(19) United States
(12) Patent Application Publication
(10) Pub. No.: US 2008/0067829 A1
(43) Pub. Date: Mar. 20, 2008

(54) Recliners for pickup trucks

(76) Inventor: Antonio M. Arias, Panama (PA)

Correspondence Address: Oltman, Flynn & Kubler, 915 Middle River Drive, Fort Lauderdale, FL, 33304, US

(21) Appl. No.: 11/985,192

(22) Filed: Nov. 14, 2007

Related U.S. Application Data
(63) Continuation-in-part of application No. 11/483,336, filed on Jul. 7, 2006.

(51) Int. Cl. B60N 2/24; B60N 2/02; B60N 2/20

(52) U.S. Cl. 296/65.03

(57) ABSTRACT

An apparatus comprising of guide rails mounted on the interior section of opposite side panels extending up from the bed of a truck, and longitudinally extensible and retractable arm members for engagement removably to respective end-joints, which can be adjusted higher or lower with respect to said guide rails, for guiding a trunk with rollers and a pair of removable seat bottoms and reclinable backrests until retained in place either in the middle of the truck bed or on the end of said bed next to the cab of the truck is disclosed. The trunk can be secured from theft in the open-topped bed of the truck. The removable seat bottoms and the reclinable backrests on top of the trunk can also be secured from theft.

This application is a continuation-in-part of application Ser. No. 11/483,336 Filed on Jul. 7, 2006.

### BACKGROUND OF THE INVENTION

1. Field of the Invention

This invention relates to a novel arrangement for mounting a pair of removable seats with fully-reclinable backrests over trunks on the bed of pickup trucks. The recliners are for people to rest or sleep and enjoy the outdoors from the open-topped back of their pickups. The recliners can be secured over such trunks and enjoyed while the pickup trucks are on the road or off the road.

Like the seats of pleasure boats, these seats should be manufactured with neoprene fabric or other all-weather resistant upholstery to withstand rain and sun. These waterproof seats would thus be washed and dried in place in the back of the pickup, and would thus be ideal for use by farm workers, repair crews, and youngsters participating in sporting or outdoor activities whose clothing may deteriorate the fine interiors of the pickup cab. Imagine then a pair of recliners in the back of the pickup contaminated with mud, sand, sun screen, perspiration, etc., while the pickup cab is kept fresh and clean.

The trunks for the safekeeping of small valuables have insulated walls and drainage outlets in the bottom and can thus be alternatively used as coolers for food and beverages. The apparatus also has convenient snack holders for both seat occupants. The snack holders can hold snacks, beverages and ashtrays for those who wish to eat or smoke outdoors and yet protect the cab interiors.

A pair of guide rails mounted on the interior section of the side panels on the back of the pickup and four rollers on the trunk bottom facilitate the movement of the apparatus back and forth on the truck bed. The apparatus would thus be rolled until retained in place either in the middle of the pickup bed or on the end of said bed right next to the cab. To use the recliners for resting or sleeping comfortably, the apparatus should be held in the middle of the pickup bed, where there is room to recline the backrests completely. (See FIG. 1). However, when the back of the pickup is not needed for seating people but to carry lots of luggage or other possessions, it may be convenient to move the apparatus out of the way by rolling it as close as possible to the cab, with the backrests upright. (See FIG. 3). If in this next-to-the-cab position the apparatus still interferes with cargo, it can then be rolled to the opposite direction, to be readily dismounted from the rear of the pickup for temporary storage at home or elsewhere. (See FIG. 6).

When not in use, the seats can be carried in their fully reclined or flat-bed position, so that they do not interfere with the rear view from the cab. Pickup owners can also recline the backrests and use a key to lock them in place to provide a safe temporary enclosure for possessions kept underneath said backrests.

When not in use, the seat bottoms and backrests can also be removed from the trunk for temporary storage at home or elsewhere, while the trunk remains in use on the bed of the truck. (See FIGS. 4 and 5).

2. Description of the Prior Art

There have long been seats for the open-topped cargo compartments of pickup trucks. The present applicant has contributed to this art with the disclosure in the following patent:

Arias, U.S. Pat. No. 6,651,469 B2, issued on Nov. 25, 2003, teaches a seat with a backrest which can be reclined backward and down, relative to a bottom of the seat, when said seat is secured to opposite side panels on the back of a pickup truck.

### SUMMARY OF THE INVENTION

The principal object of the present invention is to provide an arrangement to conveniently mount removable seat bottoms and reclinable backrests over trunks on the bed of pickup trucks. Another object of the present invention is to secure from theft said removable seat bottoms and backrests in the open-topped pickup truck.

A further object of the present invention is to provide an improved arrangement to guide the apparatus from one position to another, so that it can be retained in place and used either in the middle area of the truck bed, where there is room to recline the backrests completely, or, alternatively, next-to-the-cab, where the backrests are not reclined, leaving most of the bed available to transport cargo.

### BRIEF DESCRIPTION OF THE DRAWINGS

FIG. 1 shows an installable apparatus for pickup truck beds, comprising of a pair of reclining seats and a storage trunk underneath. One backrest is shown fully reclined, while the other one is only slightly reclined. As seen, the side panels in the back of the pickup have guide rails for the apparatus to roll from one position to another. The apparatus is in a middle of the truck bed position, where the backrests can be fully reclined.

FIG. 2 shows the apparatus in the middle of the truck bed position, with the backrests of the reclinable seats in a prone, or forward position. Since each reclining seat is mounted onto independently opening trunk lids over the storage trunk, one lid at a time can be pivoted open and back, as seen, and the cushioned seat bottom covering it, likewise goes back and up with it.

FIG. 3 shows the apparatus in a next-to-the-cab position, with the backrests of the reclinable seats upright, as can be appreciated, a position that allows the most cargo space.

FIG. 4 shows the trunk and a seat bottom and a backrest in the next-to-the-cab position illustrated in FIG. 3, but with one seat bottom and one backrest off the truck bed.

FIG. 5 shows the storage trunk in a next-to-the-cab position with both seat bottoms and both backrests off the truck bed.

FIG. 6 shows the main comprising sections of the apparatus taken off the truck bed, in its separate parts. The seat bottoms and backrests can be rolled while on the trunk toward the rear end of the pickup and be dismounted, at convenience. The apparatus can be stored away temporarily, completely assembled or in parts.

FIG. 7 shows the apparatus completely assembled, viewed from the rear end of the pickup. As also shown in FIGS. 91, 92, 96 and 97, the apparatus is secured to side panels SW-1 and SW-2 of the pickup.

FIG. 8 shows the entire apparatus, viewed from the pickup cab.

FIG. 9 shows the entire apparatus, with the seat belts unwound and secured to the seat belt fasteners.

FIG. 10 is a front view of the trunk with both trunk lids in an open position.

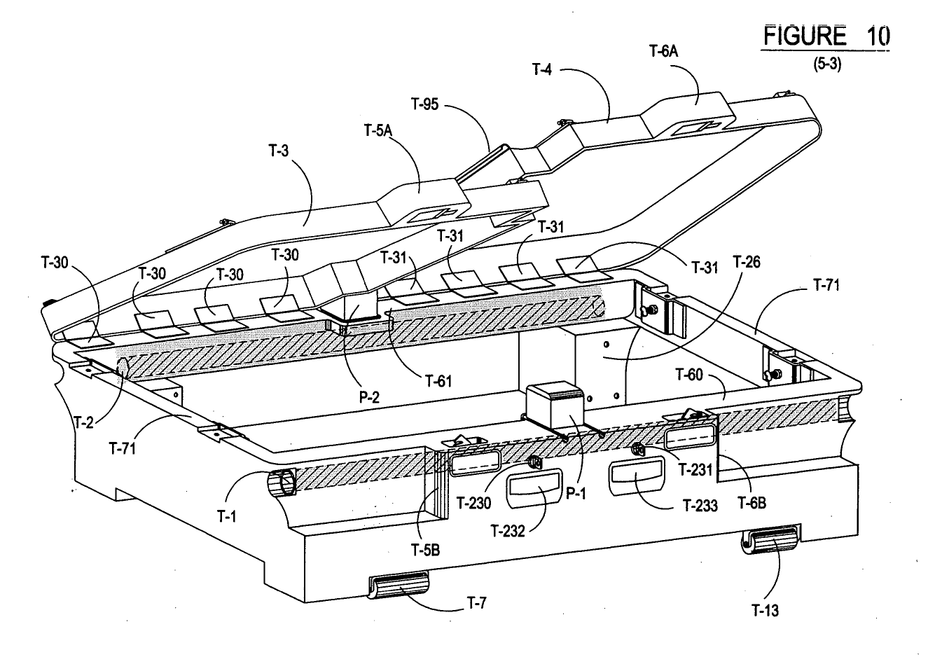

FIG. 11 is a rear view of the trunk with both trunk lids open and recesses T-25 and T-26 without their respective seat belt catches SB-3.

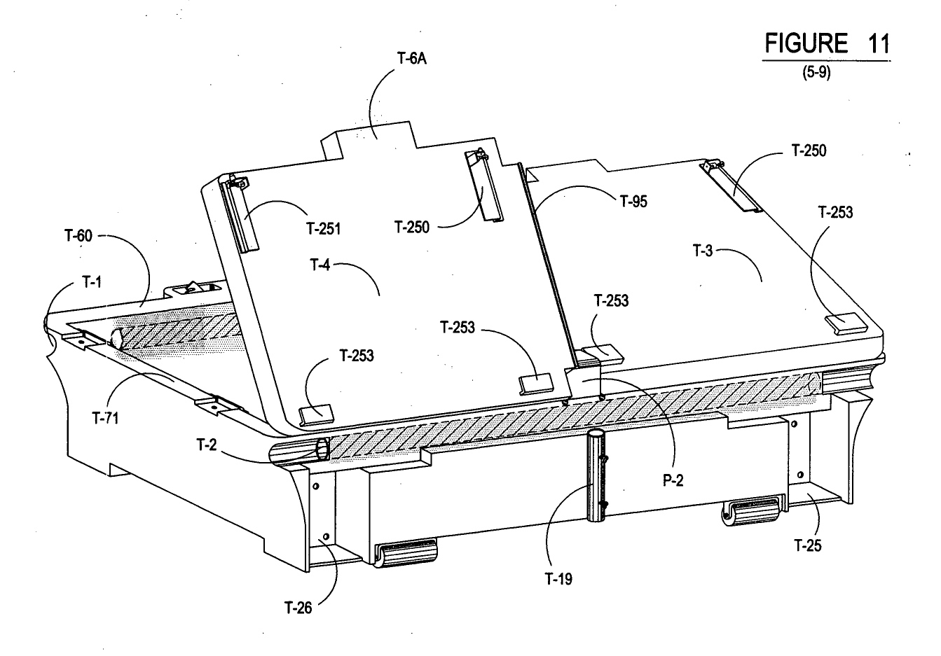

FIG. 12 shows trunk lids T-3 and T-4 removed from the trunk. When both lids are mounted on the trunk as in FIG. 14, rain guard T-95 covers rain guard base T-96.

FIG. 13 is a view of rear frame clip T-253. As illustrated in FIG. 12, each trunk lid T-3 and T-4 has two rear frame clips T-253 in the back.

FIG. 14 is a front view of trunk lids T-3 and T-4, with the latter open and the former closed. As shown, rain guard T-95 on trunk lid T-4 does not allow trunk lid T-3 to be opened while trunk lid T-4 is closed.

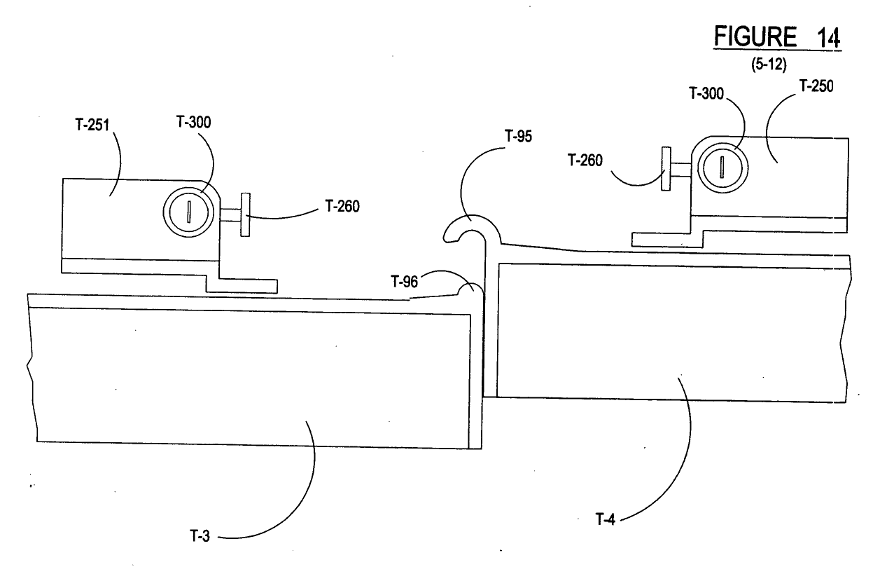

FIG. 15 is a front view of both trunk lids T-3 and T-4.

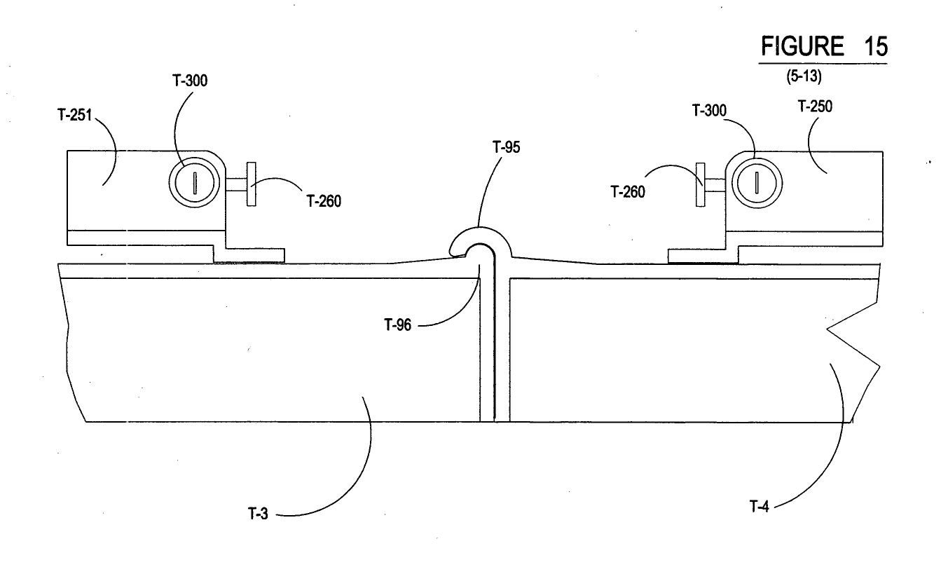

FIG. 16 is a view of the bottom of trunk lid T-3.

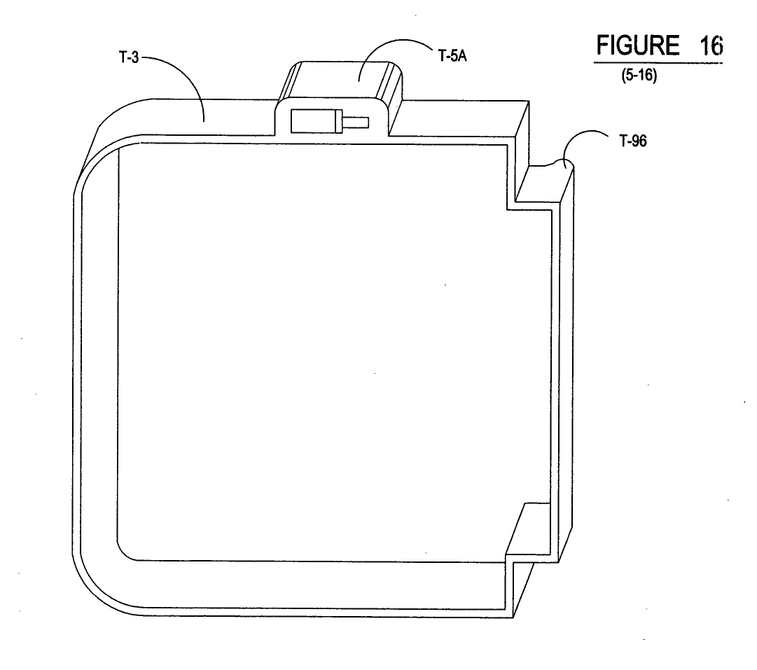

FIG. 17 is a view of the bottom of trunk lid T-4

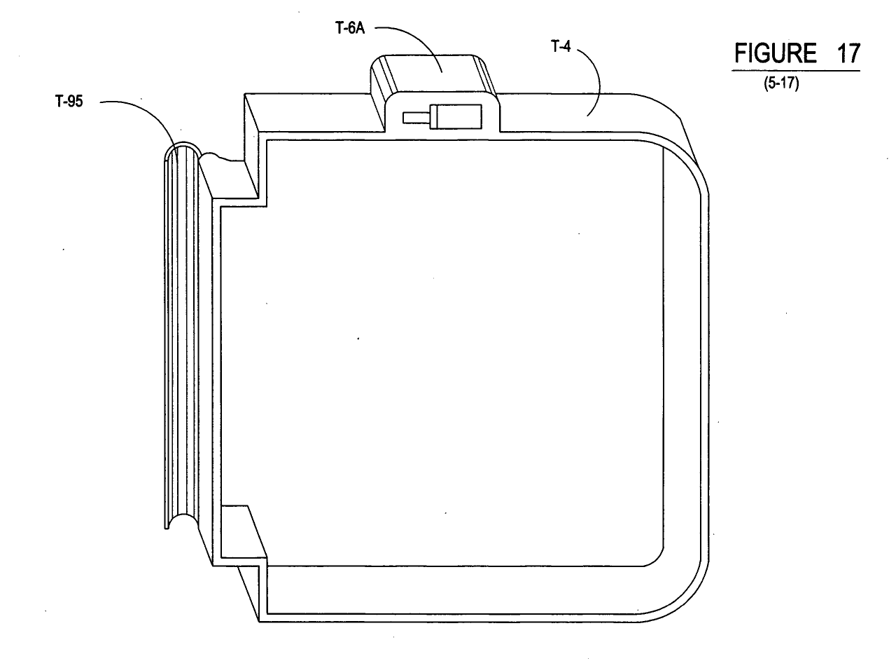

FIG. 18 is a front view of the trunk with both trunk lids T-3 and T-4 closed.

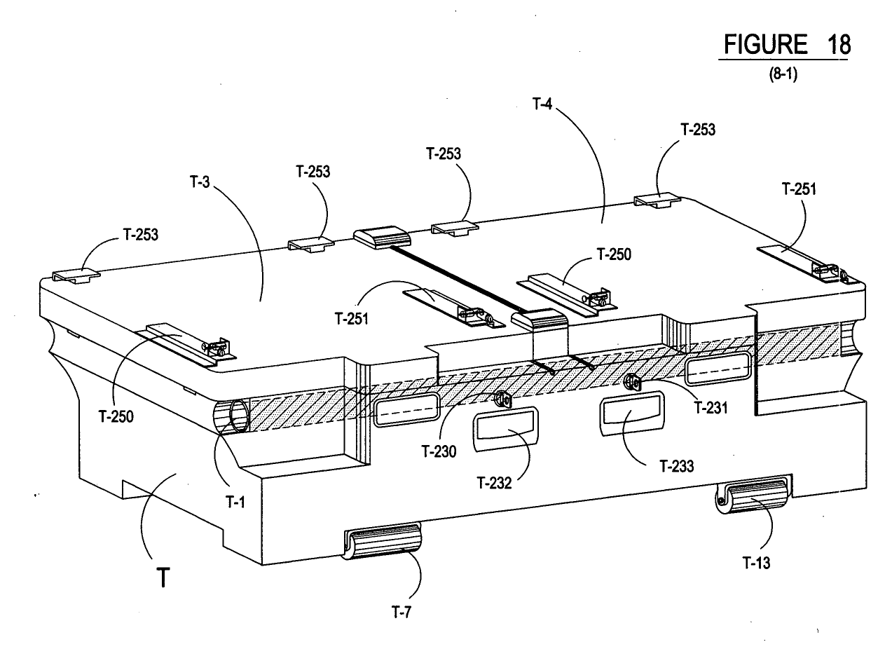

FIG. 19 is a front view of front frame clips T-250 and T-251. As shown in the previous FIGURE, each trunk lid T-3 and T-4 has a front frame clip T-250 and a front frame clip T-251 in the front.

FIG. 20 is a side view of front frame clips T-250 and T-251.

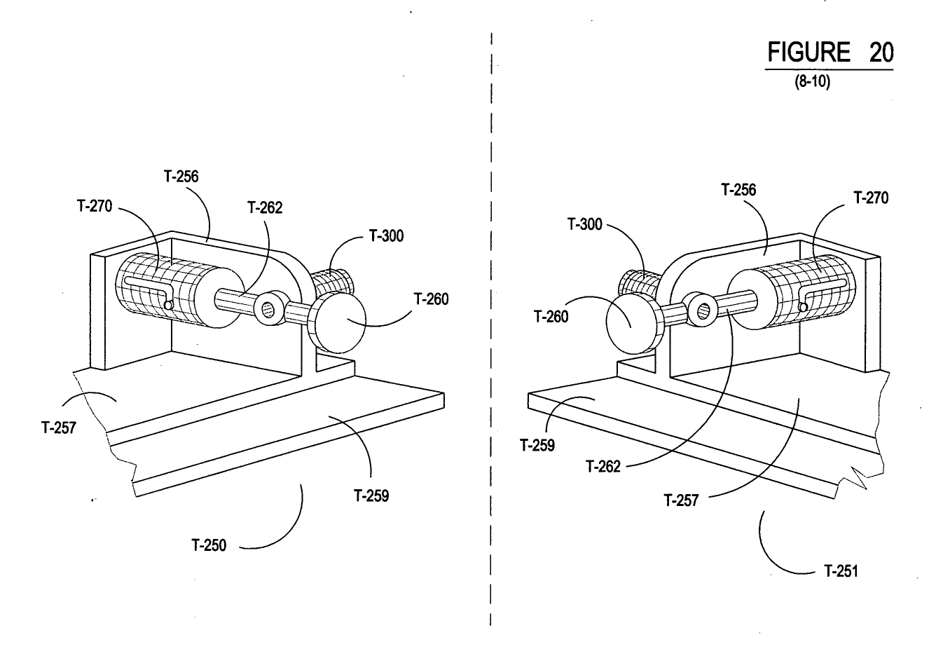

FIG. 21 is another side view of front frame clips T-250 and T-251.

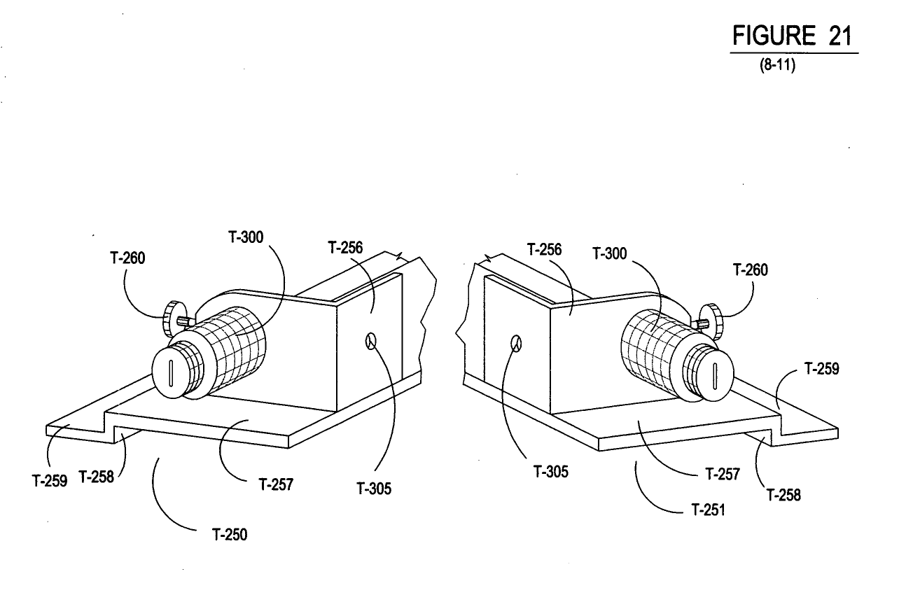

FIG. 22 shows outer seat frames S-15 and S-16. Each outer seat frame has a front segment, a rear segment, an inner side segment S-22 and an outer side segment S-23 with a side board S-24 on each of its two sides.

FIG. 23 is a top perspective of outer seat frames S-15 and S-16.

FIG. 24 shows seat bottom S-3 with inner seat frame S-15A secured underneath. As seen, inner seat frame S-15A fits perfectly within outer seat frame S-15.

FIG. 25 shows seat bottom S-4 with inner seat frame S-16A secured underneath. Inner seat frame S-16A fits perfectly within outer seat frame S-16 also seen in this FIGURE.

FIG. 26 shows seat belt fasteners SB-5 and SB-6 separated from their respective bases SB-5A and SB-6A.

FIG. 27 shows seat belt fastener SB-5 secured to its base SB-5A and seat bottom S-3 secured to inner seat frame S-15A. Outer seat frame S-15 is shown separately in this drawing.

FIG. 28 shows seat belt fastener SB-5 and base SB-5A mounted over inner seat frame S15-A.

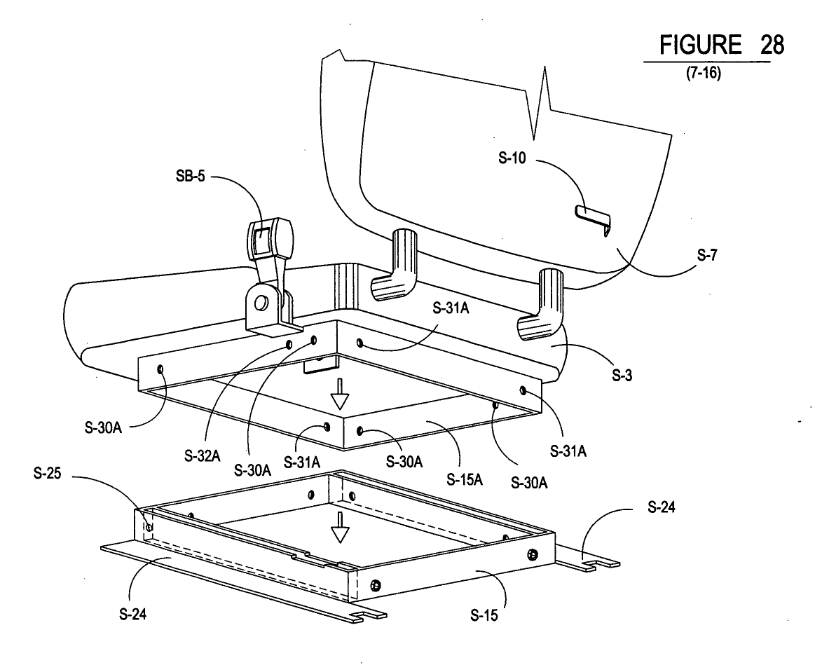

FIG. 29 is a close-up of seat belt fastener SB-5 and base SB-5A mounted over inner seat frame S-15, which is about to be fitted within outer seat frame S-15.

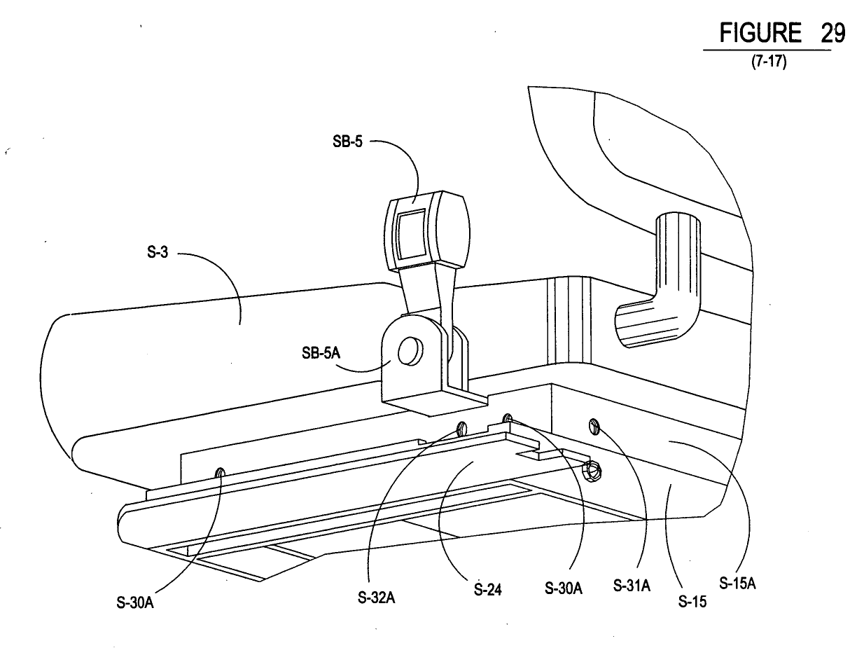

FIG. 30 shows inner seat frame S-15A fitted within outer seat frame S-15.

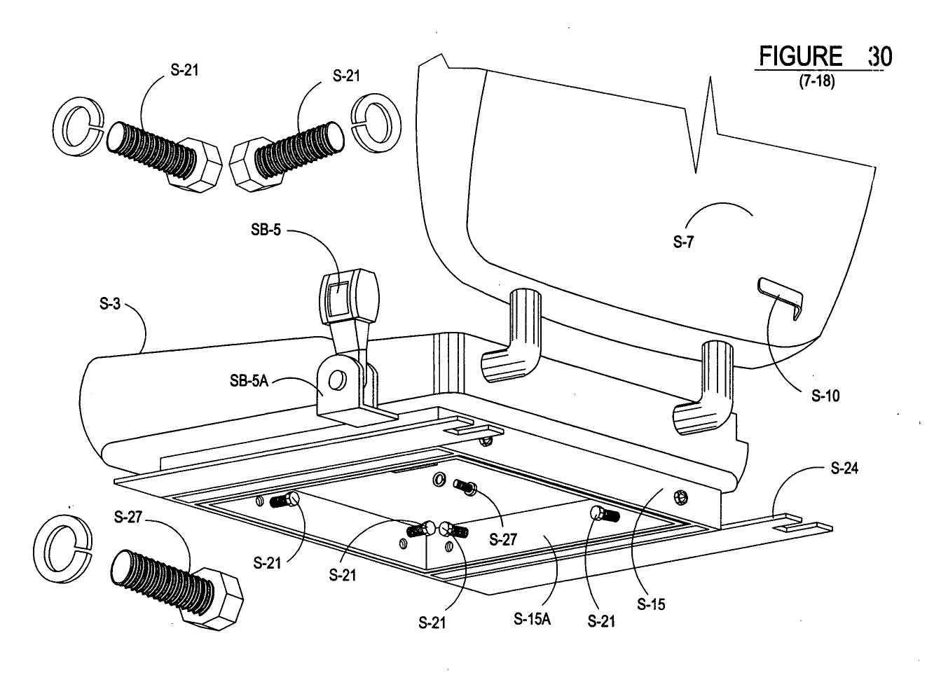

FIG. 31 shows seat belt fastener base SB-5A about to be secured to inner seat frame S-15A with bolt S-27. Concurrently, inner seat frame S-15A, already fitted within outer seat frame S-15 (refer to FIG. 30), is secured to outer seat frame S-15 by bolts S-21.

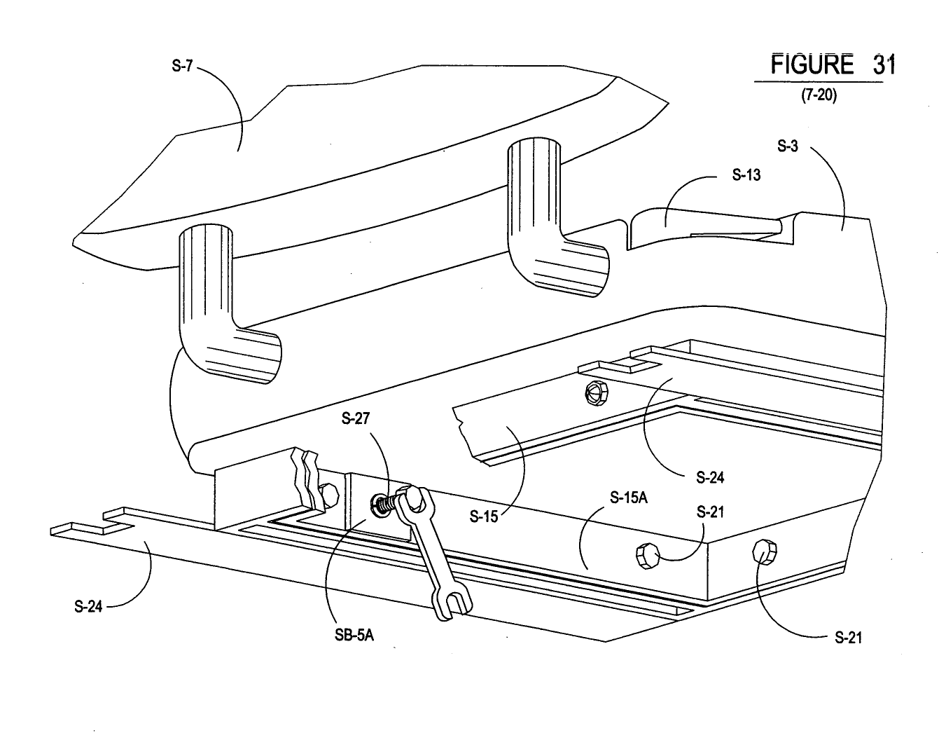

FIG. 32 is a close up of seat belt fastener SB-5 and seat belt fastener base SB-5A secured to inner seat frame S-15A and outer seat frame S-15. In this FIGURE seat belt fastener SB-5 is in position for use.

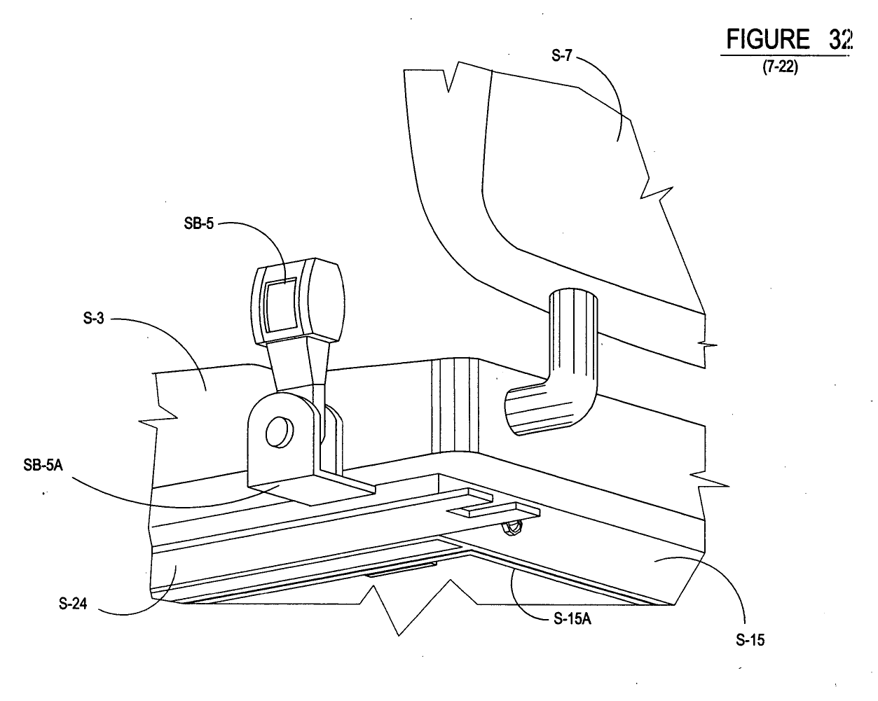

FIG. 33 is another close up of seat belt fastener SB-5, pivoted downwardly in order to protect its internal mechanism from water and the environment when not in use.

FIG. 34 is a top perspective of seat belt fastener SB-5, base SB-5A, inner seat frame S-15A, and outer seat frame S-15. As illustrated, seat belt fastener base SB-5A is secured with bolt S-27 to inner seat frame S-15A, and inner seat frame S-15A is secured with bolts S-21 to inner side segments S-22 of outer seat frame S-15. (Seat bottom S-3 secured on top of inner seat frame S-15 is not shown.)

FIG. 35 is a top perspective of seat belt fastener SB-6, base SB-6A, inner seat frame S-16A, and outer seat frame S-16. As illustrated, seat belt fastener base SB-6A is secured with bolt S-27 to inner seat frame S-16A, and inner seat frame S-16A is secured with bolts S-21 to inner side segments S-22 of outer seat frame S-16. (Seat bottom S-4 secured on top of inner seat frame S-16 is not shown.)

FIG. 36 is a rear view of the pair of seats, each seat with its seat belt fastener secured to its inner seat frame, which in turn is secured to the respective outer seat frame S-15 and S-16.

FIG. 37 shows outer seat frame S-15 with its respective inner seat frame S-15A as it slides backward over trunk lid T-3. Side boards S-24, on both sides of outer seat frame S-15, are designed to slide under a section of front frame clips T-250 and T-251 (not shown), until they reach rear frame clips T-253 in the back of trunk lid T-3.

FIG. 38 is a close-up of side board tips S-24A as they are about to reach rear frame clips T-253 in the back of trunk lid T-3.

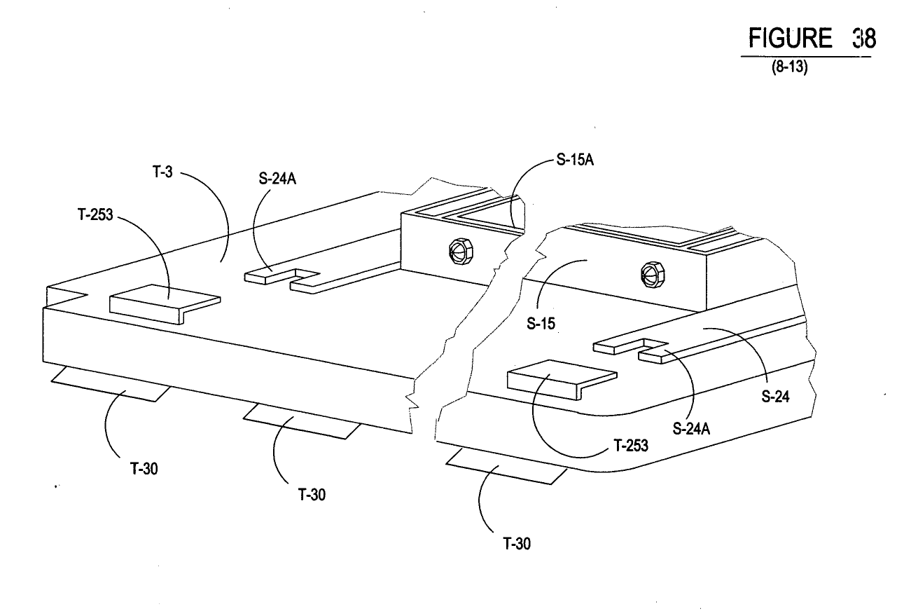

FIG. 39 is a close-up of side board S-24 on one side of outer seat frame S-15 as it passes under a section of front frame clip T-250 in the front of trunk lid T-3.

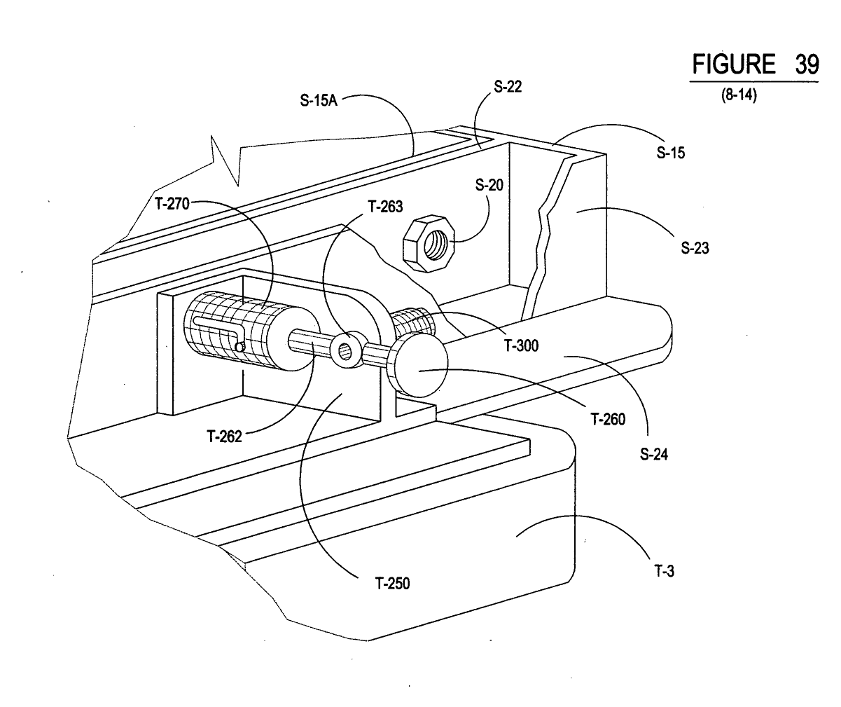

FIG. 40 is a close-up of side boards S-24, on both sides of outer seat frame S-15, as they are clipped by rear frame clips T-253 in the rear of trunk lid T-3.

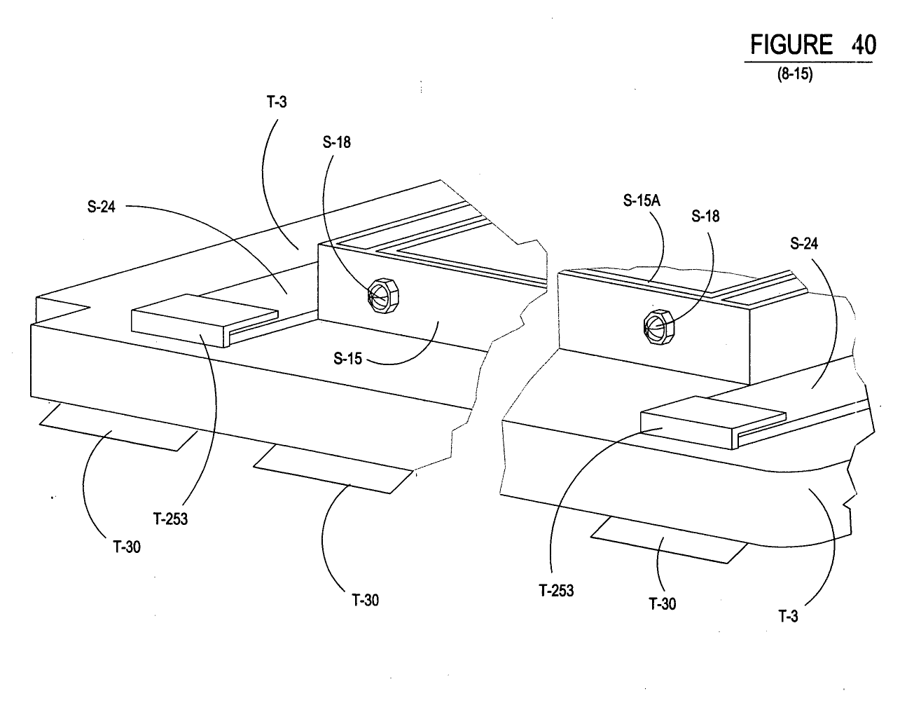

FIG. 41 shows outer seat frame S-16 with its respective inner seat frame S-16A as it slides backward over trunk lid T-4. Side boards S-24, on both sides of outer seat frame S-16, are designed to slide under a section of front frame clips T-251 and T-250 (not shown), until they reach rear frame clips T-253 in the back of trunk lid T-4.

FIG. 42 is a close-up of side board tips S-24A as they are about to reach rear frame clips T-253 in the back of trunk lid T-4.

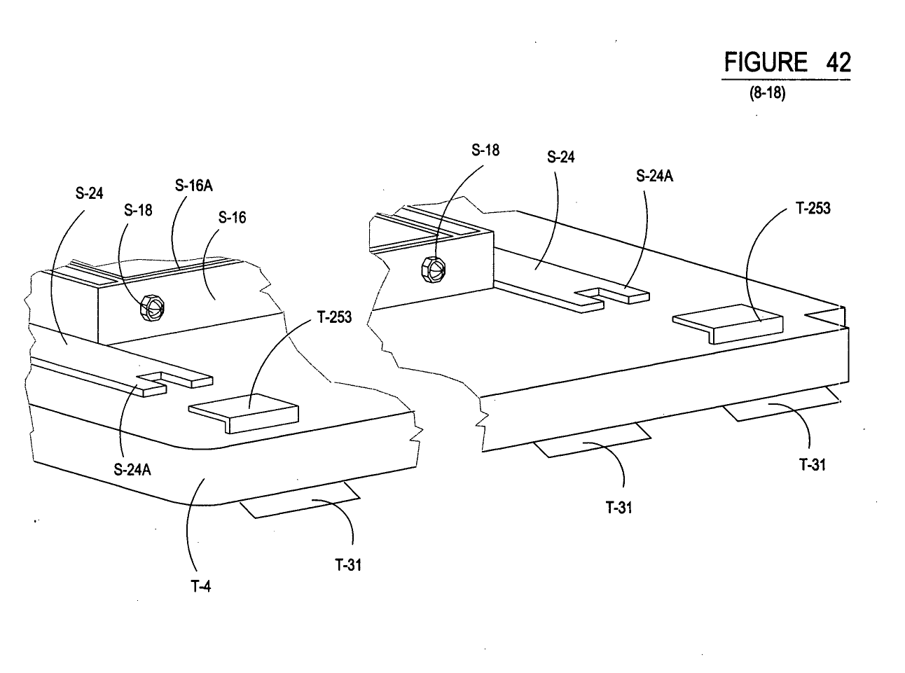

FIG. 43 is a close-up of side board S-24 on one side of outer seat frame S-16 as it passes under a section of front frame clip T-251 in the front of trunk lid T-4.

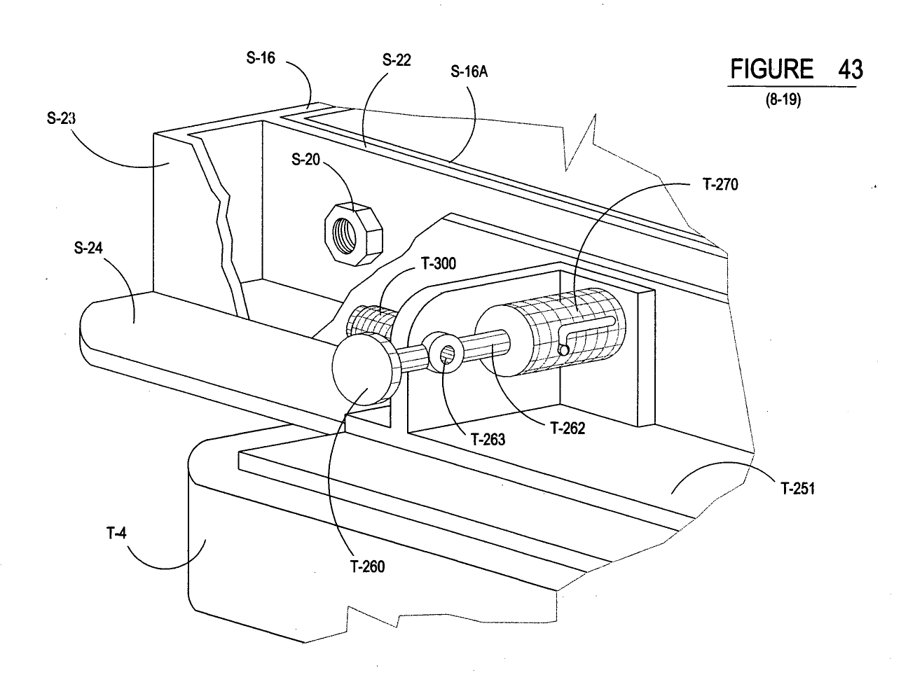

FIG. 44 is a close-up of side boards S-24, on both sides of outer seat frame S-16, as they are clipped by rear frame clips T-253 in the rear of trunk lid T-4.

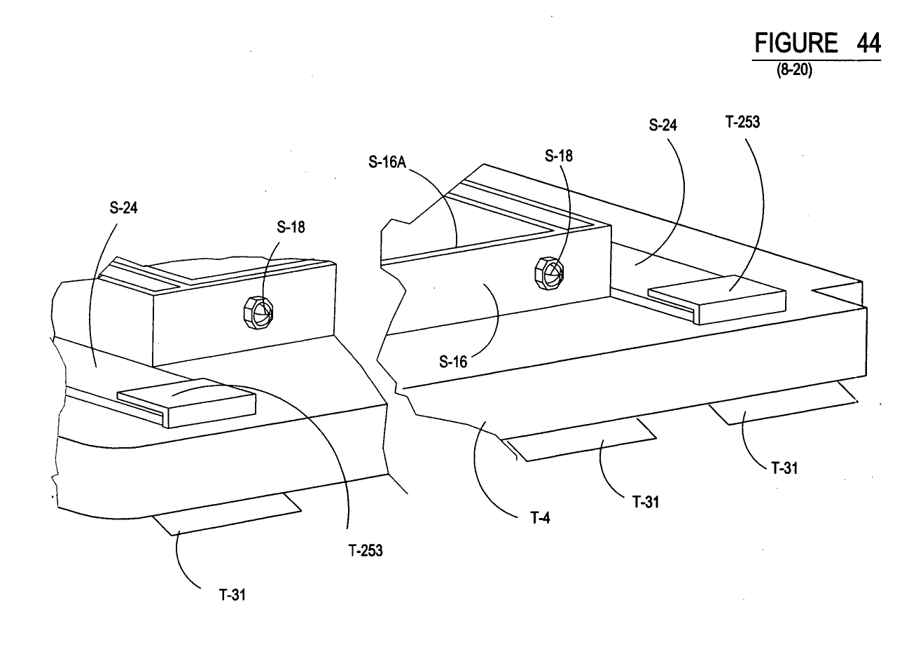

FIG. 45 shows two instances of front frame clip T-250 and its security pin T-262 with spring T-272, one in retracted position and the other in extended position. Both instances, angled from the pickup cab position, depict outer seat frame S-15 or S-16 and its respective inner seat frame, mounted over trunk lids T-3 or T-4.

FIG. 46 shows two instances of front frame clip T-251 and its security pin T-262 with spring T-272, one in retracted position and the other in extended position. Both instances, angled from the pickup cab position, depict outer seat frame S-15 or S-16 and its respective inner seat frame, mounted over trunk lids T-3 or T-4.

FIG. 47 shows two working views of lock unit T-300 on front frame clips T-250. The top drawing shows key K in a rest position with pin T-302 fully receded into said lock unit. The bottom drawing shows key K turned and pin T-302 in its fully extended position, passing through ring-shaped opening T-263 to immobilize security pin T-262 while in the position shown in the bottom of FIGS. 45 and 46.

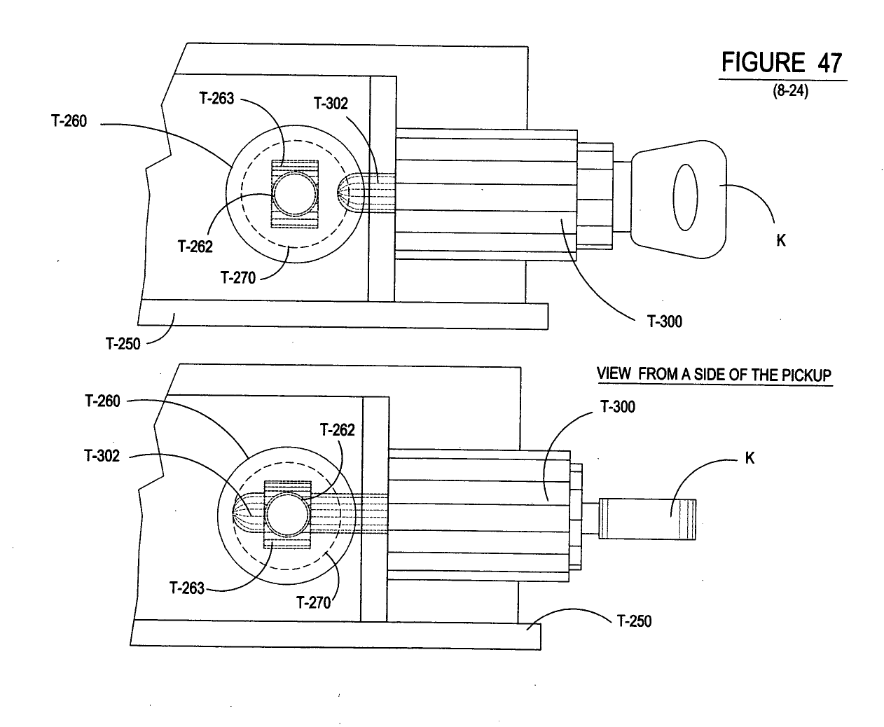

FIG. 48 shows two working views of lock unit T-300 on front frame clips T-251. The top drawing shows key K in a rest position and pin T-302 fully receded into said lock unit. The bottom drawing shows key K turned and pin T-302 in its fully extended position, passing through ring-shaped opening T-263 to immobilize security pin T-262 while in the position shown in the bottom of FIGS. 45 and 46.

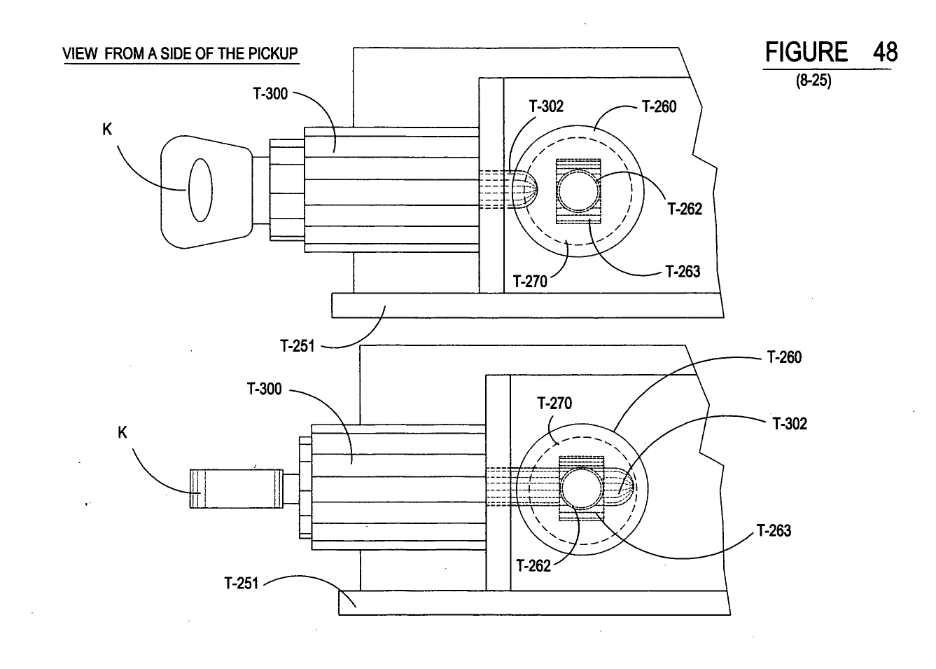

FIG. 49 is a top perspective of outer seat frames S-15 and S-16 and their respective inner seat frames, as they are locked in place over trunk lids T-3 and T4.

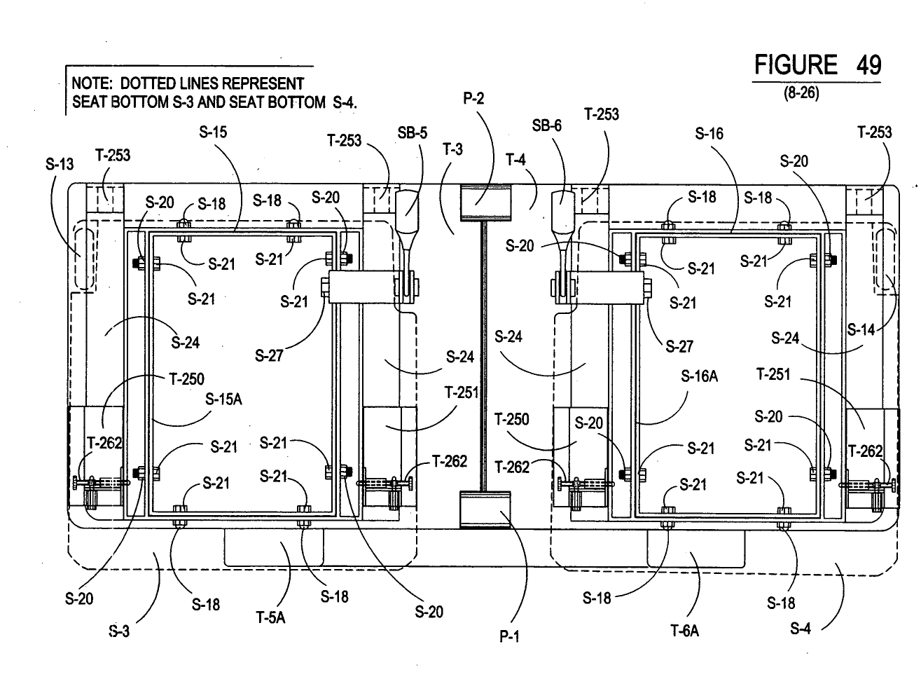

FIG. 50 is a close-up of trunk lid T-3 and front frame clip T-250 (See FIG. 49). The dotted lines represent seat bottom S-3 over inner seat frame S-15A. As shown, lock pin T-302 on lock unit T-300 is passing through ring-shaped opening T-263 to immobilize security pin T-262, which is fully extended to lock in place outer seat frame S-15 and its respective inner seat frame S-15A.

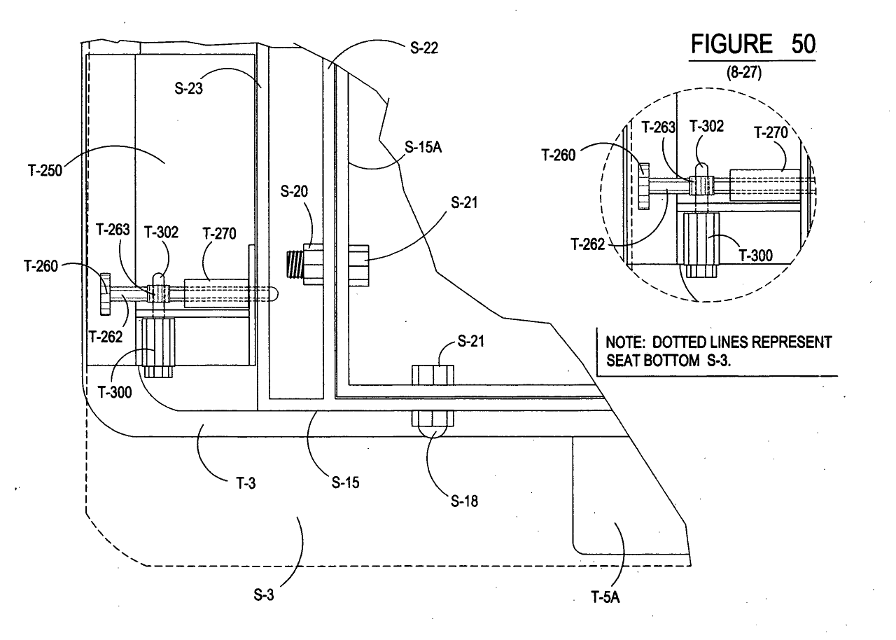

FIG. 51 is a close-up of trunk lids T-3 and T-4 and front frame clips T-251 and T-250 respectively (See FIG. 49). The dotted lines represent seat bottoms S-3 and S-4 over inner seat frames S-15A and S-16A. As shown, lock pins T-302 on lock units T-300 are passing through ring-shaped openings T-263, to immobilize security pins T-262, which are fully extended to lock in place outer seat frames S-15 and S-16 and their respective inner seat frames S-15A and S-16A.

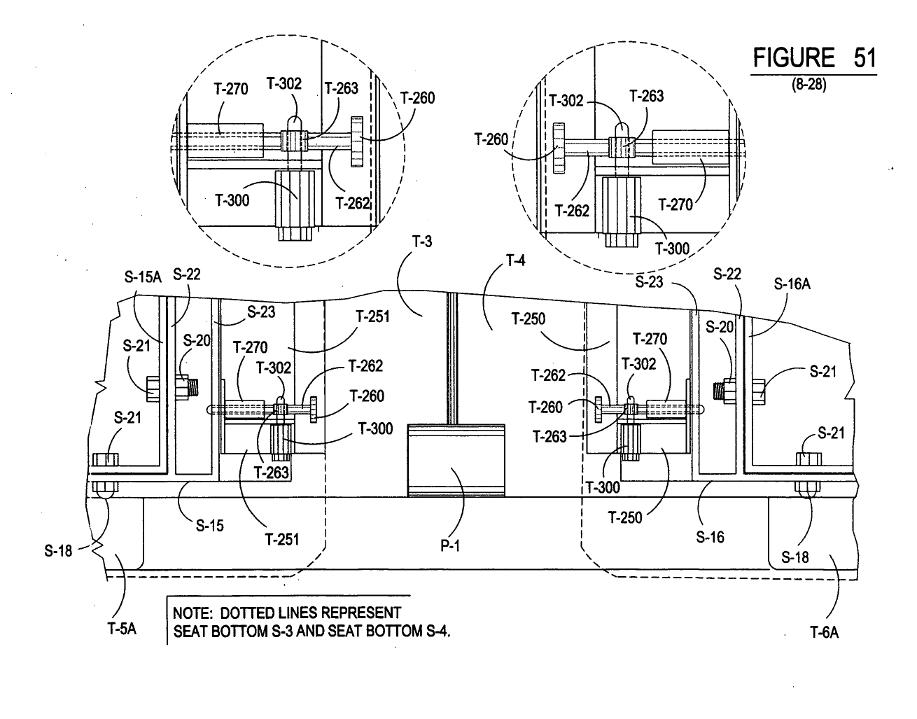

FIG. 52 is a close-up of trunk lid T-4 and front frame clip T-251 (See FIG. 49). The dotted lines represent seat bottom S-4 over inner seat frame S-16A. As shown, lock pin T-302 on lock unit T-300 is passing through ring-shaped opening T-263, to immobilize security pin T-262, which is fully extended to lock in place outer seat frame S-16 and its respective inner seat frame S-16A.

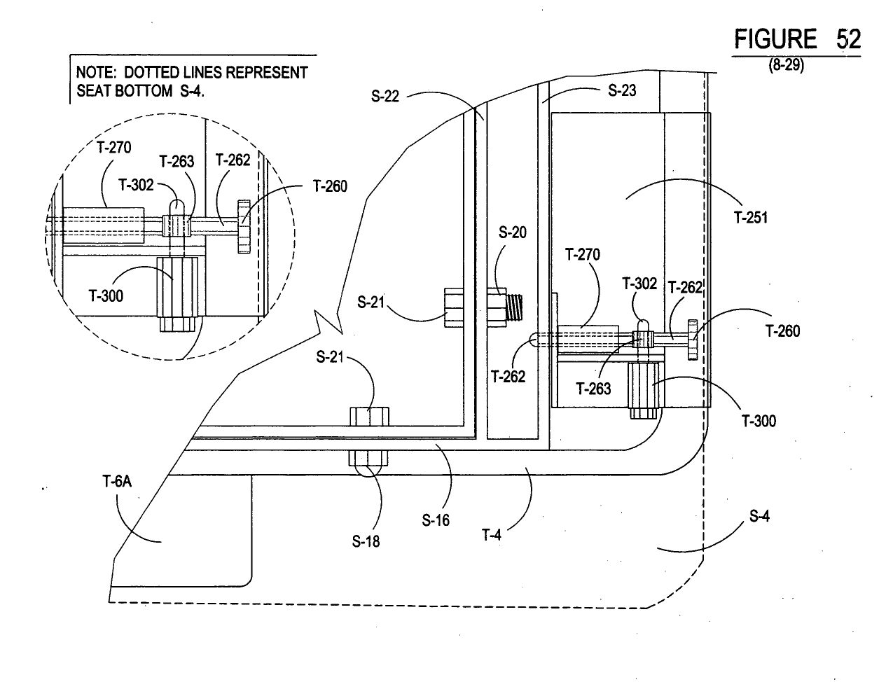

FIG. 53 is a front view of the apparatus with optional arm rests AR-1 and AR-2 mounted over the side walls of the trunk.

FIG. 54 shows the pair of optional arm rests AR-1 and AR-2.

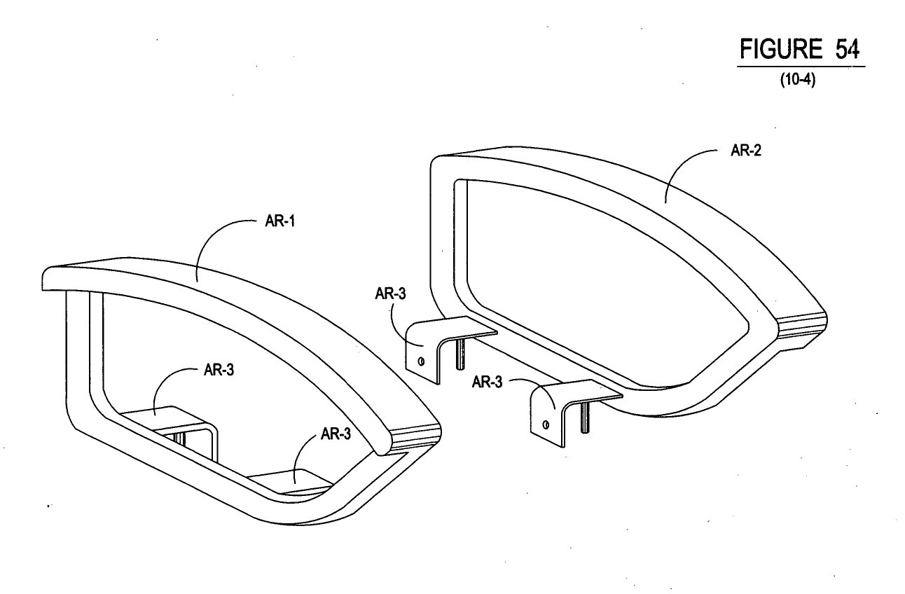

FIG. 55 shows optional armrest AR-1 and two side pockets AR-5 on one side wall T-71 of the trunk. Armrest AR-1 has a pair of teeth AR-3 which fit snugly inside side pockets AR-5 and are secured thereto with bolts AR-6.

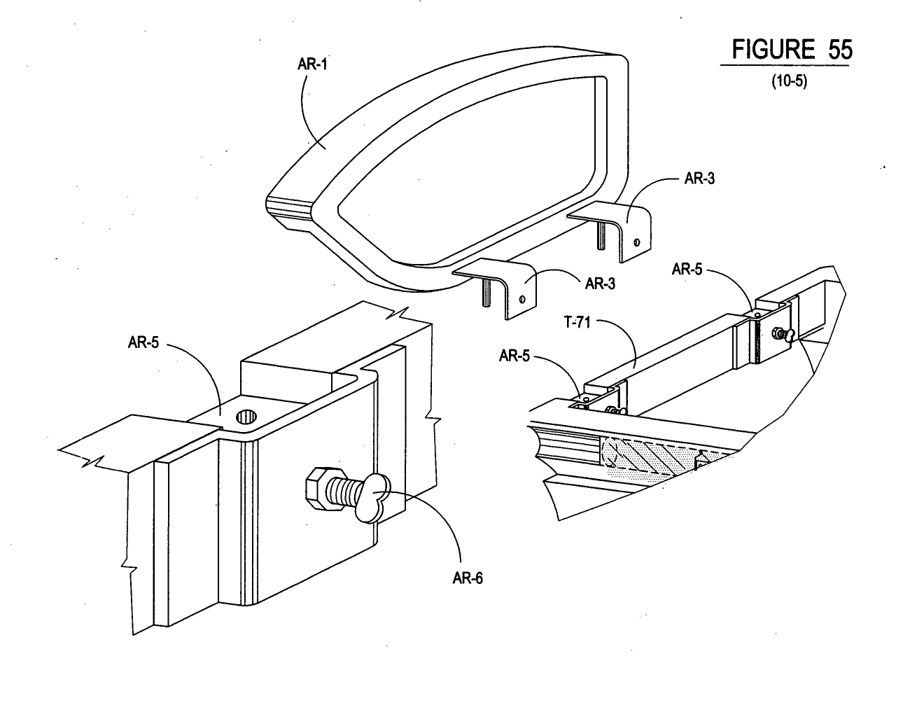

FIG. 56 shows optional arm rest AR-2 and two side pockets AR-5 on the other side wall T-71 of the trunk. Armrest AR-2 also has a pair of teeth AR-3 which fit snugly inside side pockets AR-5 and are secured thereto with bolts AR-6.

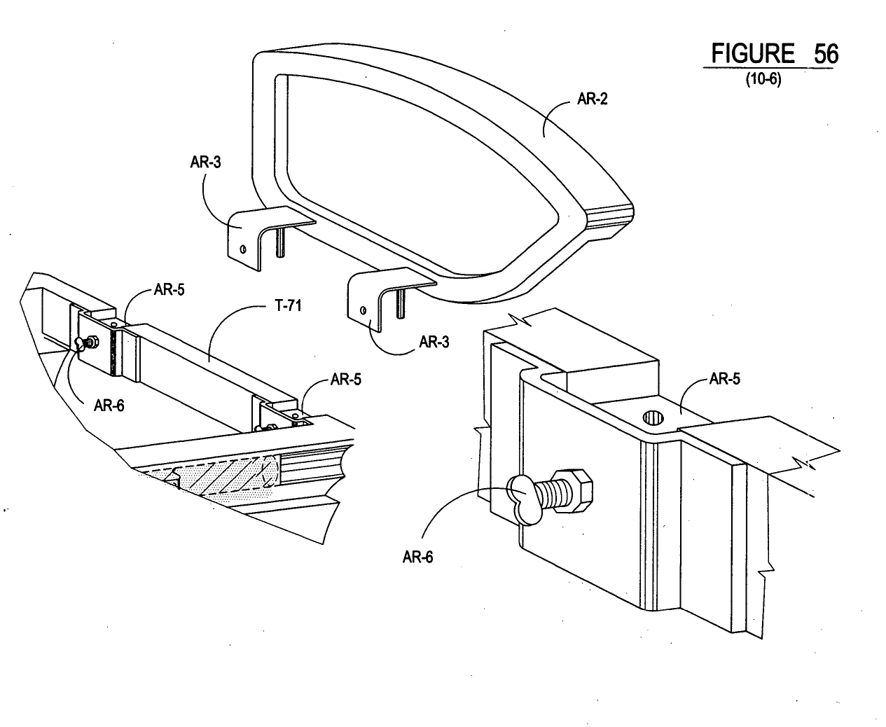

FIG. 57 shows pocket fillers AR-4. When optional armrests AR-1 and AR-2 are not on the trunk, pocket fillers AR-4 can be used to protect side pockets AR-5 from rain or dust.

FIG. 58 shows the back of the trunk and recesses T-25 and T-26, where seat belt catches SB-3 are fitted in.

FIG. 59 shows both the front and the back of seat belt catch SB-3. In the front, it has catch-lid SB-16, grasp SB-19 and shield SB-18 as a drainage outlet. In the back, it has upper hole SB-21 and two lower holes SB-22 that secure the catch with bolts to corresponding holes T-89 and T-90 on recesses T-25 and T-26 of the trunk.

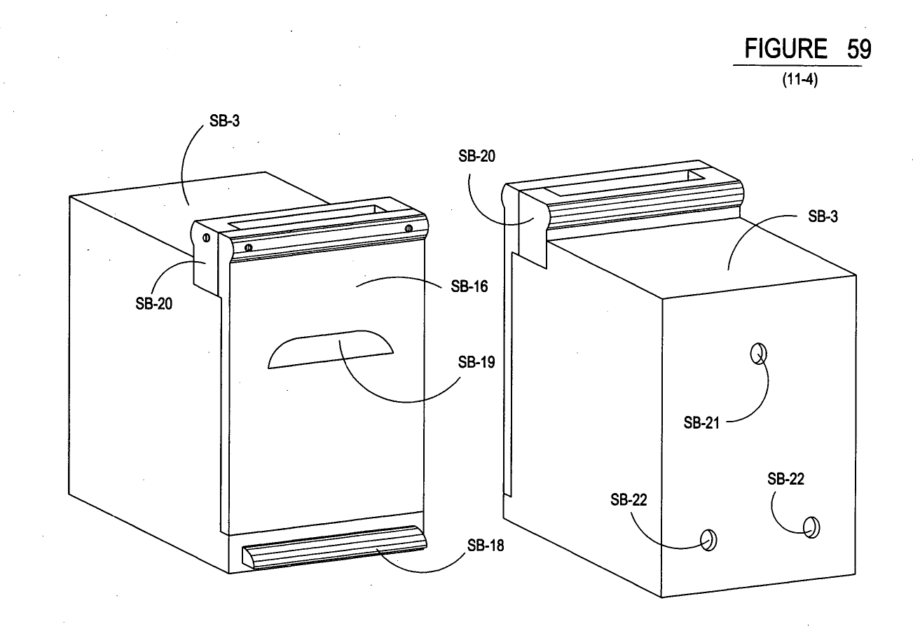

FIG. 60 shows a seat belt catch SB-3 with catch-lid SB-16 in an open position. Reel SB-24 and seat belt SB-1 or SB-2 are inside the mentioned catch. Catch SB-3 also consists of catch-top SB-20 and seat belt retainer SB-34.

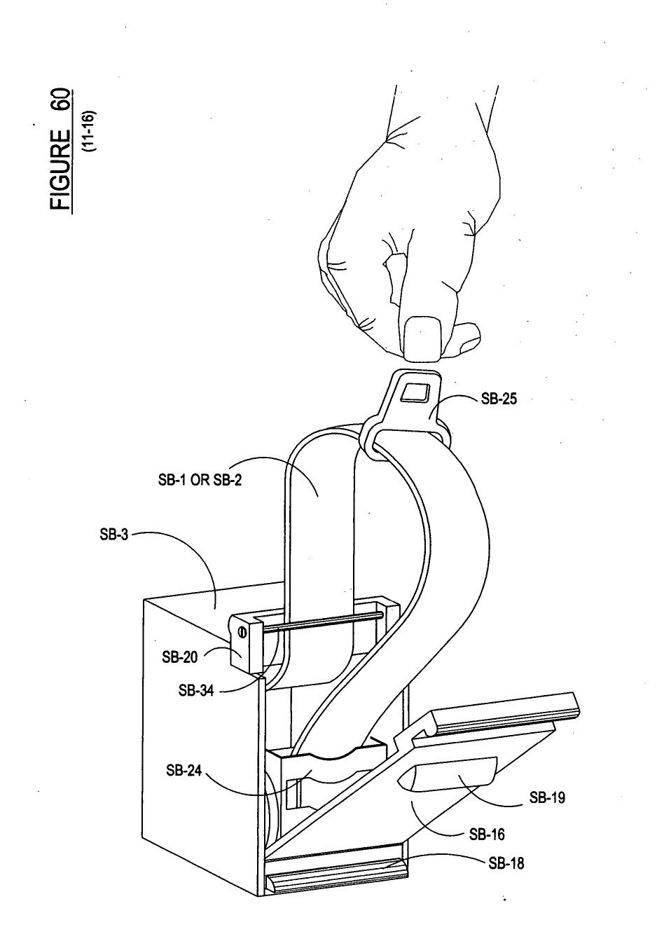

FIG. 61 shows seat belt catch SB-3 with catch-lid SB-16 in a closed position; thus exposing an opening between catch-top SB-20 and catch-lid SB-16 that provides passage for seat belt SB-1 or SB-2.

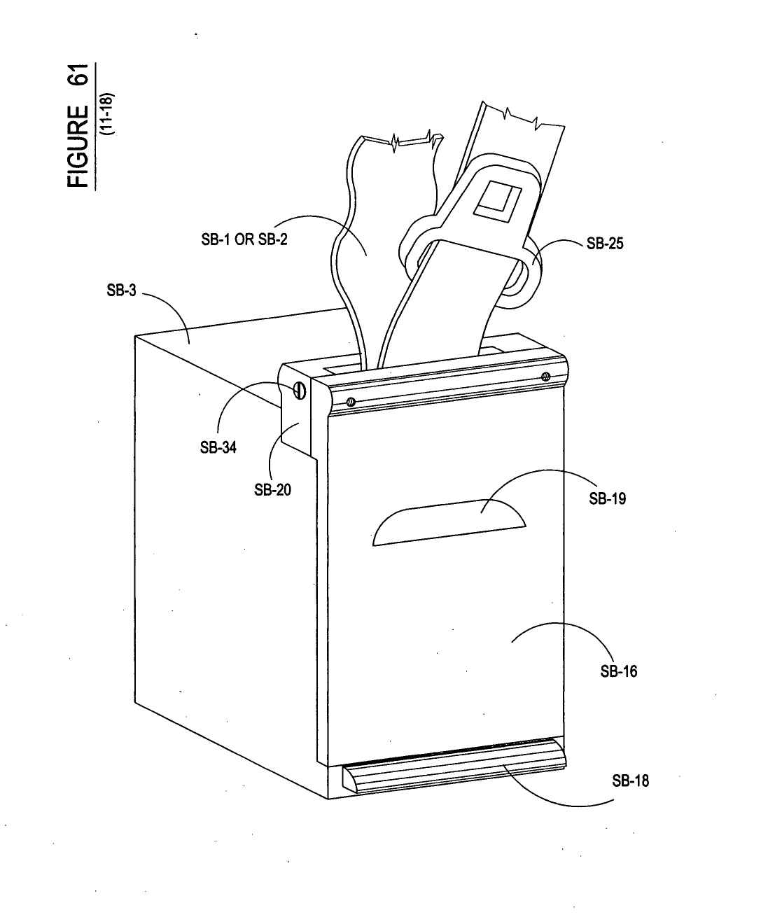

FIG. 62 shows seat belt SB-1 and seat belt buckle SB-25 inside seat belt catch SB-3. The seat belt is shown passing over seat belt retainer SB-34 between catch-top SB20 and the upper portion of catch-lid SB16.

FIG. 63 shows seat belt SB-1 inside seat belt catch SB-3 with catch-lid SB-16 opened.

FIG. 64 shows catch-slide SB-43 slid into a position slightly over catch-top SB-20 and catch-lid SB-16 to keep catch-lid SB-16 closed; in said position the seat belt opening is exposed.

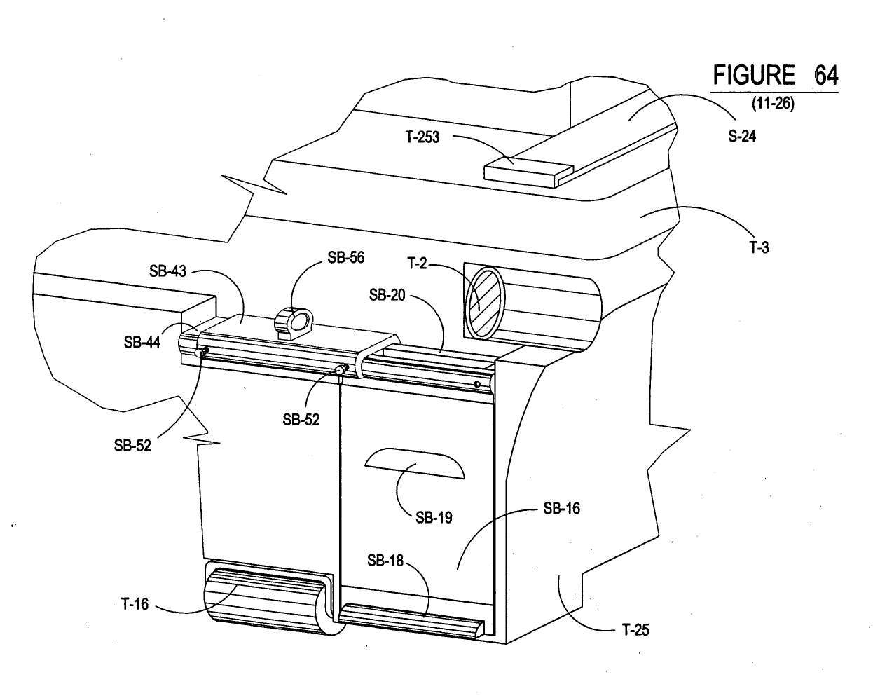

FIG. 65 shows seat belt SB-1 as it passes through the seat belt opening with catch-slide SB-43 in the same position of FIG. 64.

FIG. 66 shows catch-slide SB-43 slid further into catch-top SB-20 and catch-lid SB-16; in such position the seat belt opening is closed and the seat belt and the reel inside seat belt catch SB-3 are thus protected from water and the environment.

FIG. 67 shows seat belt SB-1 unwound, and held over backrest S-1 to be readily available for use. To keep the seat belt stretched over the backrest as shown, the seat belt has three guides: a swingable guide G-13 on the upper section of the backrest and two L-shaped fixed guides S-9 and S-10 in the rear section S-7 of backrest S-1.

FIG. 68 shows swingable guide G-13 and the two L-shaped fixed guides S-9 and S-10 in the rear section S-7 of backrest S-1.

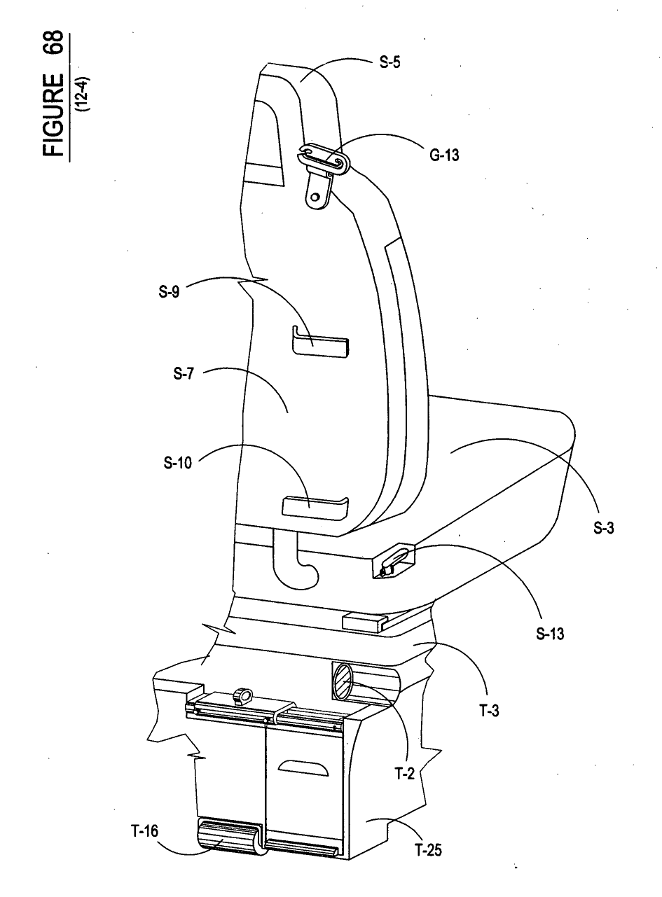

FIG. 69 shows that the short segments of the L-shaped fixed guides secure the guides to the rear section S-7 of backrest S-1 and also retain the seat belt from opposite sides.

FIG. 70 shows seat belt SB-1 fully stretched behind rear section S-7 of backrest S-1.

FIG. 71 likewise shows L-shaped guides S-11 and S-12 and swingable guide G-14 and seat belt SB-2 fully stretched behind rear section S-8 of backrest S-2.

FIG. 72 shows a side of the trunk with a front trunk tube T-1 and a rear trunk tube T-2 immediately under the trunk lids. The trunk tubes extend from one side of the trunk to the other.

FIG. 73 shows the same trunk tubes T-1 and T-2 in a view from the opposite side of the trunk. (Compare FIG. 72)

FIG. 74 is a front view of the apparatus with front trunk tube T-1 and rear trunk tube T-2 holding a pair of double-ended telescopic arms.

FIG. 75 is a rear view of the apparatus with front trunk tube T-1 and rear trunk tube T-2 holding a pair of double-ended telescopic arms.

FIG. 76 shows a pair of double-ended telescopic arms comprised of front main tube A-1 partially enclosing front inner tube A-2, and rear main tube A-3 partially enclosing rear inner tube A-4. The front double-ended telescopic arm has end-disk A-5 and end-block A-9 on one end, and end-disk A-6 and end-block A-10 on the other; while the rear double-ended telescopic arm has end-disk A-7 and end-block A-11 on one end, and end-disk A-8 and end-block A-12 on the other.

FIG. 77 shows a conventional pickup truck with an open-topped area behind the cab, having a bottom wall or bed covered with a liner GR-4, front and back sides and two opposite side walls or side panels SW-1 and SW-2, and rigid guide rails GR-1 and GR-2 mounted on the interior section of said side panels.

FIG. 78 is a view of guide rail GR-1. The guide rail consists of two vertical walls, a first vertical wall GR-9 and a second vertical wall GR-15, a horizontal bottom wall GR-18 and a horizontal top wall GR-17. Bottom wall GR-18 has a series of elongated stop holes GR-11 equidistant from each other.

FIG. 79 is a view of counterpart guide rail GR-2. This guide rail also consists of two vertical walls, a first vertical wall GR-9 and a second vertical wall GR-15, a horizontal top wall GR-17, and a horizontal bottom wall GR-18 having a series of elongated stop holes GR-11.

FIG. 80 is a close-up of the rear section of guide rail GR-1 and of lock unit GR-10 underneath bottom wall GR-18.

FIG. 81 is another close-up of the rear section of guide rail GR-1. As shown, a key K is turned in lock unit GR-10 to move up a lock pin GR-13.

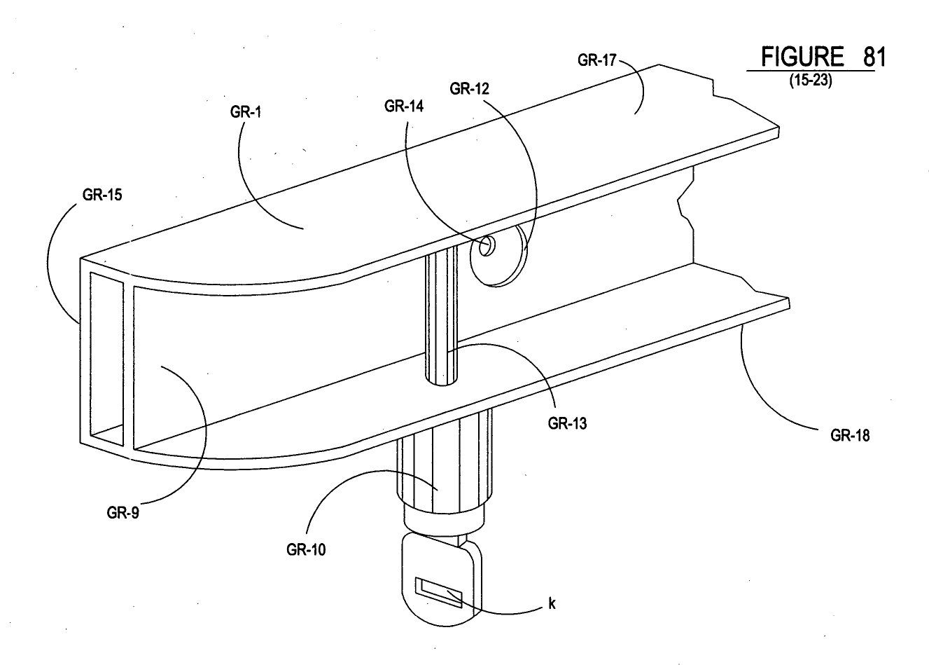

FIG. 82 is a close up of the rear section of guide rail GR-2 and of lock unit GR-10 underneath bottom wall GR-18.

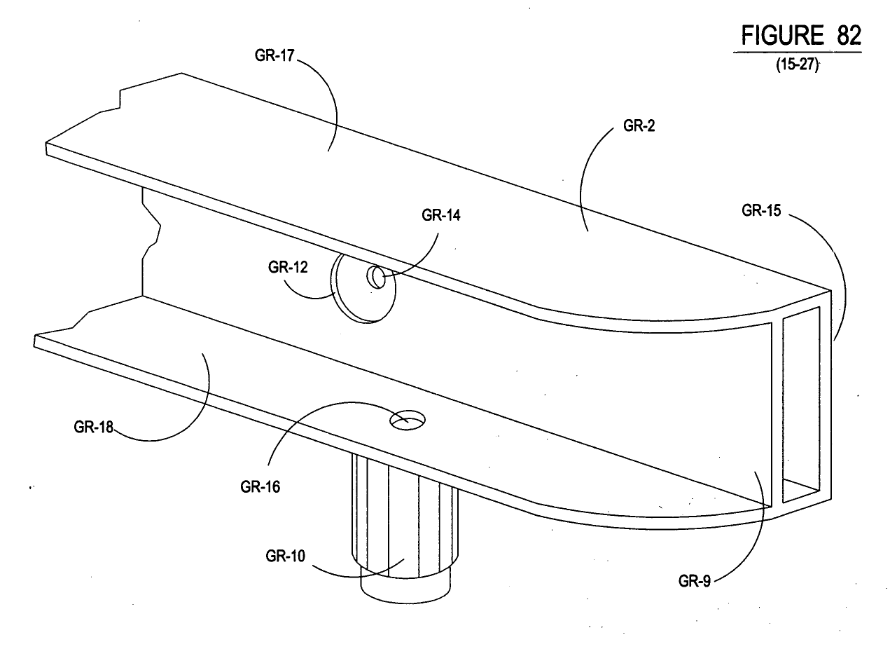

FIG. 83 is another close up of the rear section of guide rail GR-2. As shown, a key K is turned in lock unit GR-10 to move up a lock pin GR-13.

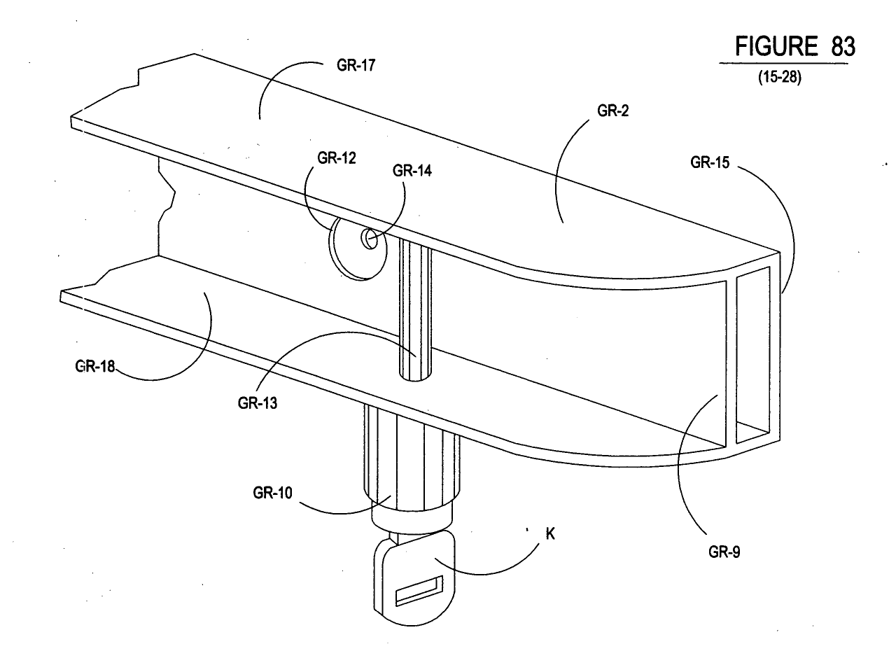

FIG. 84 is a close up of a middle section of guide rail GR-1. As shown, first vertical wall GR-9 has a series of big holes GR-12 and second vertical wall GR-15 has a corresponding series of small holes GR-14.

FIG. 85 is a close-up of a middle section of guide rail GR-2. As shown, first vertical wall GR-9 has a series of big holes GR-12 and second vertical wall GR-15 has a corresponding series of small holes GR-14.

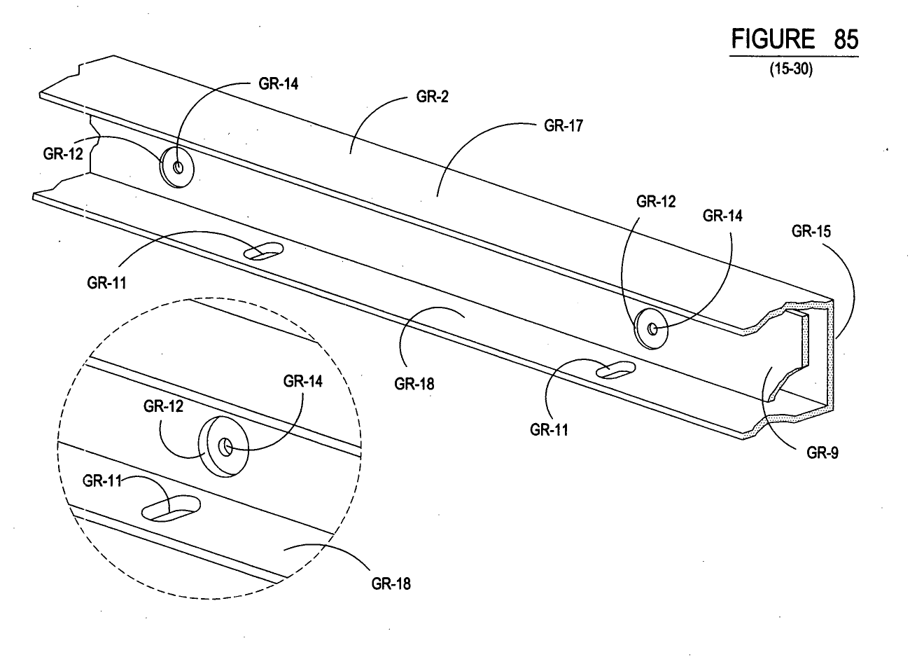

FIG. 86 shows lock units GR-10 and elongated stop holes GR-11 from underneath guide rails GR-1 and GR-2.

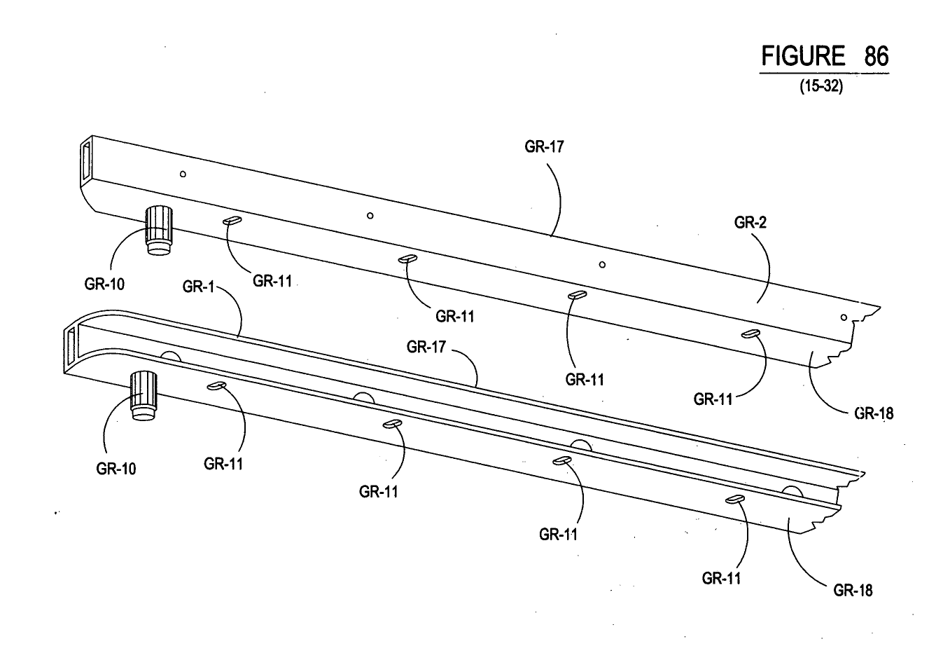

FIG. 87 is a view of T-like metal piece E-5.

FIG. 88 shows T-like metal piece E-5 holding a pair of cylinders E-50 and a pair of hook levers E-55 in its horizontal section. Side shoe E-70 is also shown as it is about to be mounted over said horizontal section of T-like metal piece E-5. Cup E-72 and cover E-85 are also shown separately, as well as handles E-55A.

FIG. 89 shows side shoe E-70 secured with bolts E-77B over the horizontal section of T-like metal piece E-5. Cover E-85 is also shown secured over side shoe E-70. Handles E-55A are also shown secured on top of hook levers E-55. End-joint assembly E-1 is also shown secured with bolts to the vertical section of T-like metal piece E-5.

FIG. 90 shows front inner tube A-2 and rear inner tube A-4 secured with bolts A-18 to end-joints E-2 and E-3 on end-joint assembly E-1, which in turn is secured to the vertical section of T-like metal piece E-5.

FIG. 91 is a close-up of a section of FIG. 7. Front inner tube A-2 is shown secured with bolt A-18 to end-joint E-2 of end-joint assembly E-1, which in turn is secured to the vertical section of T-like metal piece E-5. The lower end of a hook lever E-55, held by the horizontal section of T-like metal piece E-5, is also shown secured to an elongated stop hole GR-11 on bottom wall GR-18 of guide rail GR-1.

FIG. 92 shows rear inner tube A-4 secured with bolt A-18 to end-joint E-3 of end-joint assembly E-1, which in turn is secured to the vertical section of T-like metal piece E-5. The lower end of a hook lever E-55, held by the horizontal section of T-like metal piece E-5, is also shown secured to an elongated stop hole GR-11 on bottom wall GR-18 of guide rail GR-1.

FIG. 93 shows T-like metal piece E-5 holding a pair of cylinders E-50 and a pair of hook levers E-55 in its horizontal section. Side shoe E-90 is also shown as it is about to be mounted over said horizontal section of T-like metal piece E-5. Cup E-72 and cover E-85 are also shown separately, as well as handles E-55A.

FIG. 94 shows side shoe E-90 secured with bolts E-77B over the horizontal section of T-like metal piece E-5. Cover E-85 is also shown secured over side shoe E-90. Handles E-55A are also shown secured on top of hook levers E-55. End-joint assembly E-1 is also shown secured with bolts to the vertical section of T-like metal piece E-5.

FIG. 95 shows front main tube A-1 and rear main tube A-3 secured with bolts A-18 to end-joints E-3 and E-2 on end-joint assembly E-1, which in turn is secured to the vertical section of T-like metal piece E-5.

FIG. 96 is a close-up of a section of FIG. 7. In this close-up front main tube A-1 is shown secured with bolt A-18 to end-joint E-3 of end-joint assembly E-1, which in turn is secured to the vertical section of T-like metal piece E-5. The lower end of a hook lever E-55, held by the horizontal section of T-like metal piece E-5, is also shown secured to an elongated stop hole GR-11 on bottom wall GR-18 of guide rail GR-2.

FIG. 97 shows rear main tube A-3 secured with bolt A-18 to end-joint E-2 of end-joint assembly E-1, which in turn is secured to the vertical section of T-like metal piece E-5. The lower end of a hook lever E-55, held by the horizontal section of T-like metal piece E-5, is also shown secured to an elongated stop hole GR-11 on bottom wall GR-18 of guide rail GR-2.

FIG. 98 shows handle E-55A all the way down, groove pin E-57 on side rest E-52B of L-shaped parallel grooves E-52, spring E-51 fully contracted inside cylinder E-50, and the lower end of a hook lever E-55 swung away from bottom wall GR-18 of guide rail GR-1.

FIG. 99 shows handle E-55A, groove pin E-57 and spring E-51 as they begin to move up, while the lower end of a hook lever E-55 is about to reach an elongated stop hole GR-11 on bottom wall GR-18 of guide rail GR-1.

FIG. 100 shows handle E-55A all the way up, groove pin E-57 at top rest E-52A, spring E-51 fully extended and the lower end of a hook lever E-55 locked into an elongated stop hole GR-11 on bottom wall GR-18 of guide rail GR-1.

FIG. 101 shows handle E-55A all the way down, groove pin E-57 on side rest E-52B of L-shaped parallel grooves E-52, spring E-51 fully contracted inside cylinder E-50, and the lower end of a hook lever E-55 swung away from bottom wall GR-18 of guide rail GR-2.

FIG. 102 shows handle E-55A, groove pin E-57 and spring E-51 as they begin to move up, while the lower end of a hook lever E-55 is about to reach an elongated stop hole GR-11 on bottom wall GR-18 of guide rail GR-2.

FIG. 103 shows handle E-55A all the way up, groove pin E-57 at top rest E-52A, spring E-51 fully extended and the lower end of a hook lever E-55 locked into an elongated stop hole GR-11 on bottom wall GR-18 of guide rail GR-2.

FIG. 104 shows spring E-51, cylinder E-50, groove pin E-57, hook lever E-55 and handle E-55A unassembled.

FIG. 105 shows all parts illustrated in the previous FIGURE fully assembled, except for handle E-55A. Groove pin E-57 is shown secured to hole E-56 on hook lever E-55 and at top rest E-52A of L-shaped parallel grooves E-52 on cylinder E-50, with spring E-51 underneath fully extended.

FIG. 106 likewise shows all parts illustrated in the previous FIGURE. However, in this instance groove pin E-57 is shown between top rest E-52A and side rest E-52B of L-shaped parallel grooves E-52 on cylinder E-50, with spring E-51 underneath somewhat contracted.

FIG. 107 likewise shows all parts illustrated in the previous FIGURE. However, in this instance groove pin E-57 is shown at side rest E-52B of L-shaped parallel grooves E-52 on cylinder E-50, with spring E-51 underneath fully contracted.

FIG. 108 shows handles E-55A secured to their respective hook levers, cover E-85 secured on top of side shoe E-70 with bolts E-86C, lock units E-87 with a key K on opposite sides of cover E-85 and a hollow pin E-87A for each lock unit E-87.

FIG. 109 shows handles E-55A secured to their respective hook levers, cover E-85 secured on top of side shoe E-70 with bolts E-86C, lock units E-87 with a key K on opposite sides of cover E-85, and a hollow pin E-87A receded into each lock unit E-87. This FIGURE further shows hook levers E-55 pushed down and springs E-51 fully contracted inside cylinders E-50, with groove pins E-57 at side rests E-52B.

FIG. 110 shows hook levers E-55 all the way up, and springs E-51 fully extended inside cylinders E-50, with groove pins E-57 at top rest E-52A encompassed by hollow pins E-87A.

FIG. 111 shows vertical security bolt P-4 and nut P-4A securing front inner tube A-2 and front main tube A-1 to front trunk tube T-1. The head of vertical security bolt P-4 rests inside front box P-1, between trunk lid T-3 and trunk lid T-4. Nut P-4A rests inside the trunk and underneath front trunk tube T-1.

FIG. 112 shows vertical security bolt P-4 and nut P-4A securing rear inner tube A-3 and rear main tube A-2 to rear trunk tube T-2. The head of vertical security bolt P-4 rests inside rear box P-2, between trunk lid T-3 and trunk lid T-4. Nut P-4A rests inside the trunk and underneath rear trunk tube T-2.

### DETAILED DESCRIPTION OF THE PREFERRED EMBODIMENTS

Before explaining the present invention in detail it is to be understood that the invention is not limited in its application to the particular arrangements shown and described herein since the invention is capable of other embodiments. Also, the terminology used herein is for the purpose of description and not of limitation.

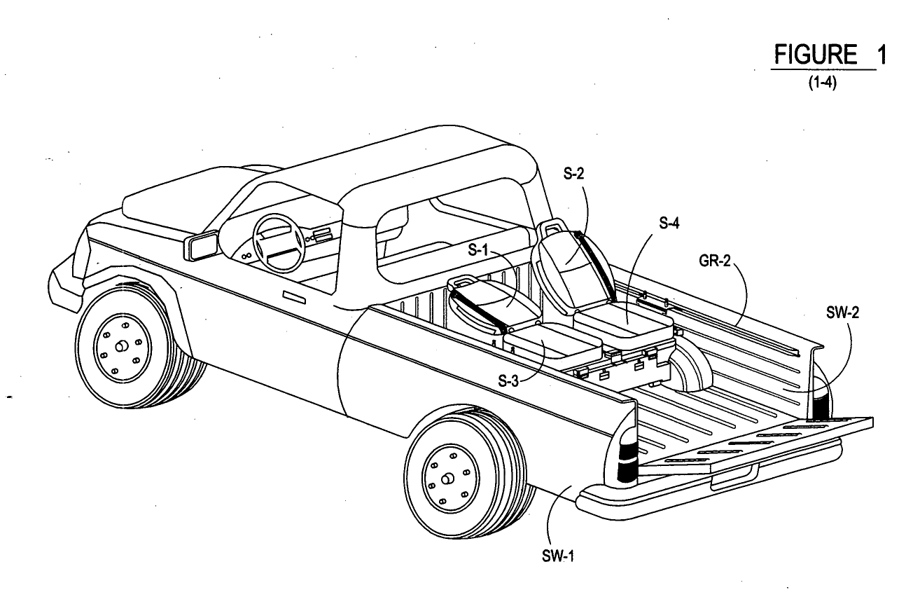

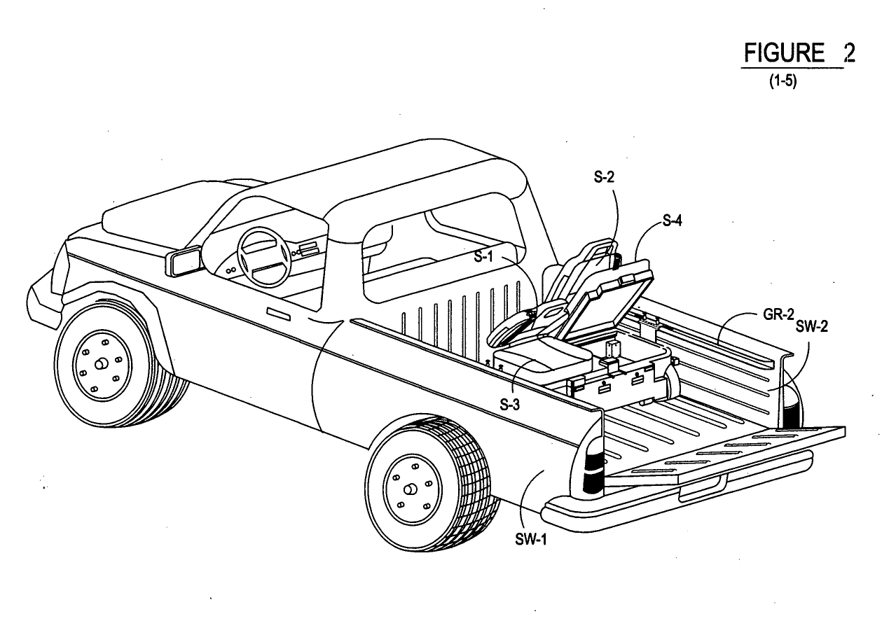

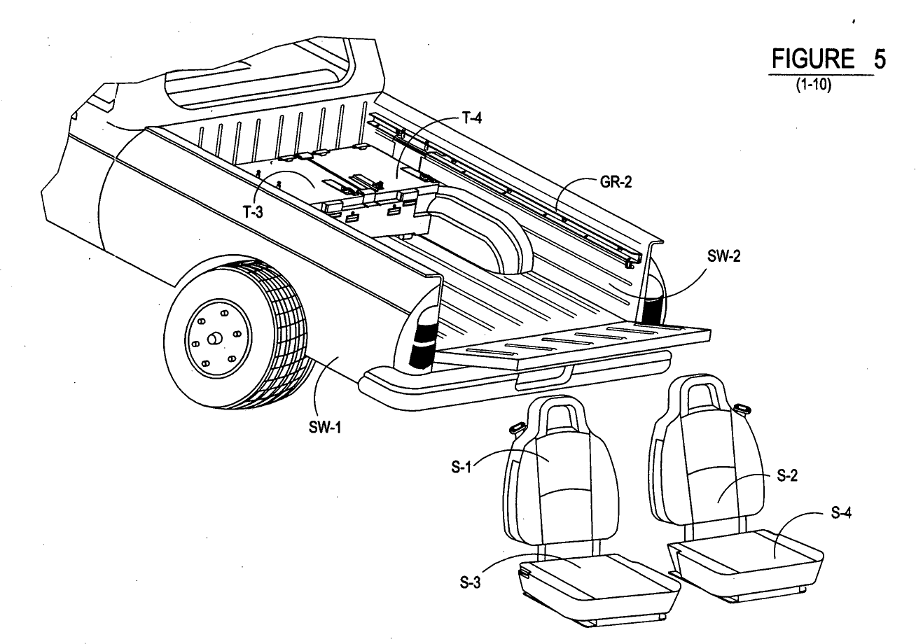

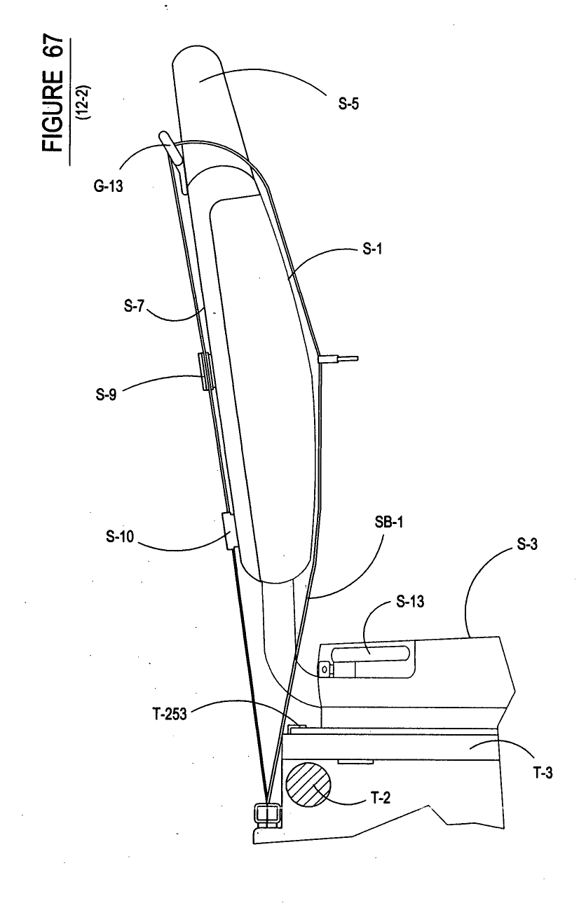

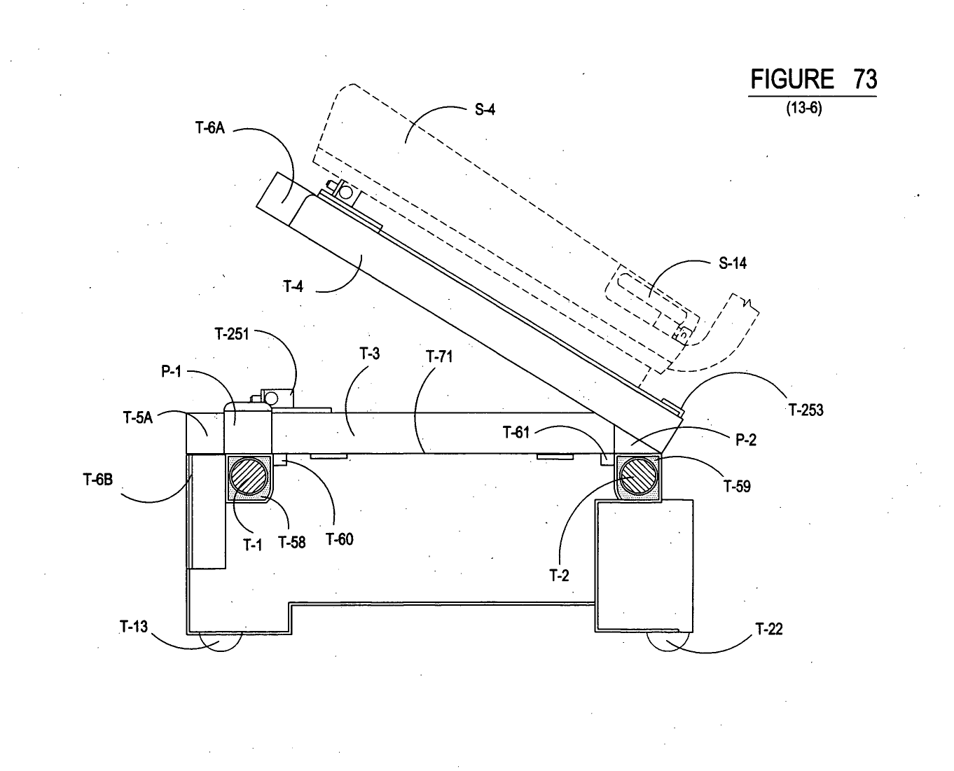

FIG. 1 shows an apparatus on the bed of a pickup truck comprising of a pair of bucket seats with a trunk underneath. The trunk has two lids, each lid being also the base on which a seat bottom and a backrest are mounted. See FIG. 5. Seat bottom S-3 and backrest S-1 are secured over trunk lid T-3 and seat bottom S-4 and backrest S-2 are secured over trunk lid T-4. Therefore, when the trunk lids are opened, the cushioned seat bottoms on top are likewise pivoted backward and up. See FIG. 2. And when the trunk lids are closed, said seat bottoms are likewise pivoted frontward and down, to rest in position for people to occupy the seats. Each trunk lid locks automatically when the trunk lid is closed. The backrests are fully-reclinable and can be locked in place with a key on reclining levers S-13 or S-14. See FIGS. 67 and 73. The backrests can be locked in place in any of several reclined positions to provide a safe temporary enclosure for possessions kept underneath said backrests in the open-topped pickup. See FIG. 1.

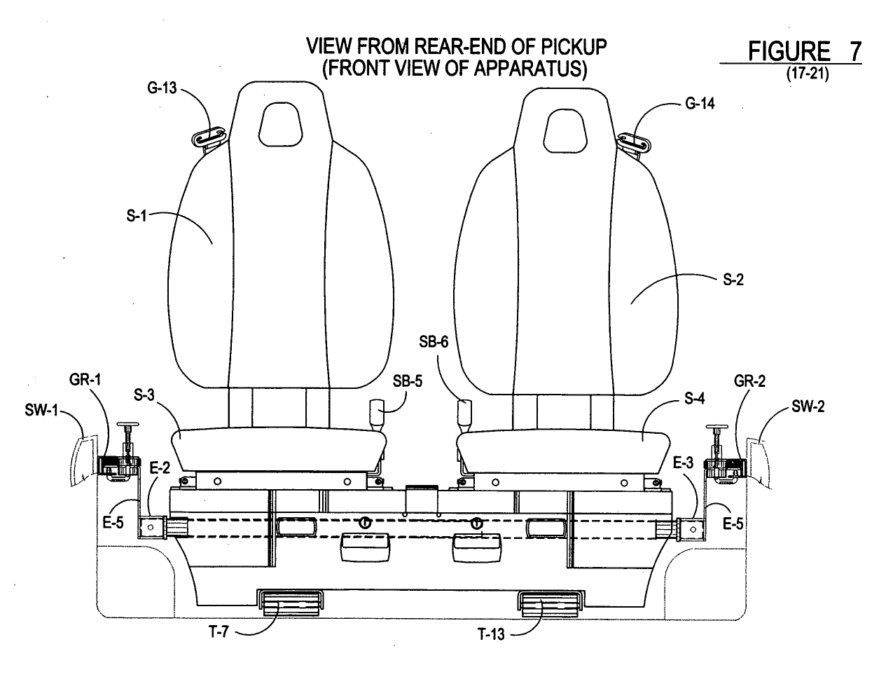

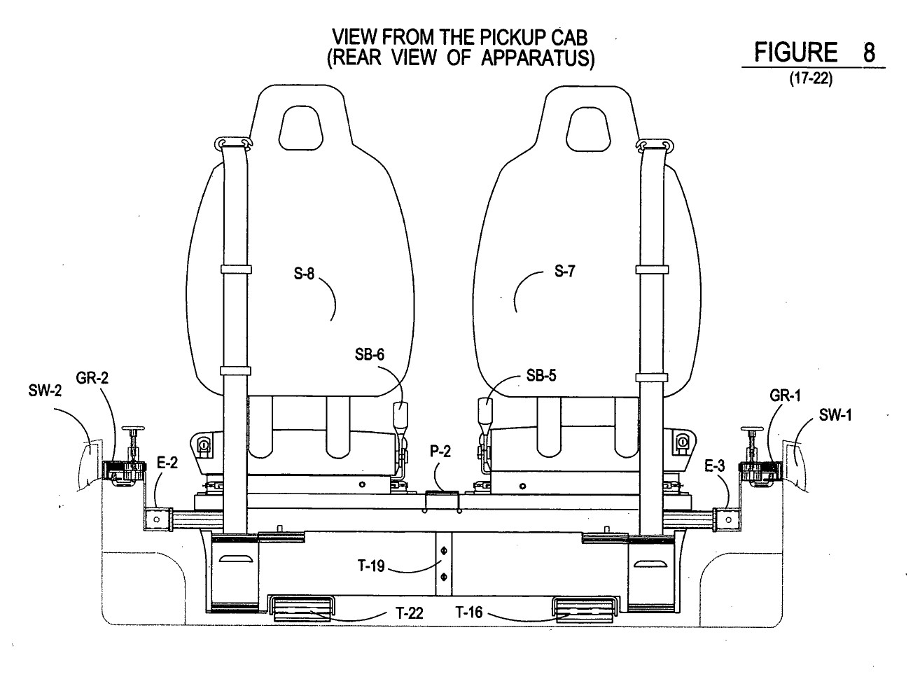

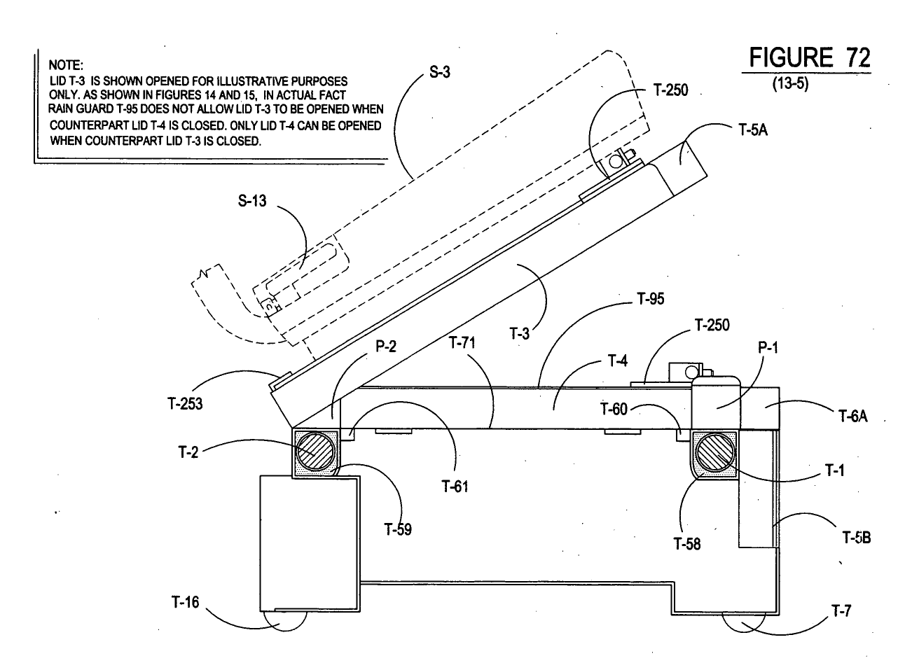

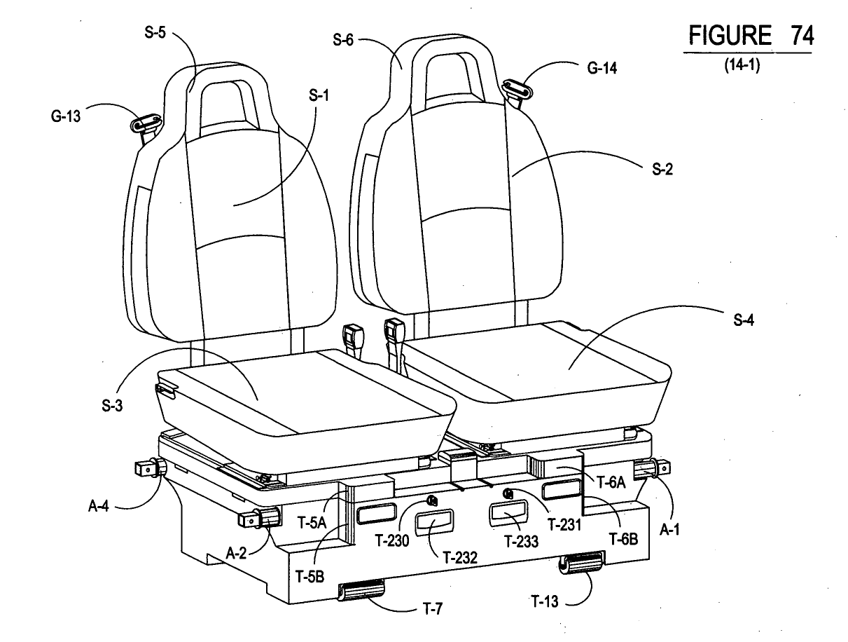

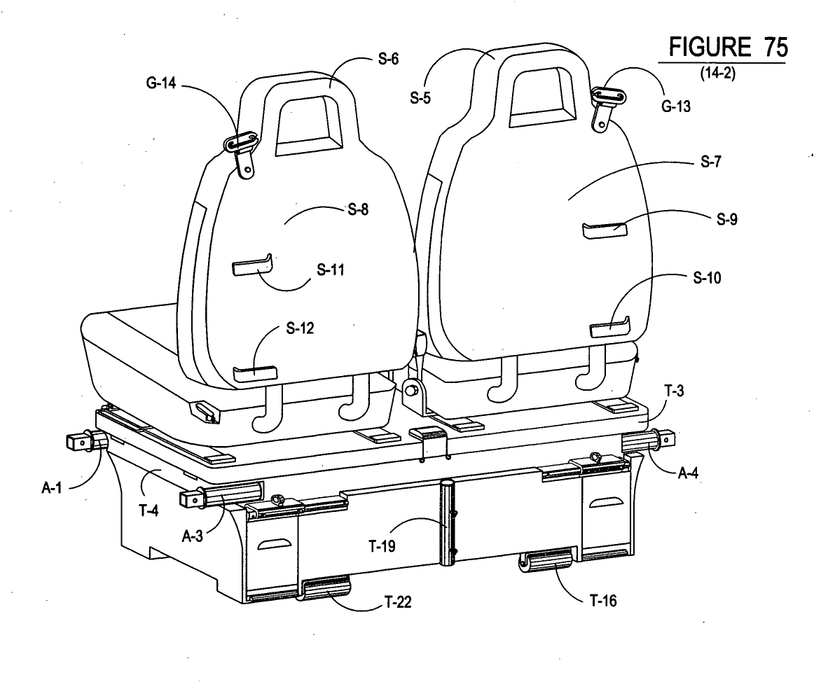

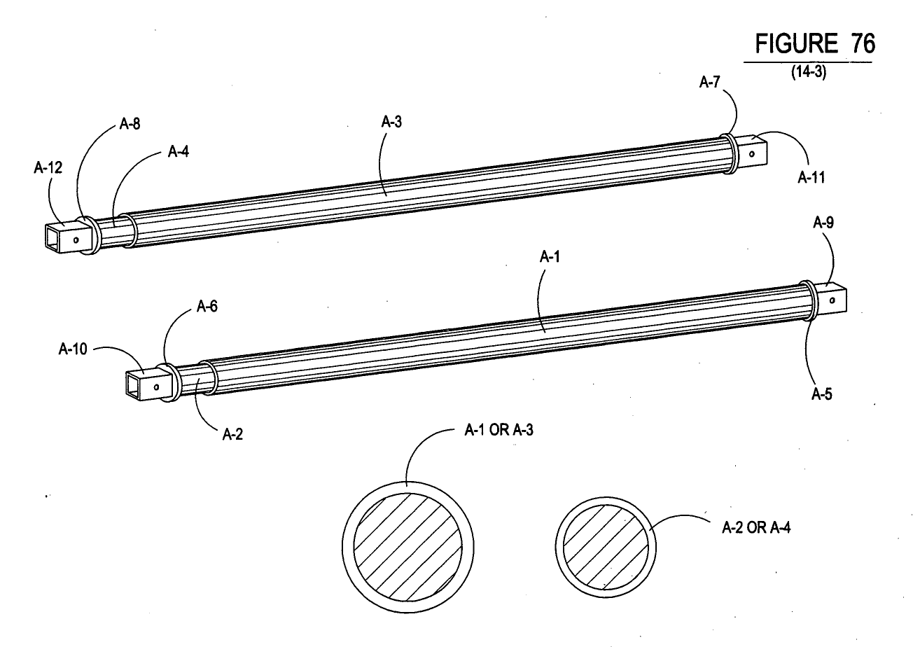

FIGS. 72 and 73 show that the trunk has two hollow trunk tubes immediately under its two lids, one front trunk tube T-1 and one rear trunk tube T-2, extending from one side of the trunk to the other. Then, as can be seen in FIG. 76, front trunk tube T-1 is designed to hold a double-ended telescopic arm comprised of front main tube A-1 partially enclosing front inner tube A-2. Rear trunk tube T-2 is likewise designed to hold a second double-ended telescopic arm comprised of rear main tube A-3 partially enclosing rear inner tube A-4. Each end of these double-ended telescopic arms has an end-disk and an end-block. The front double-ended telescopic arm thus has end-disk A-5 and end-block A-9 on one end, and end-disk A-6 and end-block A-10 on the other; while the rear double-ended telescopic arm has end-disk A-7 and end-block A-11 on one end, and end-disk A-8 and end-block A-12 on the other. In FIGS. 74 and 75 these double-ended telescopic arms are shown mounted within trunk tubes T-1 and T-2, with end-blocks and end-disks protruding outwardly from the trunk. In FIGS. 7 and 8 the extension of these double-ended telescopic arms is made for securing the apparatus to the side walls or side panels SW-1 and SW-2 on the back of the pickup truck.

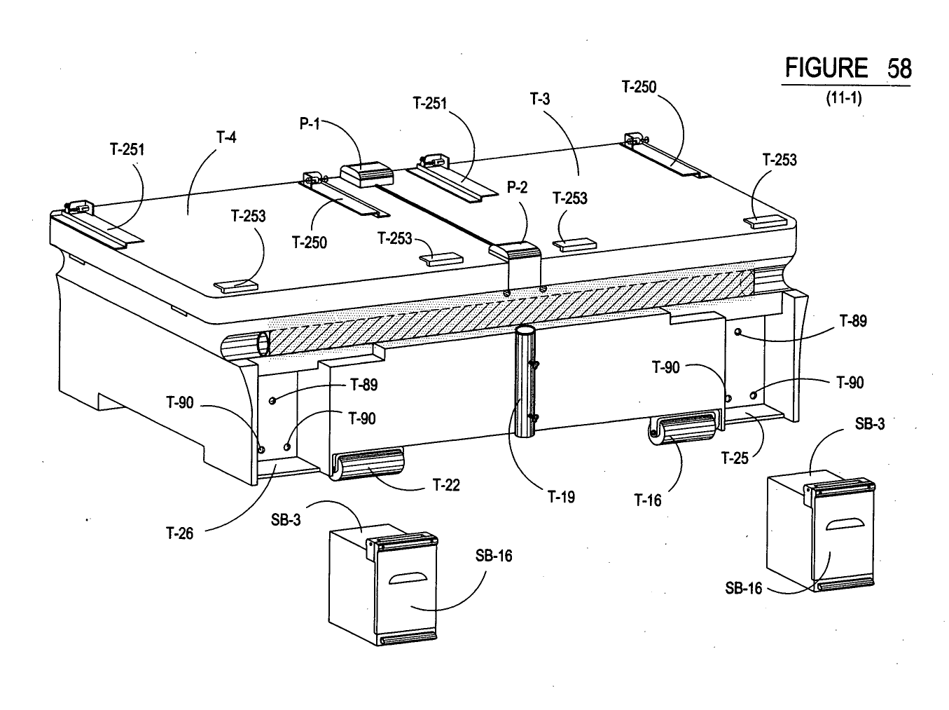

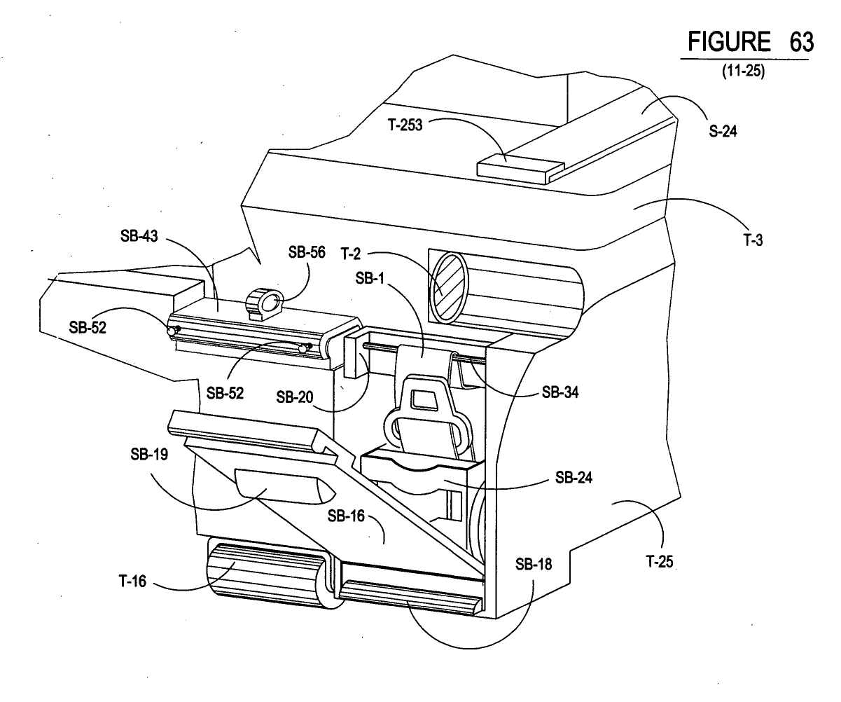

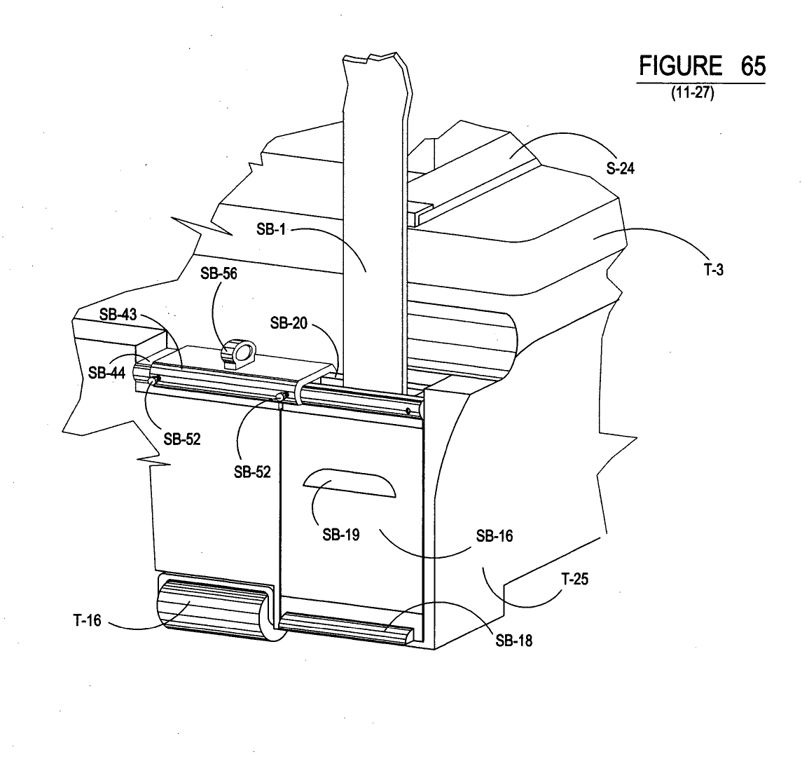

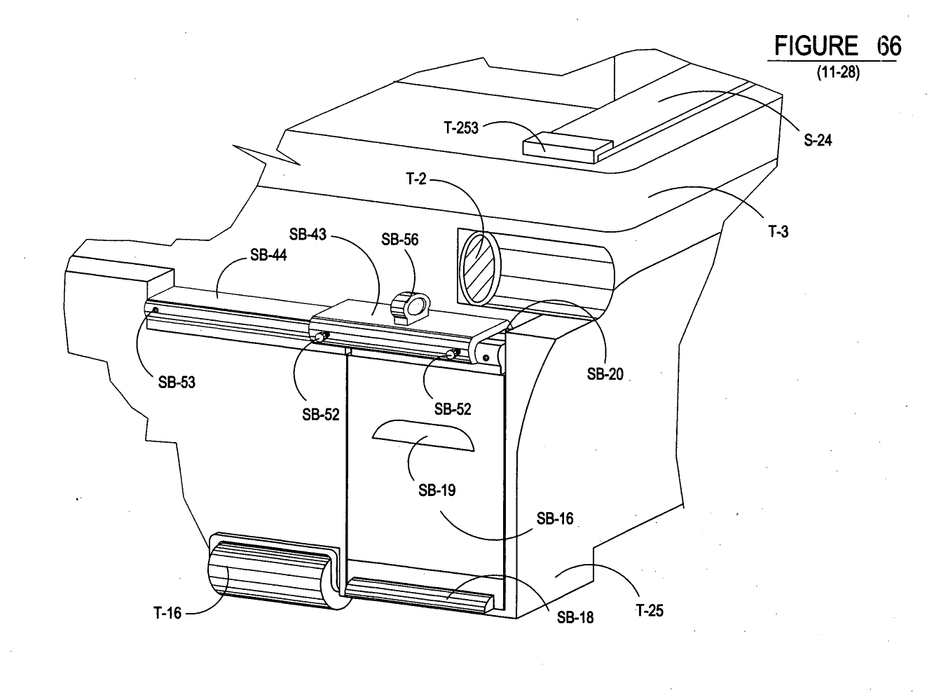

The trunk has a seat belt catch SB-3 on each rear corner, one for each seat. See FIGS. 58 thru 71. Each seat belt catch holds a seat belt SB-1 or SB-2 and a reel SB-24 with retractable means to recoil the seat belt automatically. The seat belt catch has a lid SB-16 which can be opened to replace the seat belt and the reel at any time. The top of the catch has a base or catch-top SB-20 on which a catch-slide SB-43 can be slid. If the catch-slide is positioned totally out of said catch-top, the lid then opens. See FIG. 63. If the catch-slide is slid to an intermediate position in which only a small part of the catch-slide is over the catch-top, the lid is then kept closed, but with the small seat belt opening exposed to provide passage for the belt. See FIG. 65. However, when the seat is not in constant use and the seat belt is kept fully recoiled, this opening on top of the lid should be closed to protect the seat belt and the reel inside the catch from water and the environment in the open-topped pickup truck. To shut this opening catch-slide SB-43 is slid further into catch-top SB-20. See FIG. 66.

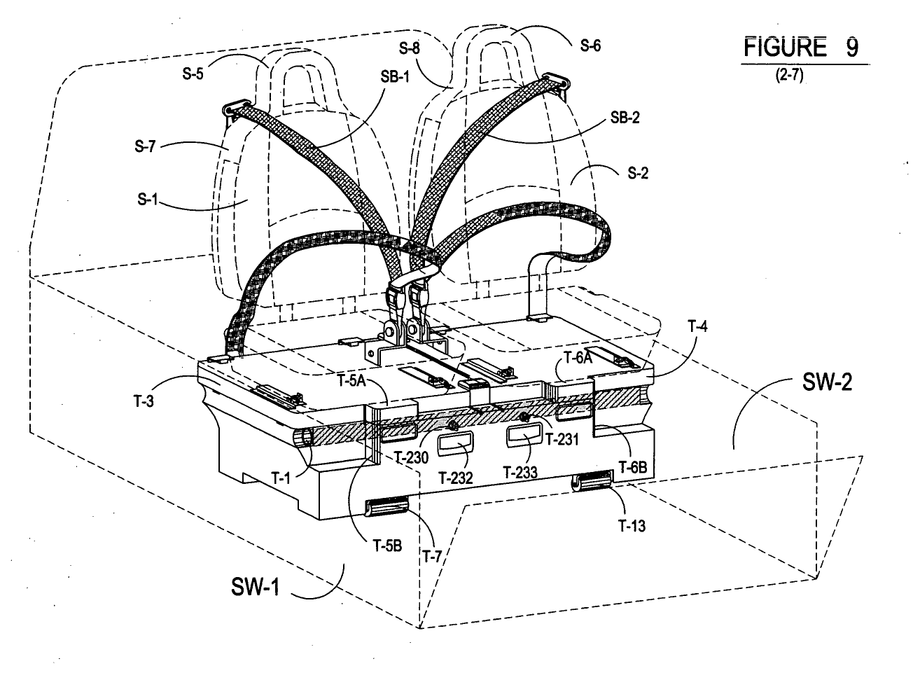

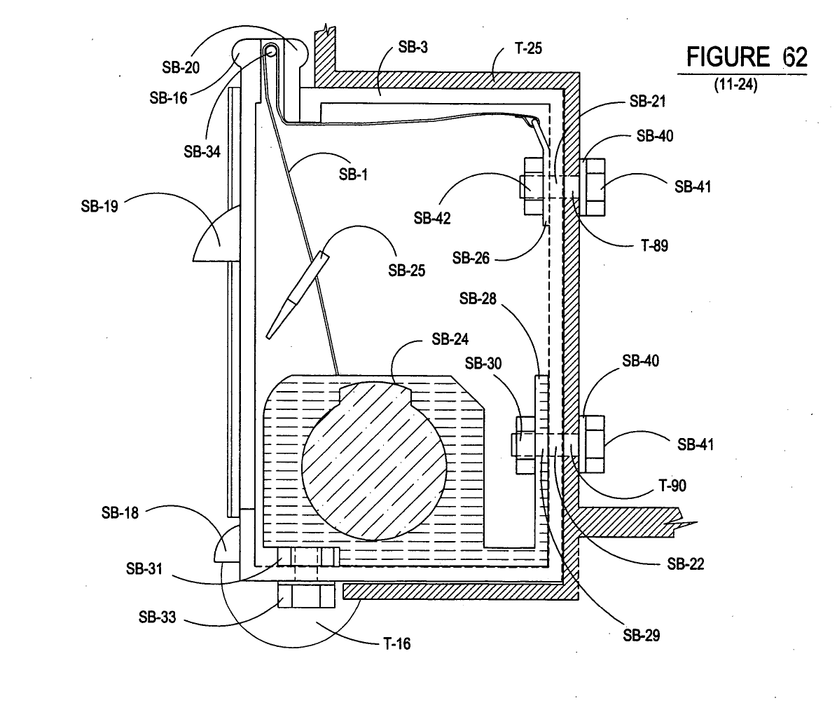

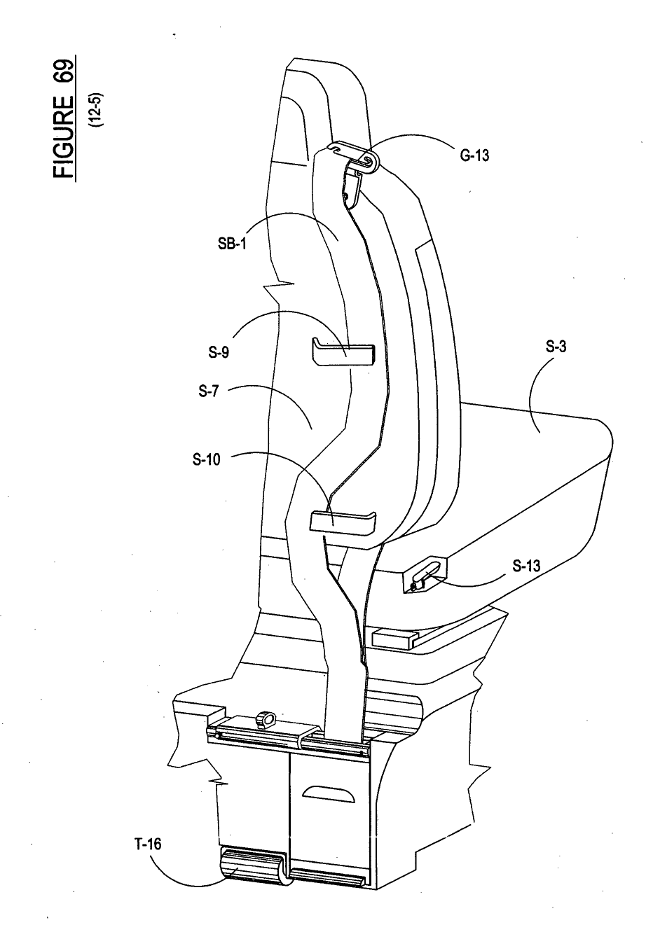

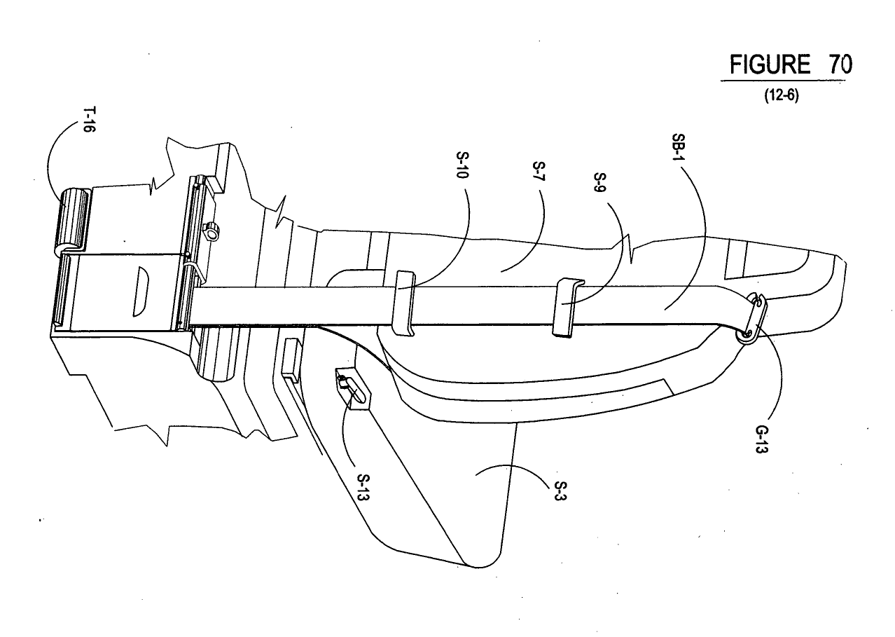

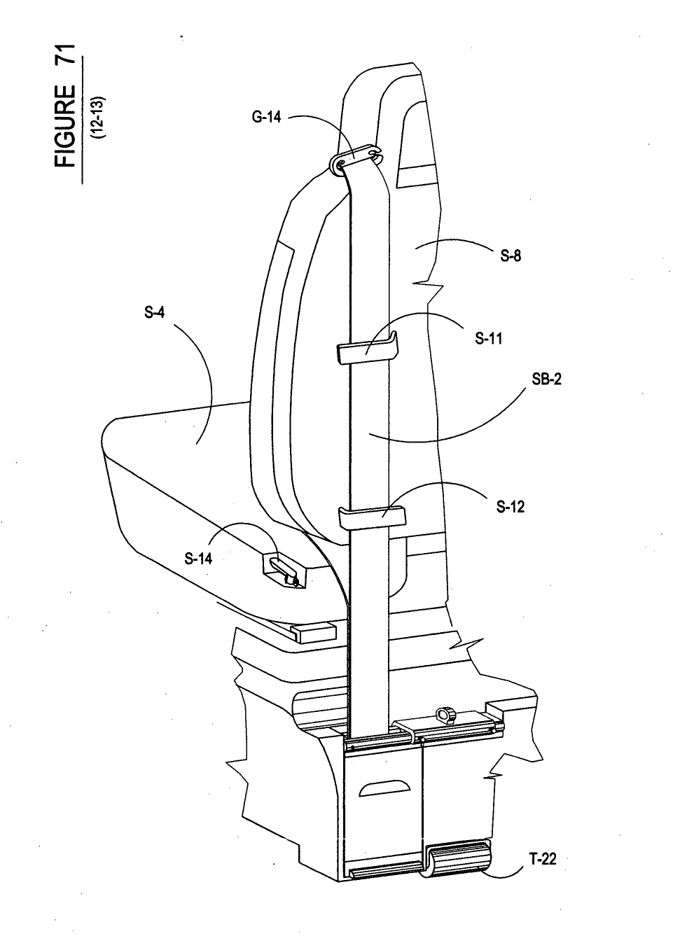

One end of the seat belt is secured to the reel and the other to the rear wall of the seat belt catch. See FIG. 62. The seat belt then unwinds in a loop, with one segment passing through the small seat belt opening between catch-top SB-20 and the top of lid SB-16 and going up directly behind the respective backrest and the other segment likewise passing through said opening but turning under the respective backrest to go up in front thereof. See FIG. 67. At this juncture, the seat belt no longer retracts to the reel freely as it is held and stretched over the backrest structure, half-way unwound to be readily available for use. To then use the seat belt, the seat occupant only has to extend the latter segment outwardly from the backrest until the buckle reaches a swingable seat belt fastener across the seat, where the buckle is fastened. See FIG. 9. To keep the seat belt half-way unwound and stretched over the backrest as shown, each seat belt has three seat belt guides, a swingable guide on the upper section of the backrest and two L-shaped fixed guides in the rear section of the backrest. See swingable seat belt guide G-13 and fixed seat belt guides S-9 and S-10 for seat belt SB-1 in FIGS. 67 thru 70 and swingable seat belt guide G-14 and fixed seat belt guides S-11 and S-12 for seat belt SB-2 in FIG. 71. Please note in FIGS. 69, 70 and 71 that in order to keep seat belts SB-1 and SB-2 straight up behind the backrests, directly in line with the respective seat belt catch, L-shaped seat belt guides S-9, S-10, S-11, and S-12 retain the seat belts from opposite sides. The short segments of these L-shaped guides secure the guides to the backrests and also retain the seat belts from opposite sides.

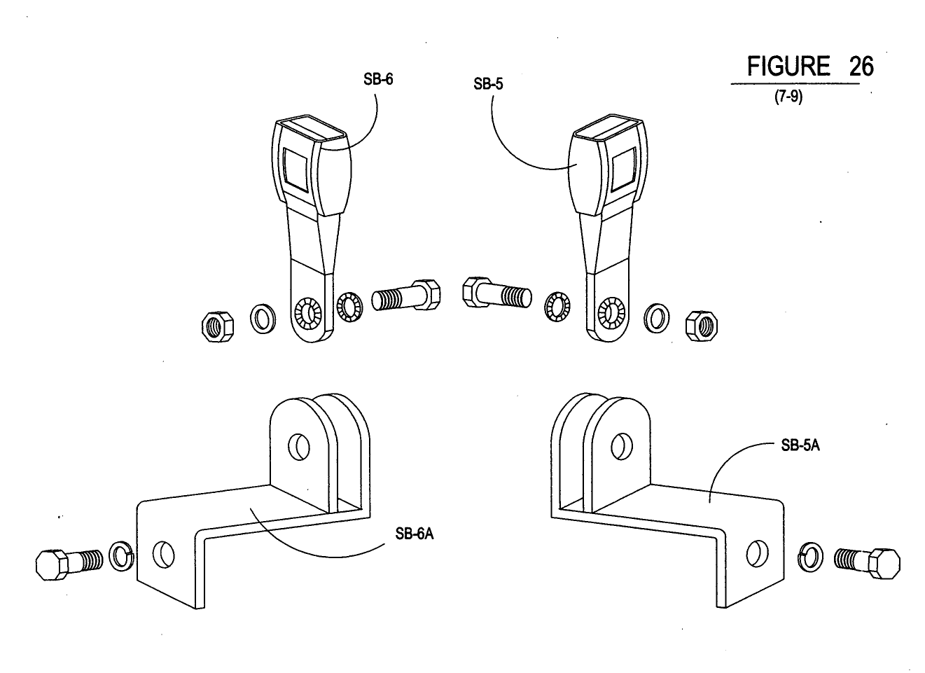

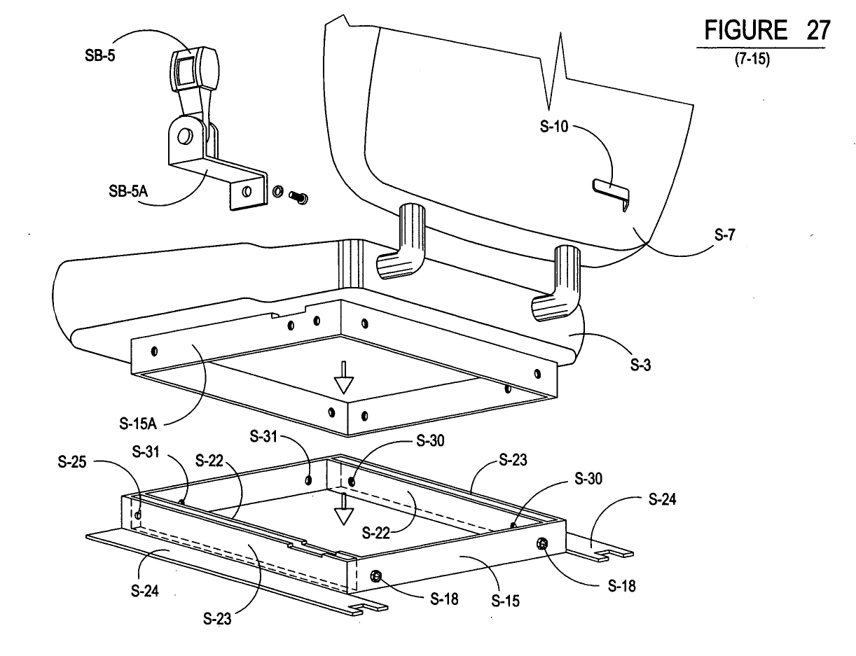

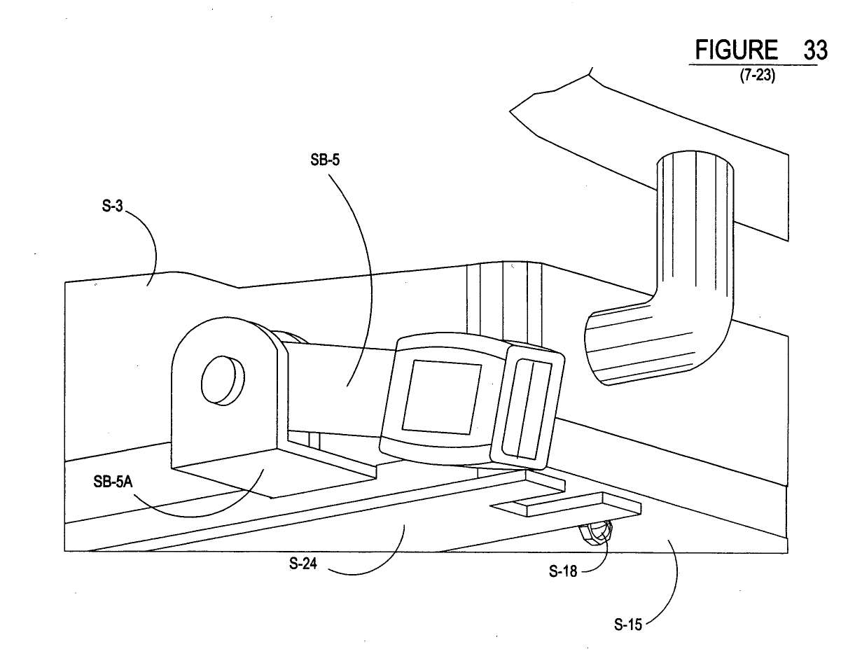

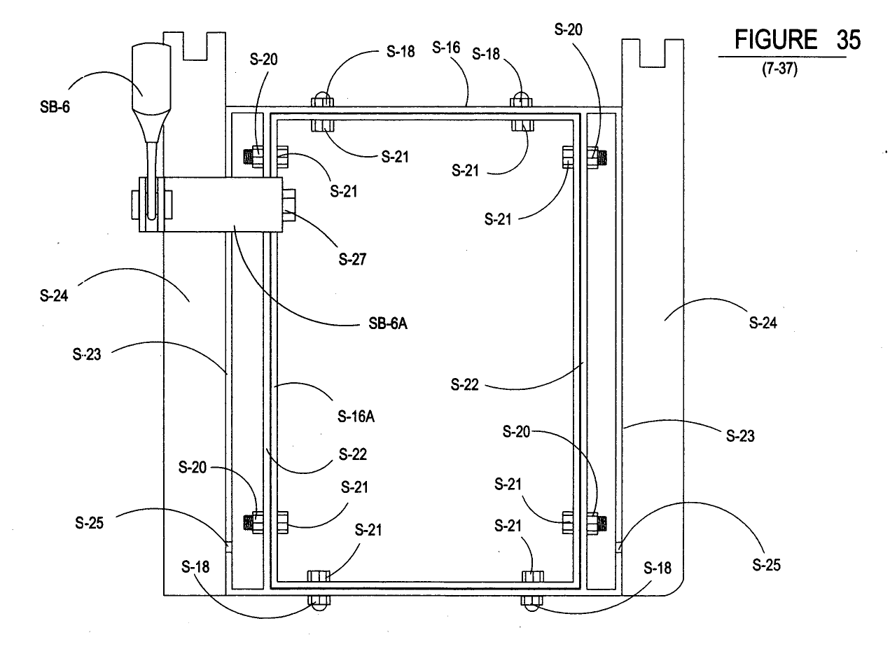

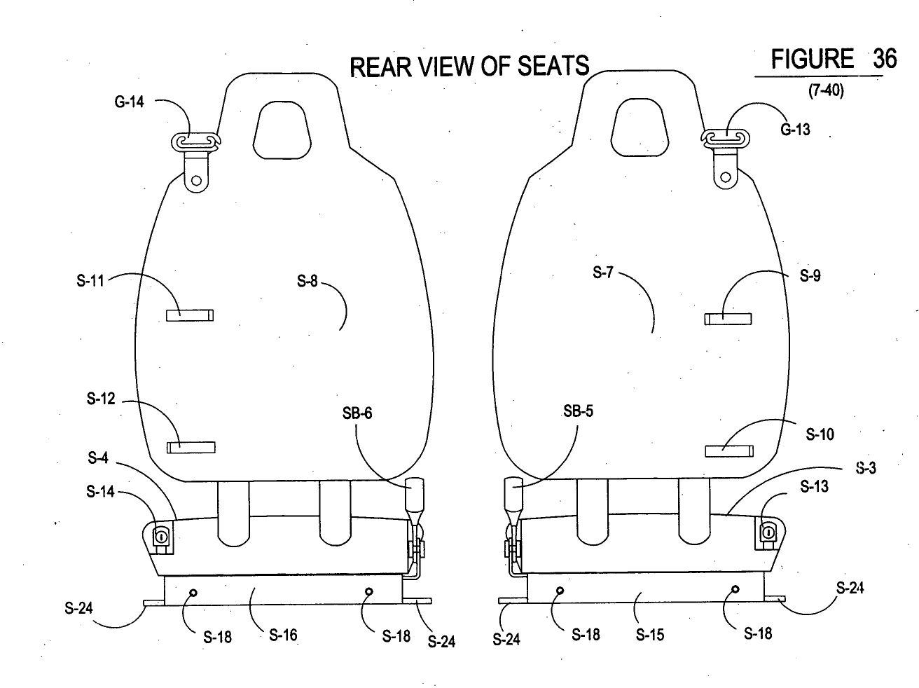

Each seat belt fastener is secured to an inner seat frame and an outer seat frame under seat bottom S-3 or S-4, and is positioned side by side with the other seat belt fastener. FIG. 26 shows the pair of seat belt fasteners SB-5 and SB-6, one for each seat belt or seat. FIGS. 27 thru 34 show how seat belt fastener SB-5 is secured to outer seat frame S-15 and inner seat frame 915A. FIG. 35 likewise shows how seat belt fastener SB-6 is secured to outer seat frame S-16 and inner seat frame S-16A. FIG. 36 shows seat belt fasteners SB-5 and SB-6 side by side, between the two seat bottoms S-3 and S-4. When the seat belts are not in use, the seat belt fasteners should be pivoted downward and to the rear, as in FIG. 33, to protect their internal mechanism from water and the environment in the open-topped pickup truck.

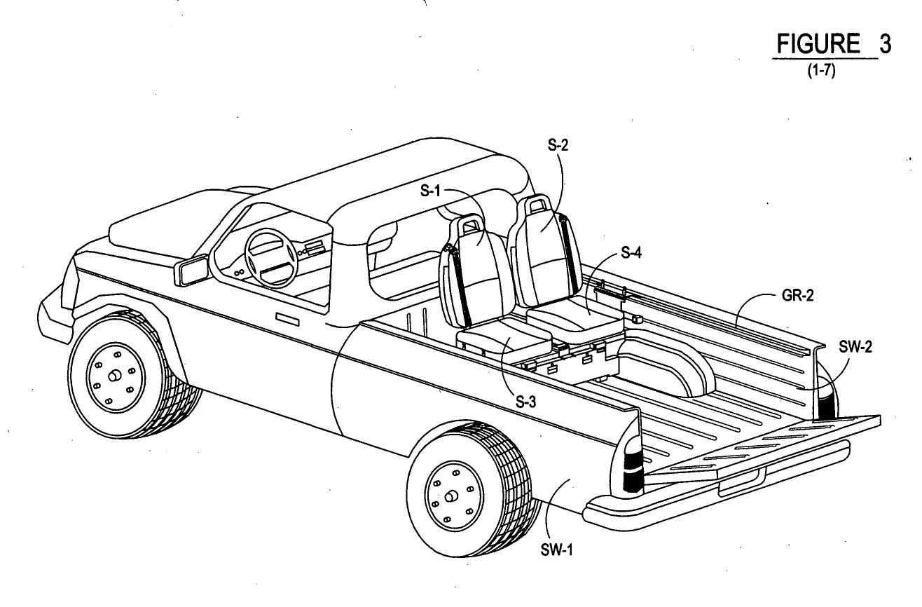

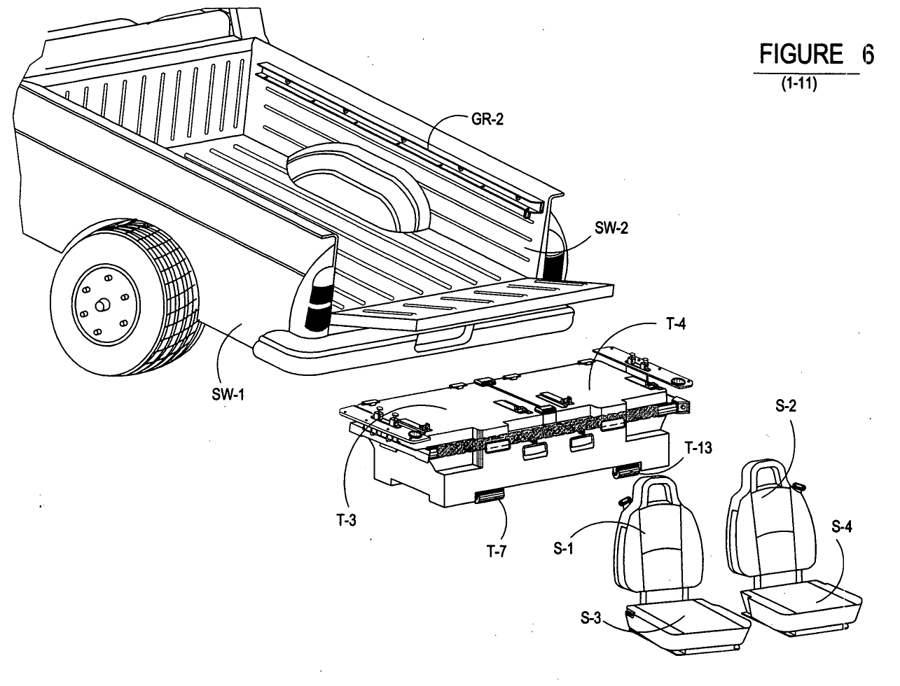

FIGS. 74 and 75 further show that underneath its bottom wall, the trunk has two front rollers T-7 and T-13 and two rear rollers T-16 and T-22. The trunk rollers facilitate the movement of the apparatus from one position to another in the pickup bed. If the backrests are needed fully or half-reclined the apparatus should be rolled to be secured in the intermediate position shown in FIG. 1. However, if the truck bed is needed to carry lots of cargo, then the apparatus should be rolled all the way back to be secured next to the cab as in FIG. 3, where the backrests can not be reclined backward. Alternatively, if the apparatus is needed off the truck bed for convenient storage at home or elsewhere, it should be rolled to the opposite direction, to be dismounted from the rear of the vehicle as shown in FIG. 6.

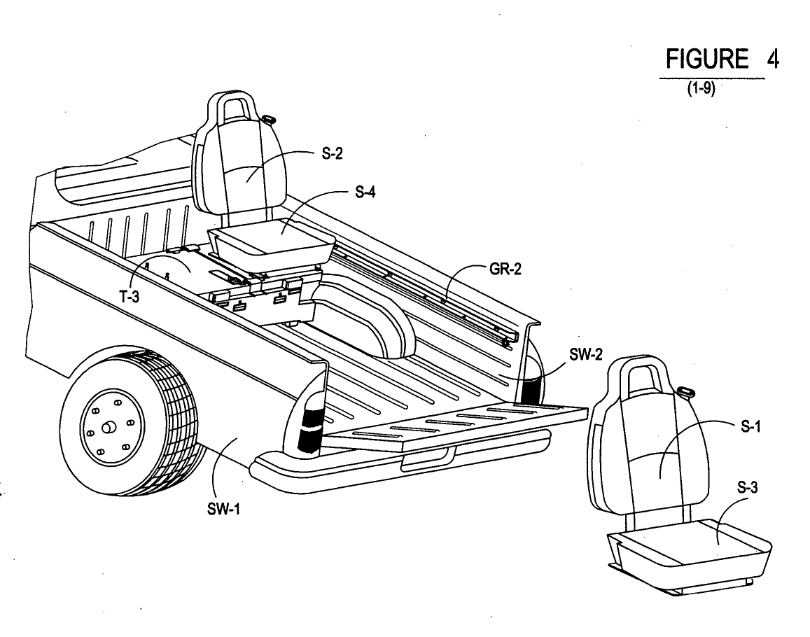

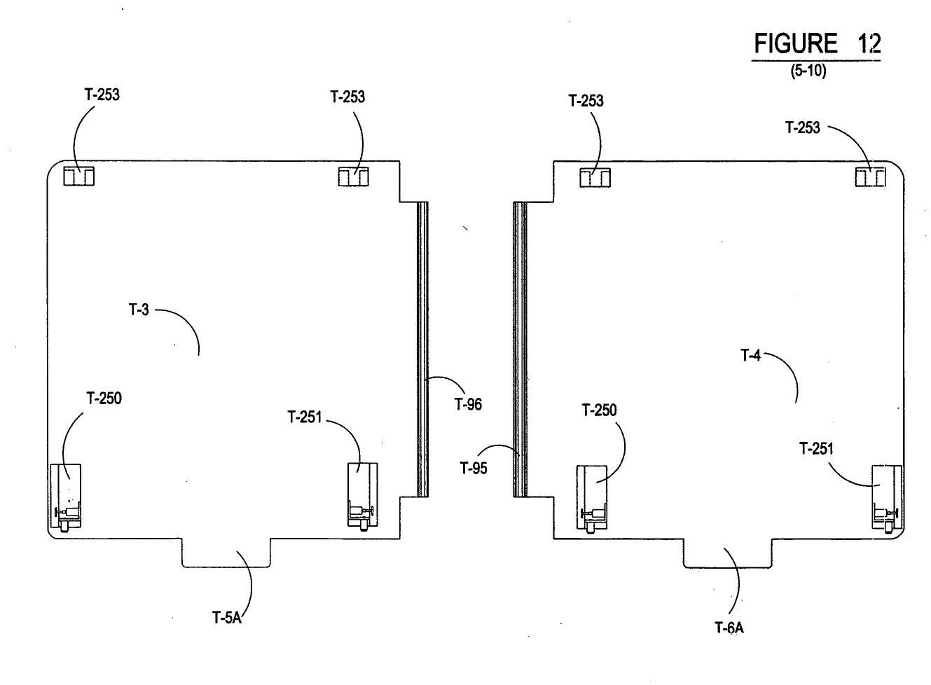

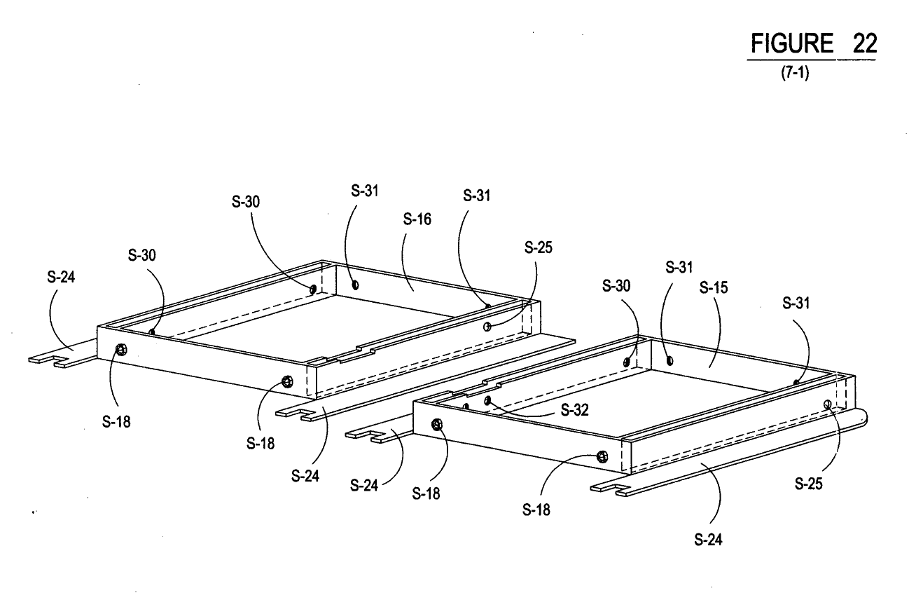

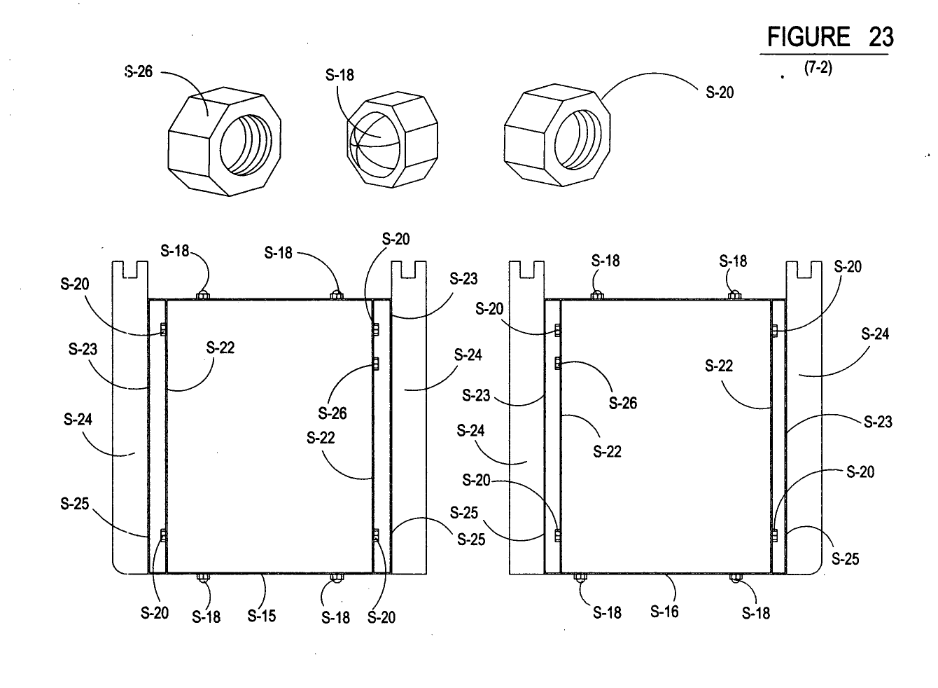

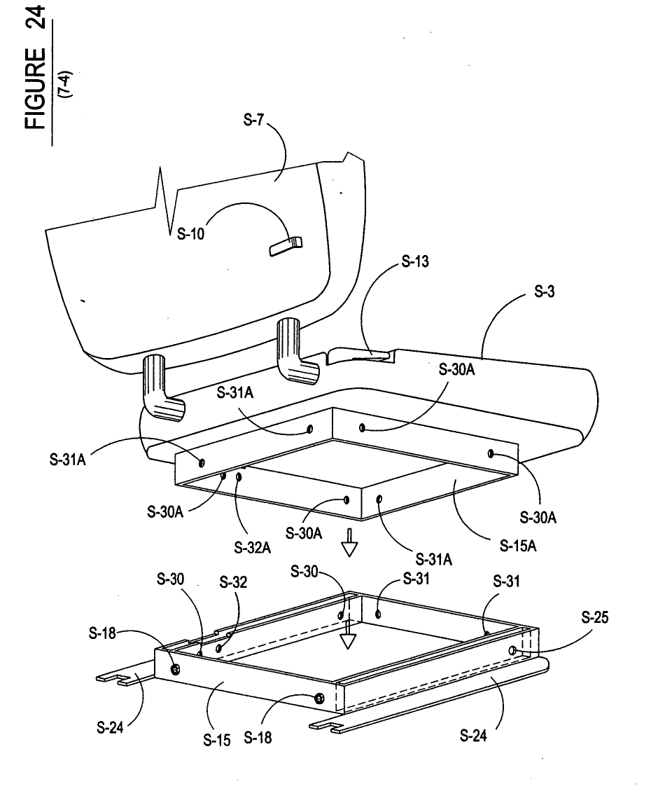

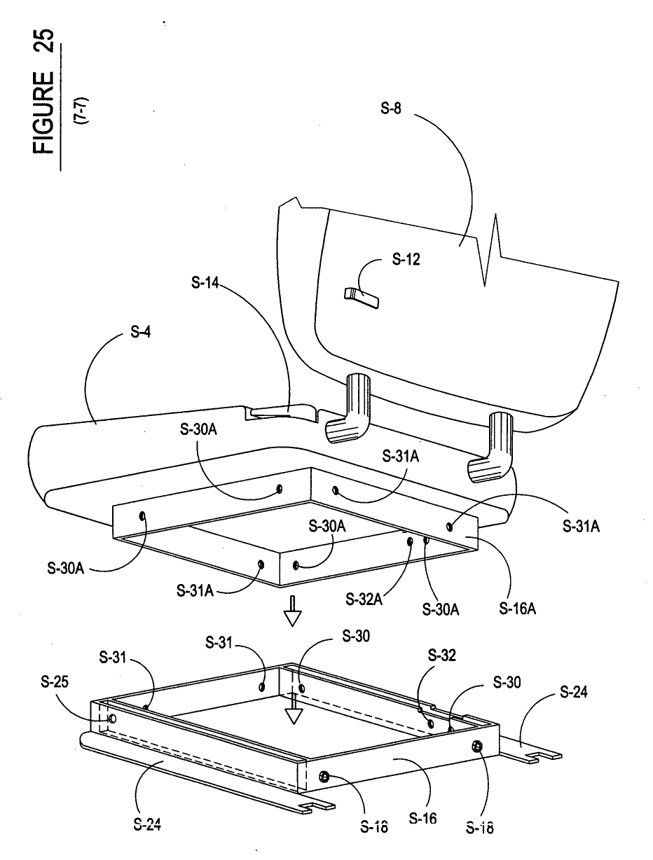

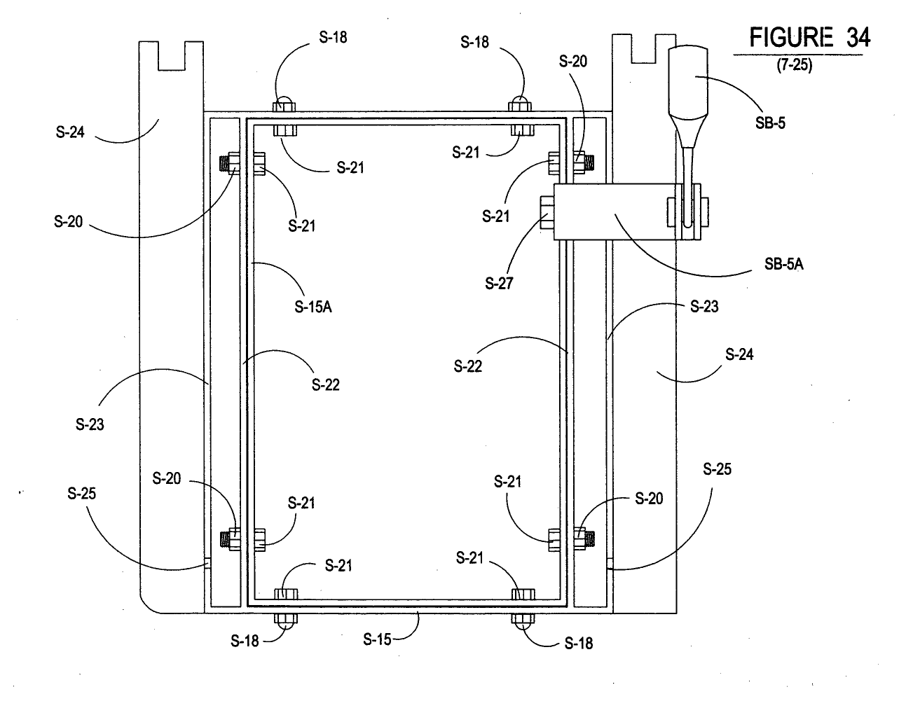

However, the entire apparatus need not be dismounted from the vehicle. As shown in FIGS. 4 and 5, seat bottoms S-3 and S-4 and the backrests can be removed and stored away, while the trunk remains on the bed of the truck For this purpose, each trunk lid T-3 or T-4 has four frame clips, a front frame clip T-250 and a front frame clip T-251 and two rear frame clips T-253. See FIG. 12. In addition, seat bottoms S-3 and S-4 also have underneath inner seat frames S-15A and S-16A respectively. See FIGS. 24 and 25. Inner seat frames S-15A and S-16A are designed to be secured with bolts S-21 to outer seat frames S-15 and S-16 respectively. See FIGS. 27 thru 31 and 34 and 35. Each inner seat frame S-15A or S-16A has a front segment, a rear segment and a side segment on each of its two sides. Each outer seat frame S-15 or S-16 has a front segment, a rear segment, an inner side segment S-22 and an outer side segment S-23 with a side board S-24 on each of its two sides. See FIGS. 22 and 23. Bolts S-21 securing inner seat frames S-15A and S-16A and outer seat frames S-15 and S-16 respectively extend from the side segments of the former to inner side segments S-22 of the latter. See FIGS. 34 and 35.

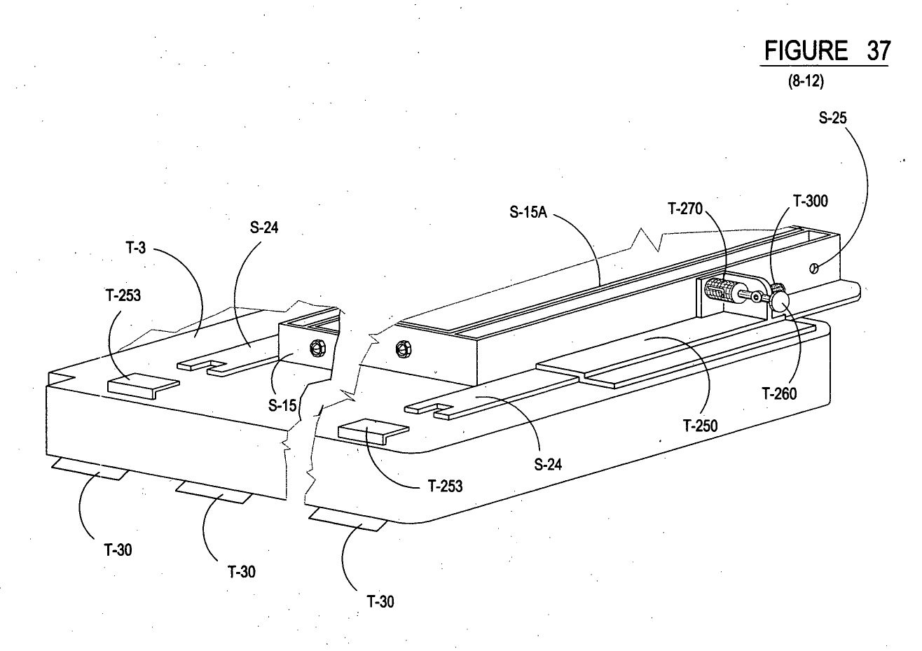

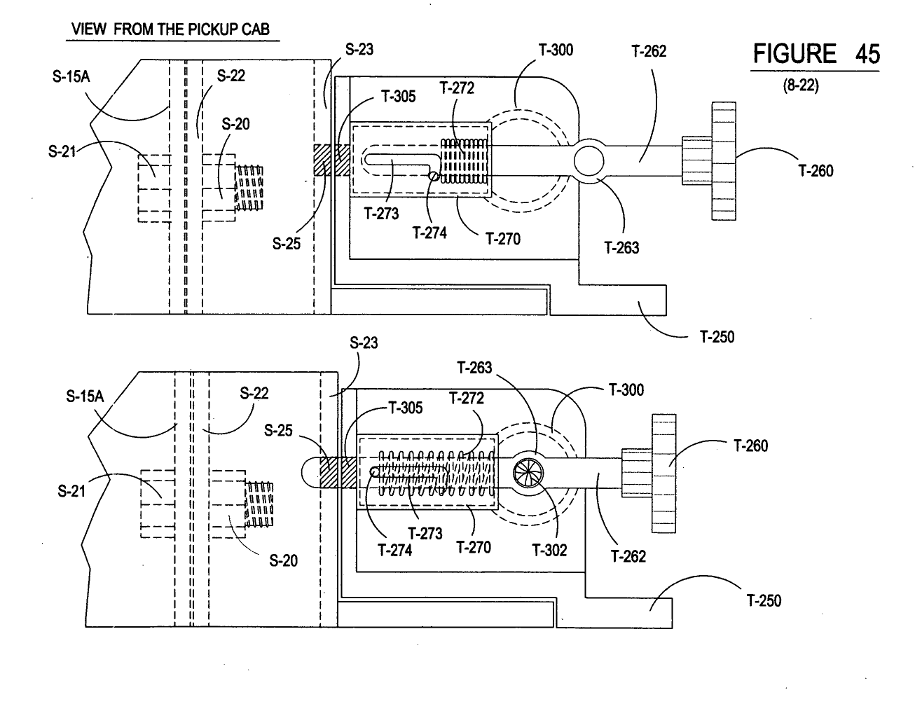

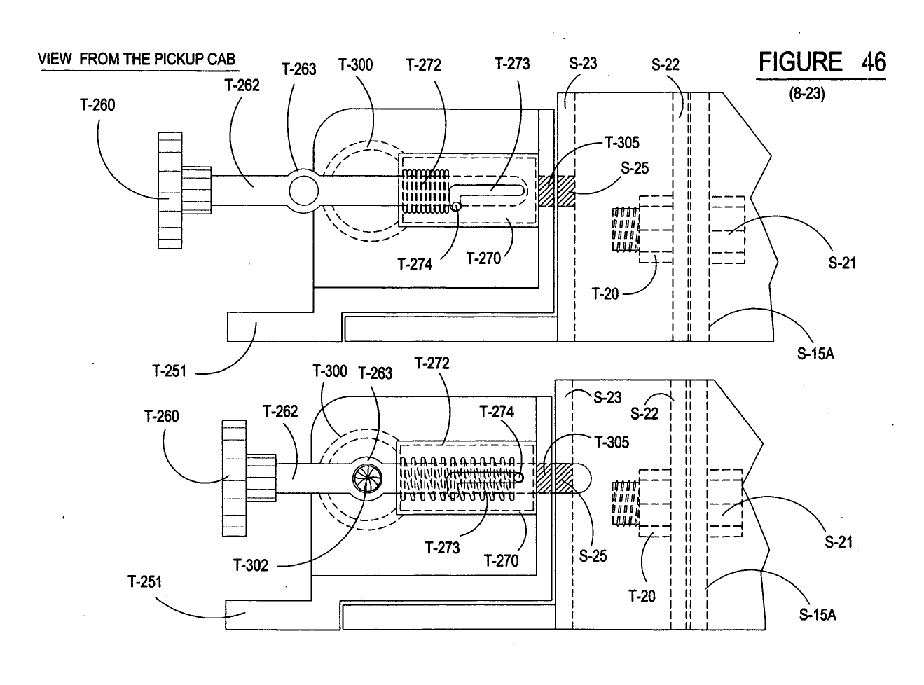

Side boards S-24 of outer seat frame S-15 or S-16 are designed to slide backward over trunk lid T-3 or T-4 respectively, and between the two front frame clips T-250 and T-251, until side board tips S-24A are clipped by rear frame clips T-253. See FIGS. 37 thru 44. As these side board tips S-24A are clipped by rear frame clips T-253, security pins T-262 mounted on front frame clips T-250 and T-251 enter holes S-25 on outer side segments S-23, to thus secure seat bottom S-3 or S-4 and the respective backrest to trunk lid T-3 or T-4 underneath. See FIGS. 45 and 46.

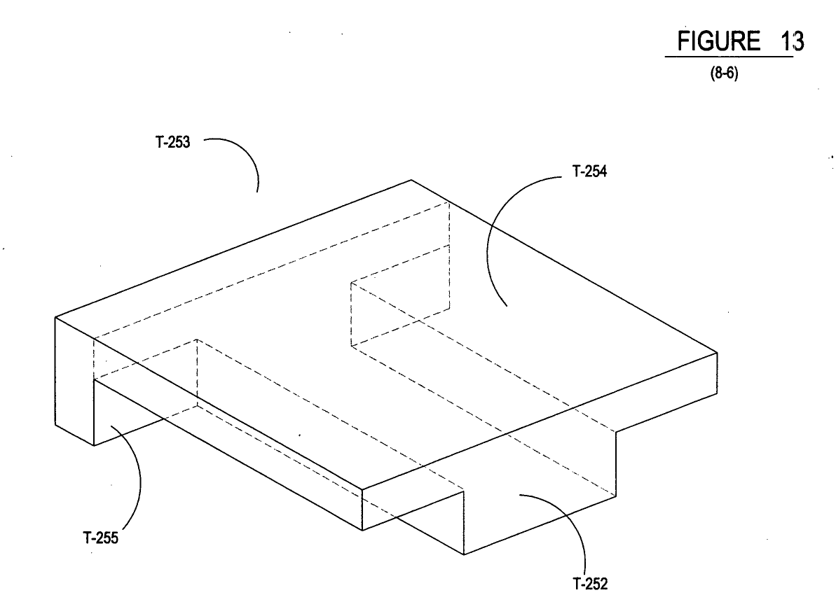

As shown in FIG. 13, each rear frame clip has three divisions, with a back panel T-255, a top panel T-254 and a middle divide T-252. FIGS. 37 thru 44 show that when outer seat frame S-15 or S-16 is slid back over a trunk lid, back panels T-255 stop side boards S-24 from sliding further backward, as top panels T-254 enclose side board tips S-24A and middle divides T-252 fill the entire space between said side board tips, for a firmer grip.

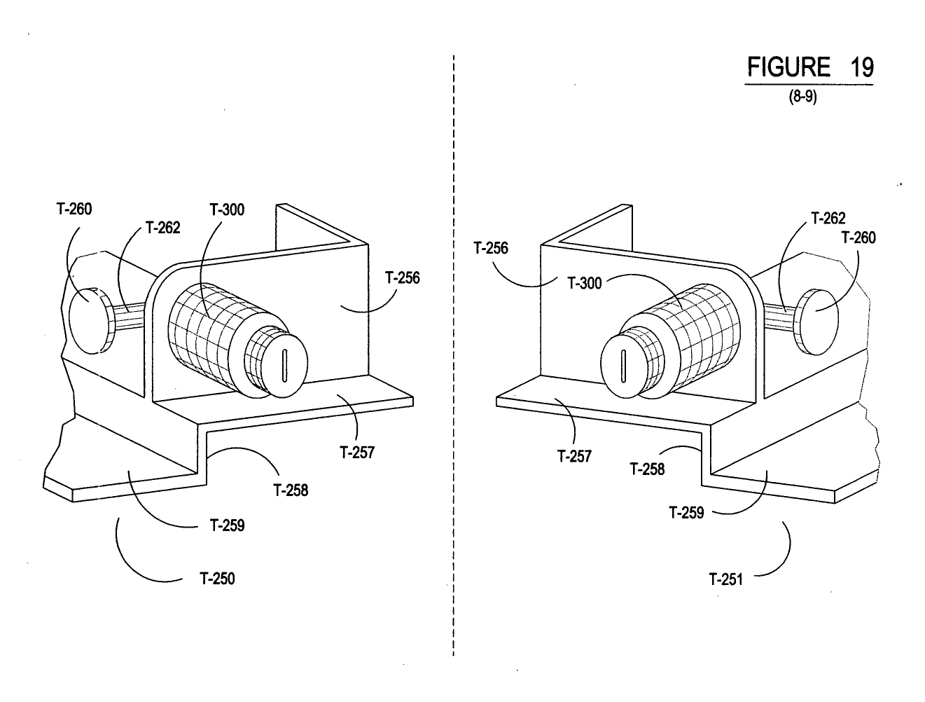

FIGS. 19 thru 21 show that each front frame clip T-250 or T-251 is essentially comprised of a connecting base T-259, a side board guide T-258, and a platform T-257 which carries a support structure T-256 holding a security pin T-262 and a lock unit T-300. The two front frame clips T-250 and T-251 of trunk lid T-3 or T-4 face each other, so that when outer seat frame S-15 or S-16 is slid over the respective trunk lid, the two side boards S-24 pass snugly between side board guides T-258 and under platforms T-257. FIGS. 37 thru 44 show that when outer seat frame S-15 or S-16 is being mounted over trunk lid T-3 or T-4 respectively, side board guides T-258 and platforms T-257 guide sliding side boards S-24 toward rear frame clips T-253.

FIGS. 19 thru 21 further show that lock units T-300 are oriented perpendicularly to security pins T-262 and are secured to the long section of support structures T-256 over platforms T-257. Security pins T-262 are held by horizontally oriented chambers T-270 secured to the short section of support structures T-256, which end up side by side to outer side segments S-23 when outer seat frame S-15 or S-16 is mounted over trunk lid T-3 or T-4 respectively. Security pins T-262 have nose ends which fit snugly on holes T-305 on the short section of support structures T-256 and in corresponding holes S-25 on outer side segments S-23. When side board tips S-24A on side boards S-24 are clipped by rear frame clips T-253, holes T-305 on support structures T-256 on front frame clips T-250 and T-251 always coincide with holes S-25 on outer side segments S-23, allowing said nose ends of security pins T-262 to pass through, thus securing outer seat frame S-15 or S-16 to front frame clips T-250 and T-251. See FIGS. 37 thru 46, and 49 thru 52.

Security pins T-262 terminate in handles T-260, and along their solid shafts have ring-shaped openings T-263 and also perpendicularly oriented groove pins T-274. Groove pins T-274 pass through the circumference of chambers T-270 and can move back and forth within L-shaped parallel grooves T-273 on these chambers. When groove pins T-274 are retained by the short segment of L-shaped parallel grooves T-273, as shown at the top of FIGS. 45 and 46, springs T-272 inside chambers T-270 and security pins T-262 are held back and holes S-25 remain free. With security pins T-262 and holes S-25 in this manner, outer seat frame S-15 or S-16 is free to move, and seat bottom S-3 or S-4 and the respective backrest can slide off the trunk. See FIGS. 4 and 5.

However, when handles T-260 on security pins T-262 are turned sideways to allow groove pins T-274 to reach the long segment of L-shaped parallel grooves T-273 on chambers T-270, springs T-272 are allowed to expand, propelling groove pins T-274 and security pins T-262 towards outer side segments S-23. If this occurs when holes T-305 on support structures T-256 on front frame clips T-250 and T-251 coincide with holes S-25, as shown at the bottom of FIGS. 45 and 46, the nose ends of security pins T-262 will pass through to secure outer seat frame S-15 or S-16 to said front frame clips. Once security pins T-262 secure both outer side segments S-23 of outer seat frame S-15 or S-16, the respective seat bottom and backrest are firmly retained in place and therefore ready for use on top of the trunk.

To secure the seat bottoms and the backrests from theft, or ensure that the seat bottoms and the backrests are not removed from a trunk on the open-topped pickup truck, lock units T-300 on front frame clips T-250 and T-251 can be used to block security pins T-262 so that said security pins can not be pulled back from outer side segments S-23 of outer seat frame S-15 or S-16. When security pins T-262 secure outer side segments S-23 and key K is turned on lock units T-300, lock pins T-302 move out from said lock units to pass through support structures T-256 and then through ring-shaped openings T-263 on security pins T-262. See FIGS. 19 thru 21 and 47 and 48. When this occurs, lock pins T-302 immobilize security pins T-262 so that said security pins can not be pulled back from outer side segments S-23, until key K is reintroduced in lock units T-300 and said lock pins T-302 recede into said lock units.

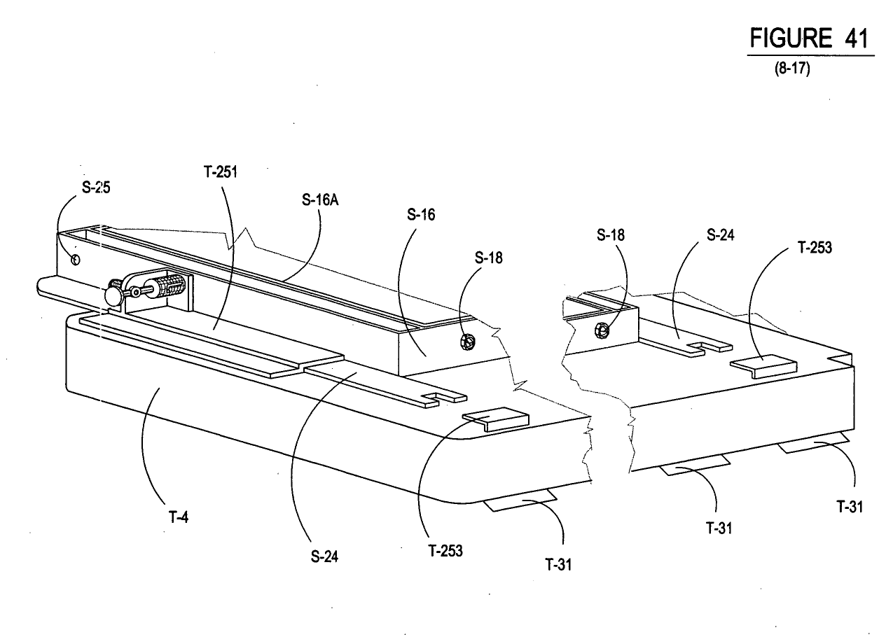

Once lock pins T-302 have receded into lock units T-300, handles T-260 can be pulled back and then turned to keep security pins T-262 back from outer side segments S-23. This action retains groove pins T-274 in the short segment of L-shaped parallel grooves T-273 on chambers T-270, and maintains springs T-272 in place. See the top of FIGS. 45 and 46. Once this operation is repeated on both front frame clips on trunk lid T-3 or T-4, outer seat frame S-15 or S-16 can be slid off the trunk lid to remove and store away seat bottom S-3 or S-4 and the respective backrest. See FIGS. 4, 5, 37 and 41.

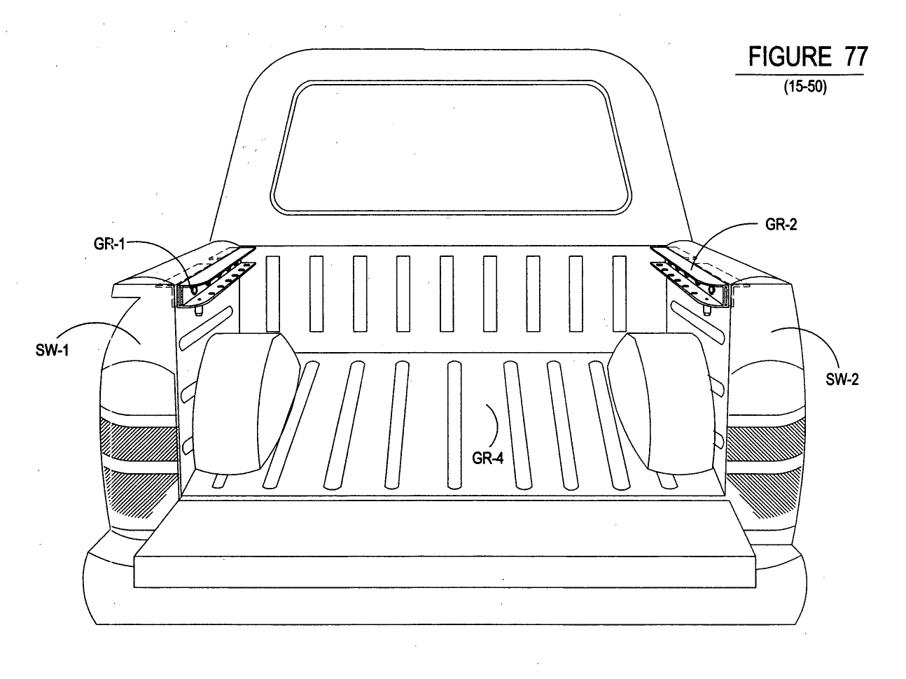

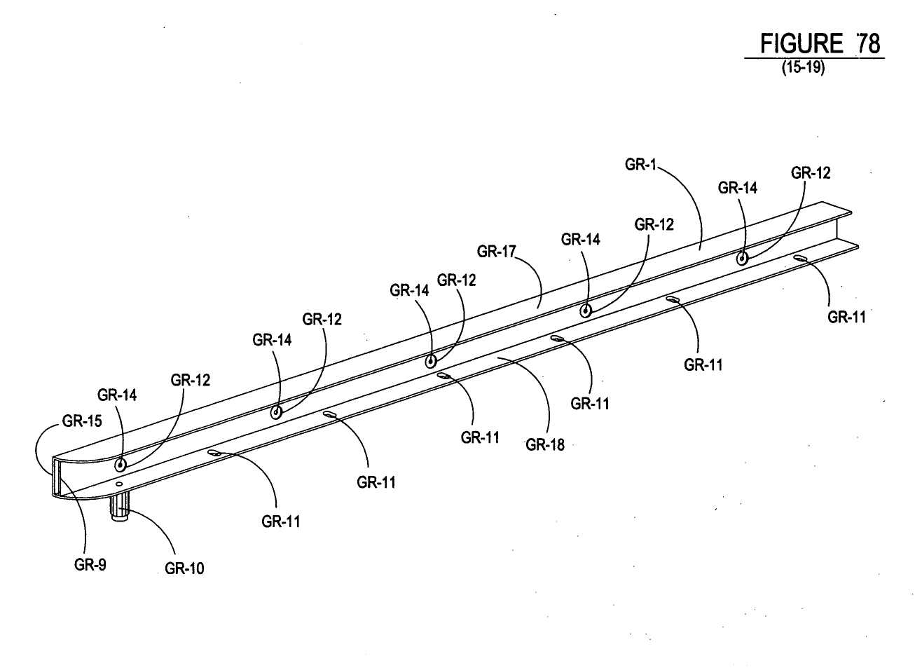

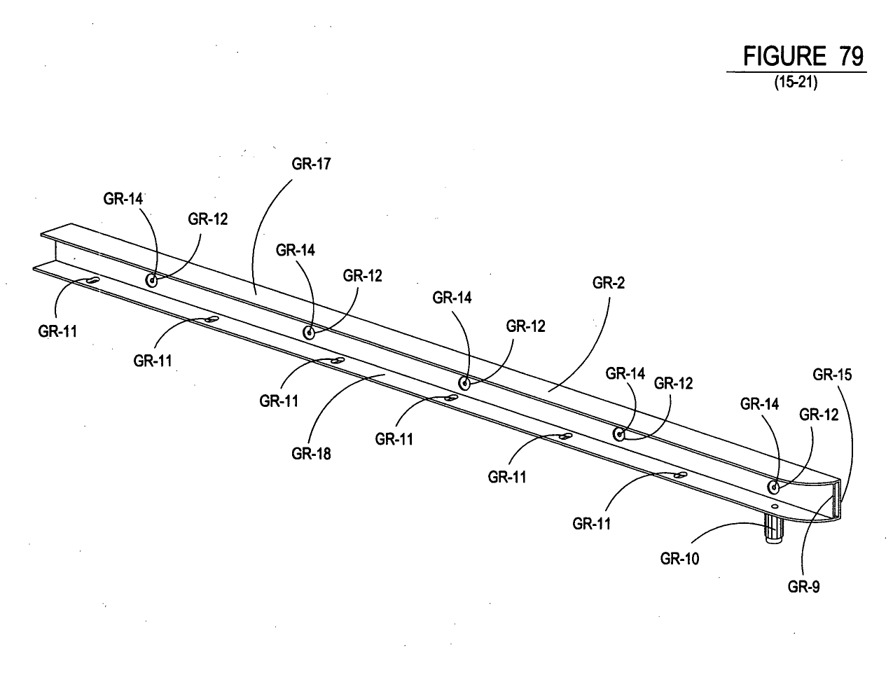

Referring now to FIG. 77, a conventional pickup truck has an open-topped area behind the cab. This area behind the cab has a bottom wall or bed covered with a liner GR4, front and back sides and two opposite side walls or side panels SW-1 and SW-2. FIG. 77 shows rigid guide rails GR-1 and GR-2 mounted on the interior section of side panels SW-1 and SW-2. The guide rails are illustrated in FIGS. 78 and 79.

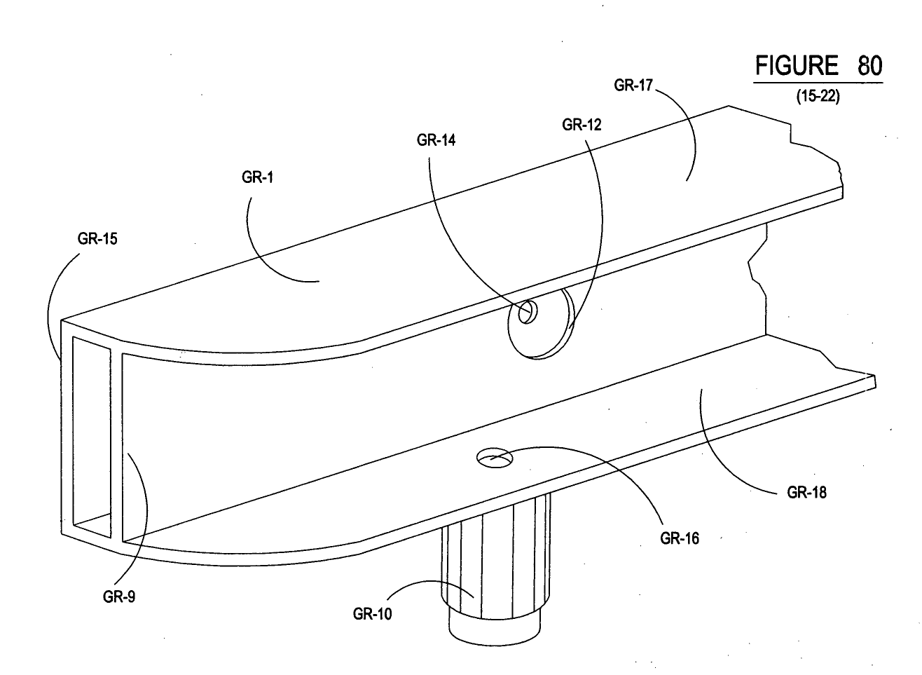

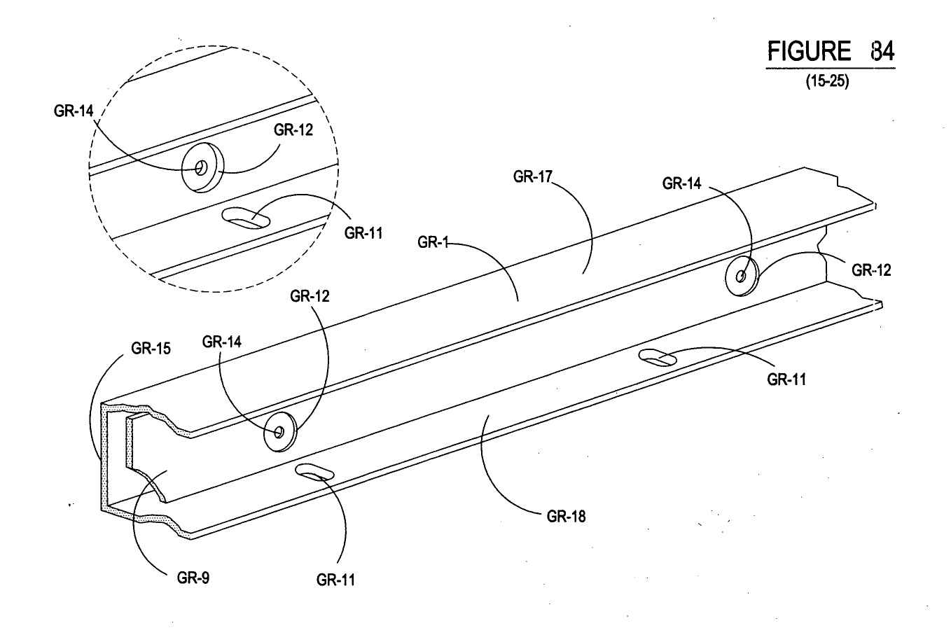

FIGS. 78 thru 86 show that each guide rail has two vertical walls, a first vertical wall GR-9 and a second vertical wall GR-15, a horizontal bottom wall GR-18 and a horizontal top wall GR-17. Bottom wall GR-18 has a series of elongated stop holes GR-11 equidistant from each other. See FIGS. 84 thru 86. The guide rails should be affixed to the upper interior section of side panels SW-1 and SW-2 with stop holes GR-11 on guide rail GR-1 in perfect alignment with stop holes GR-11 on guide rail GR-2. As shown in FIGS. 80 thru 83 bottom walls GR-18 also have a lock hole GR-16 for a lock pin GR-13 on a lock unit GR-10. Lock units GR-10 are controlled with a key K. The first vertical wall GR-9 has a series of big holes GR-12 and the second vertical wall GR-15 has a corresponding series of small holes GR-14.

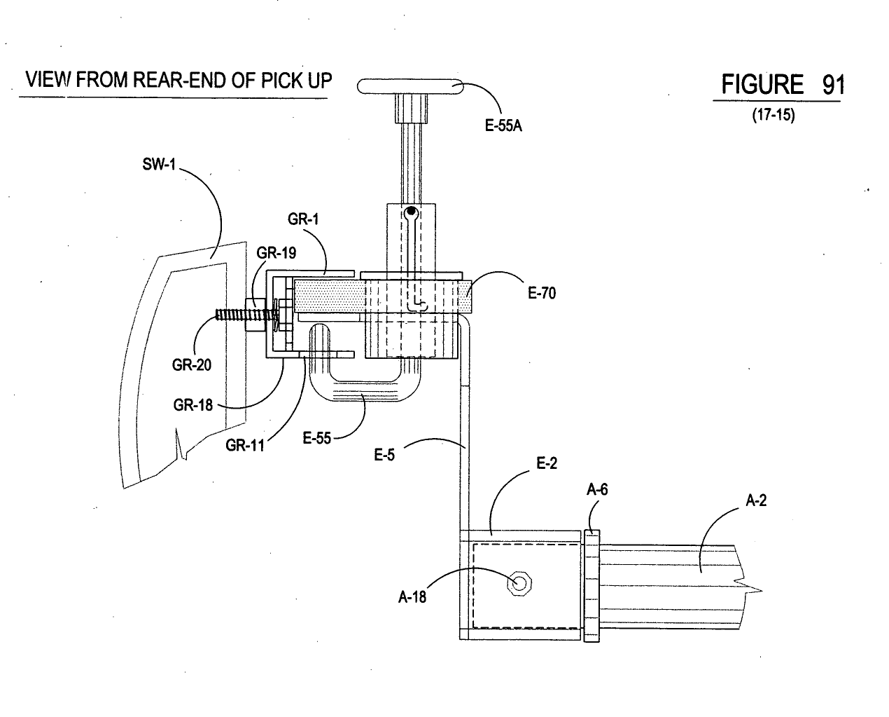

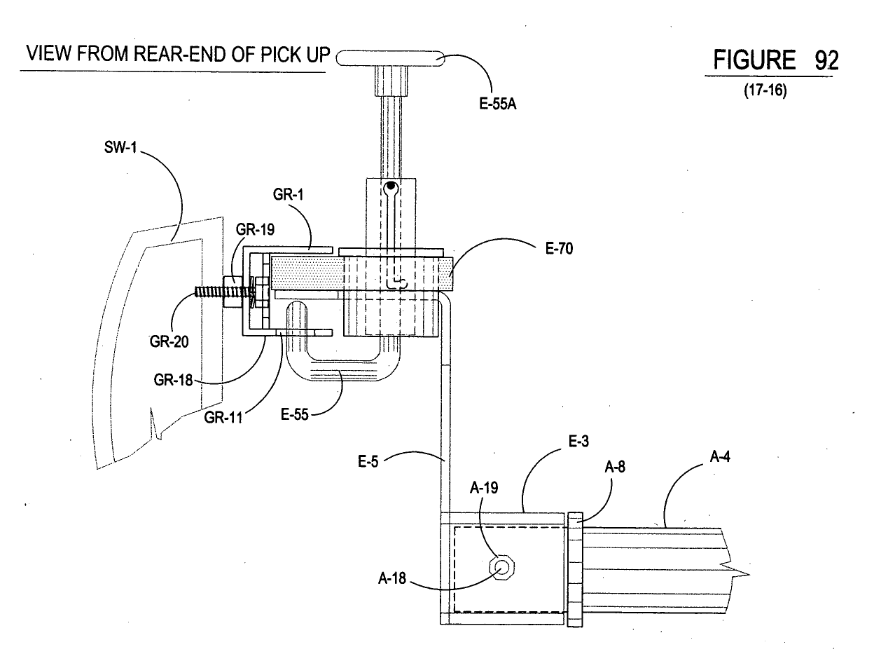

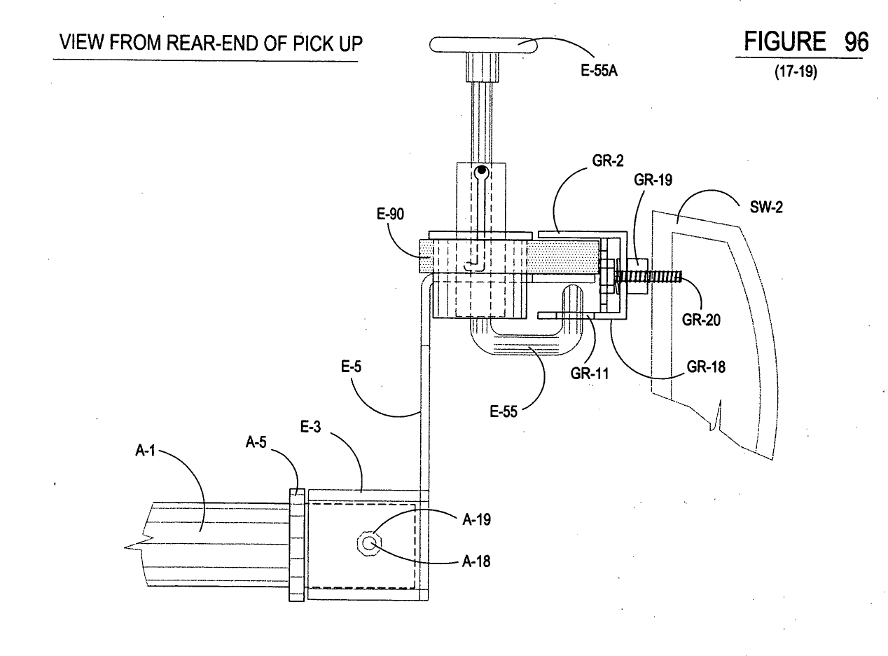

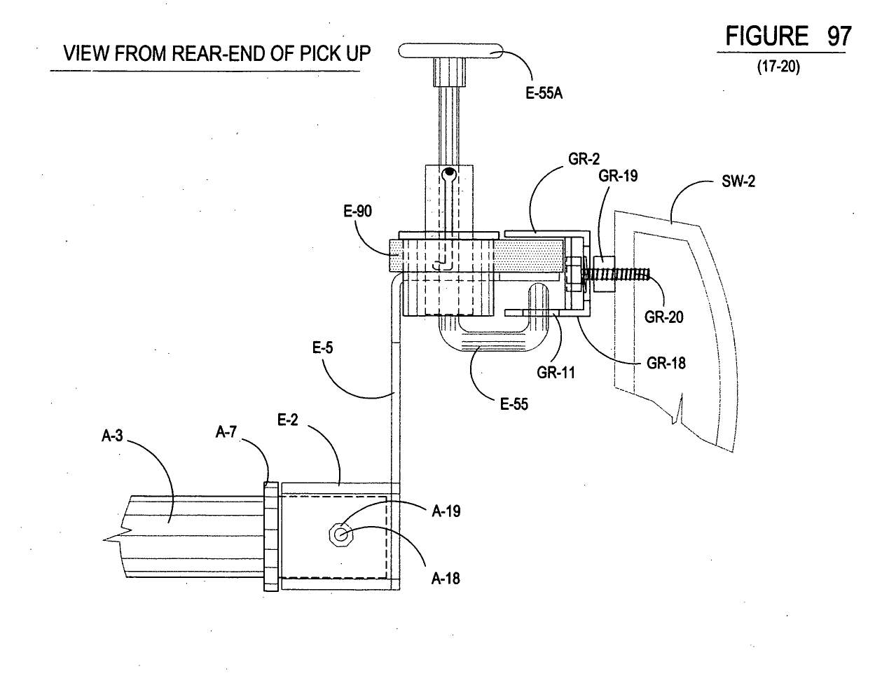

The significance of stop holes GR-11 and lock pins GR-13 and lock units GR-10 will be explained later. As for small holes GR-14 and big holes GR-12, these holes allow bolts GR-20 to pass through the first and second vertical walls of guide rails GR-1 and GR-2 to affix the rails against the interior section of side walls or side panels SW-1 and SW-2. See FIGS. 91, 92, 96 and 97. When bolts GR-20 penetrate the interior section of side panels SW-1 and SW-2, their heads rest between the two vertical walls so that they do not interfere with the passage of side shoes E-70 and E-90, shown between top walls GR-17 and bottom walls GR-18 of guide rails GR-1 and GR-2 in FIGS. 91 and 92 and also in FIGS. 96 thru 103.

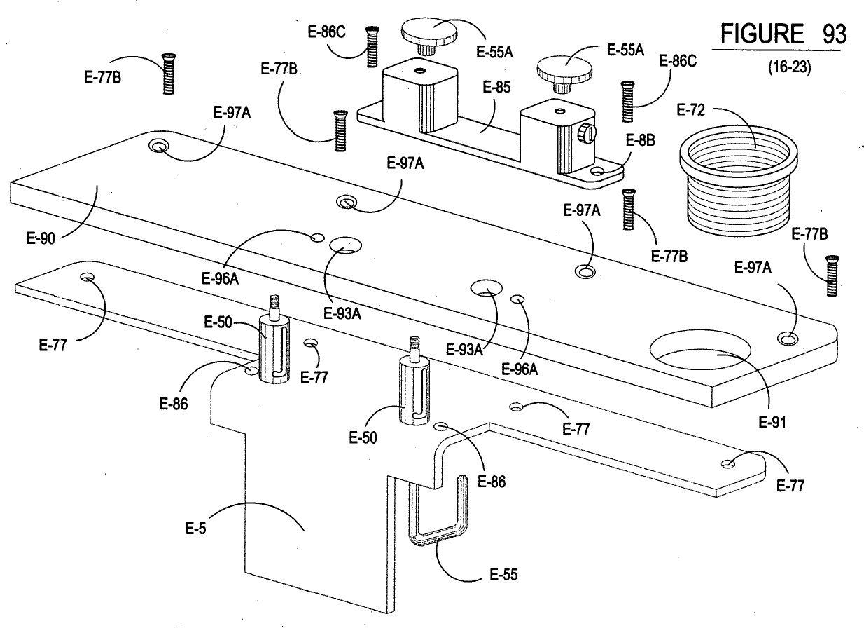

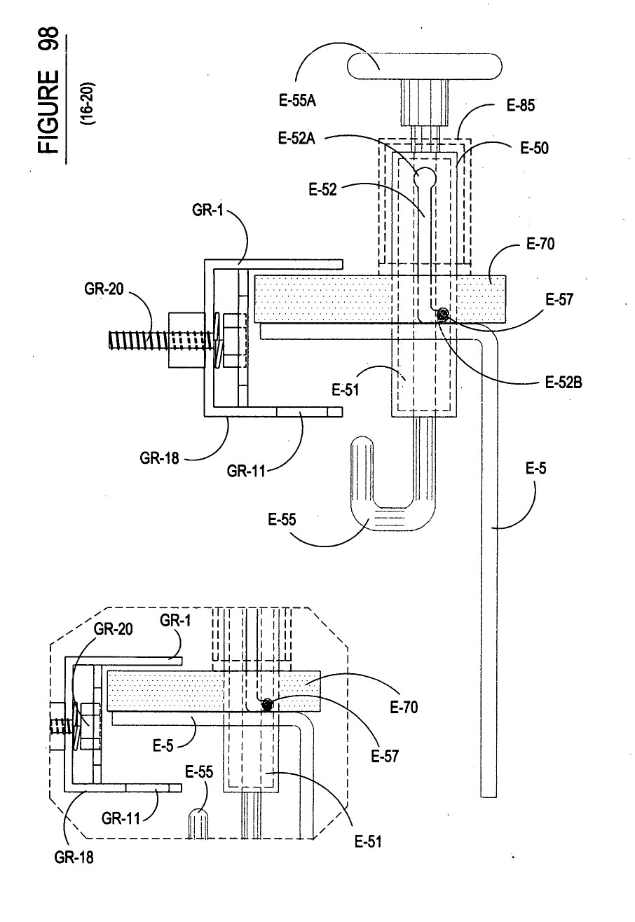

As can also be seen in FIGS. 93 thru 95, side shoes E-70 and E-90 are longitudinal pieces of nylon or other similar material capable of sliding with minimum friction along the hard metal surface of first vertical walls GR-9 of guide rails GR-1 and GR-2. As the apparatus is rolled back or forth, side shoes E-70 and E-90 slide back or forth along said vertical walls to keep the apparatus moving as straight as possible in either direction on the truck bed. Although the side shoe material is of minimum friction, there is a slight separation between the side shoes and said vertical walls, allowing the apparatus a very small margin of side to side movement to permit greater ease in its rolling action. See FIGS. 98 thru 103.

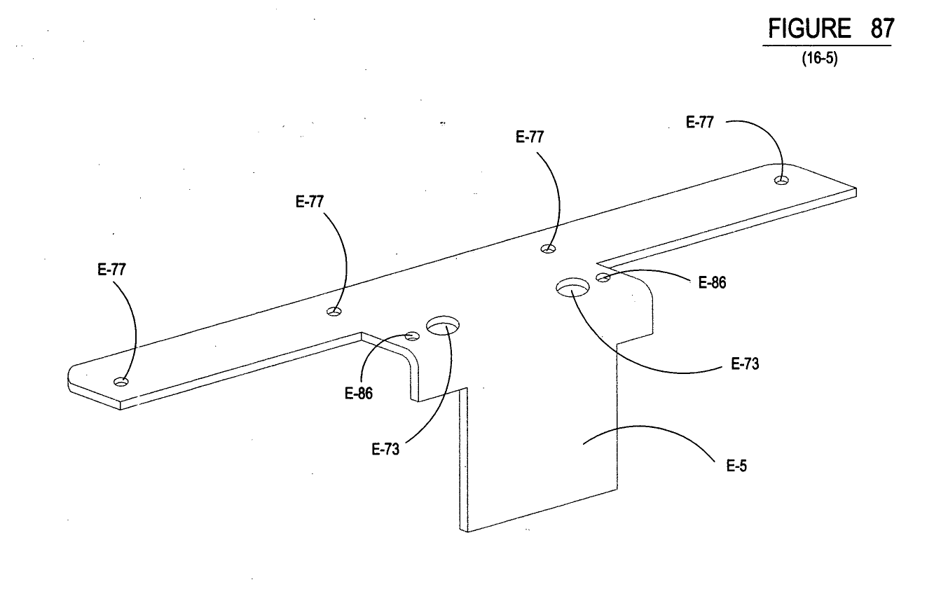

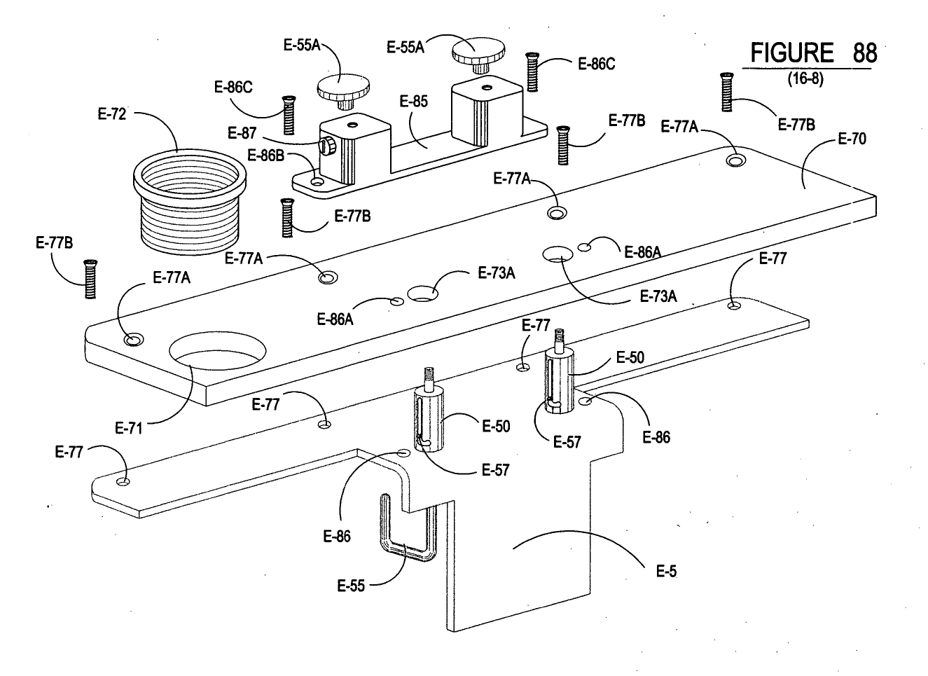

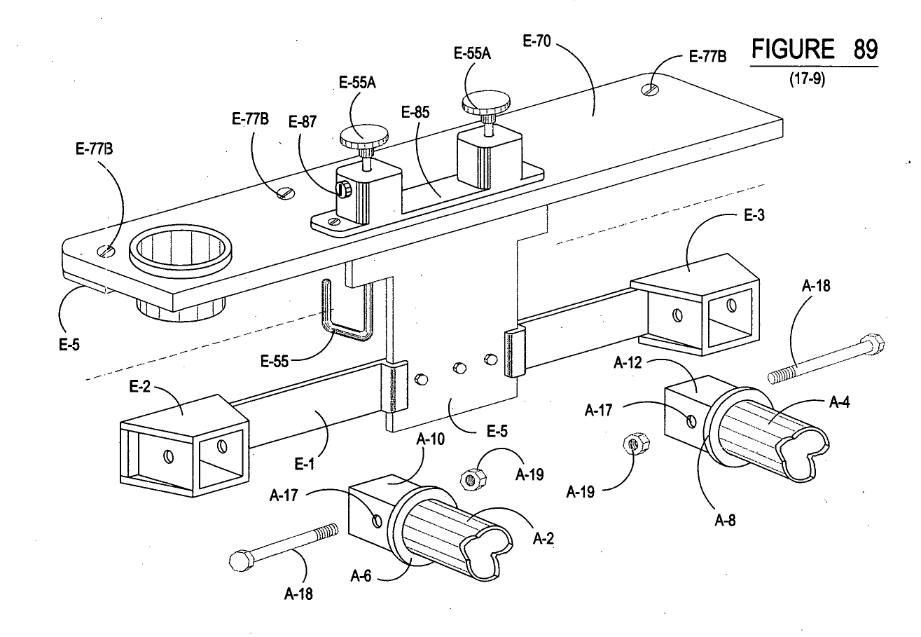

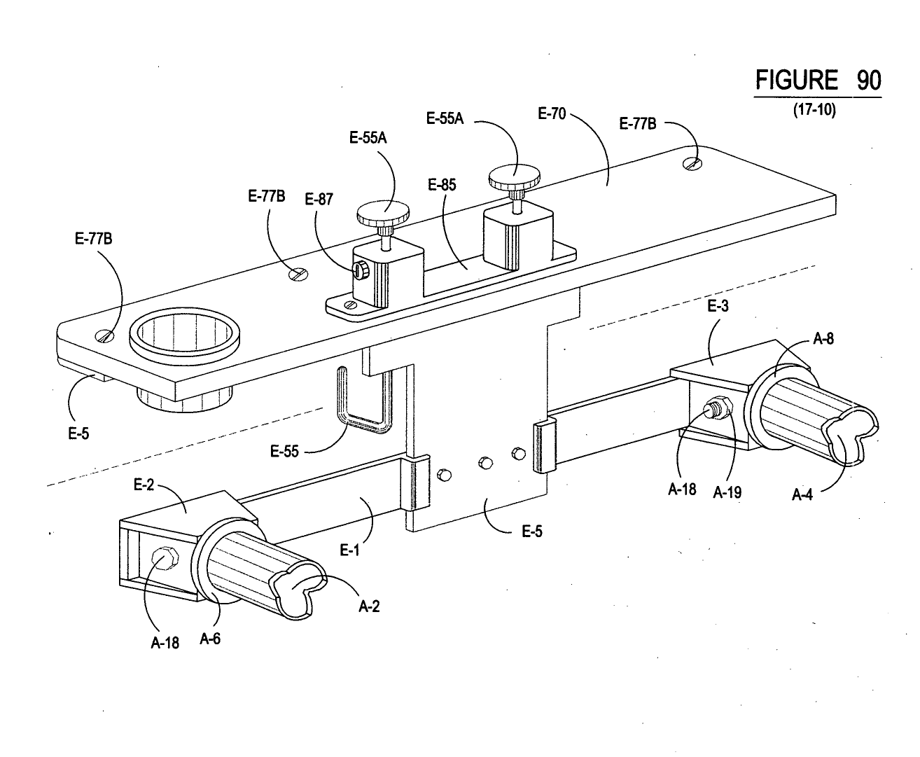

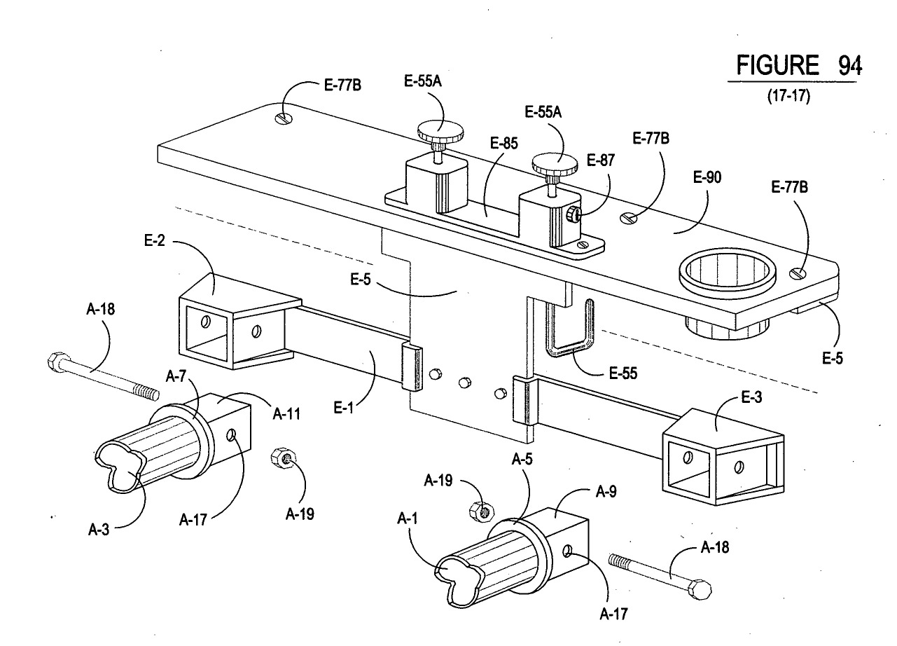

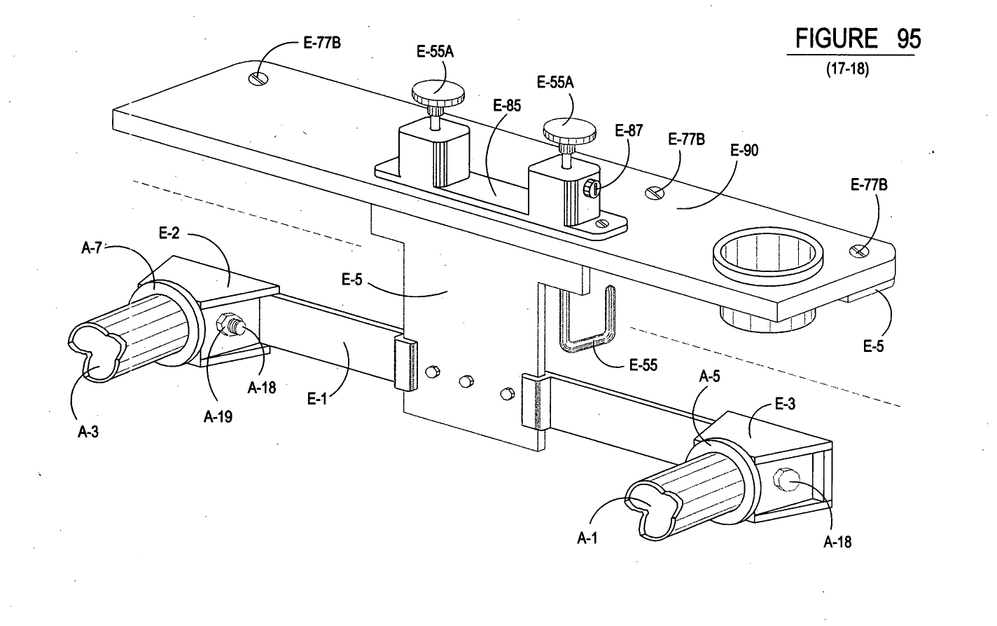

FIGS. 88 thru 97 show how side shoes E-70 and E-90 are interconnected to the front and rear double-ended telescopic arms illustrated in FIG. 76. FIGS. 89 and 90 show how end-blocks A-10 and A-12 of arm tubes A-2 and A-4 respectively are secured with bolts A-18 to end-joints E-2 and E-3 of end-joint assembly E-1, which in turn is secured with other bolts to a T-like metal piece E-5 holding side shoe E-70 on top. A complete T-like metal piece E-5 is illustrated in FIG. 87. Likewise, on the other side of the apparatus, end-blocks A-9 and A-11 of arm tubes A-1 and A-3 respectively are secured with bolts A-18 to end-joints E-3 and E-2 of a second end-joint assembly E-1, which in turn is secured to a second T-like metal piece E-5 holding side shoe E-90 on top. See FIGS. 94 and 95. Side shoes E-70 and E-90 are secured to their respective T-like metal pieces E-5 with bolts E-77B.

FIGS. 89, 90, 94 and 95 show that end-joint assemblies E-1 can be secured with bolts at virtually any distance from the top or the bottom of the vertical section of T-like metal pieces E-5. Therefore, if side panels SW-1 and SW-2 on a given pickup truck model are especially high, end-joint assemblies E-1 would have to be secured at a short distance from the bottom of said vertical sections. Conversely, if side panels SW-1 and SW-2 on another pickup truck model are especially low, then end-joint assemblies E-1 would have to be secured at a short distance from the top of said vertical sections.

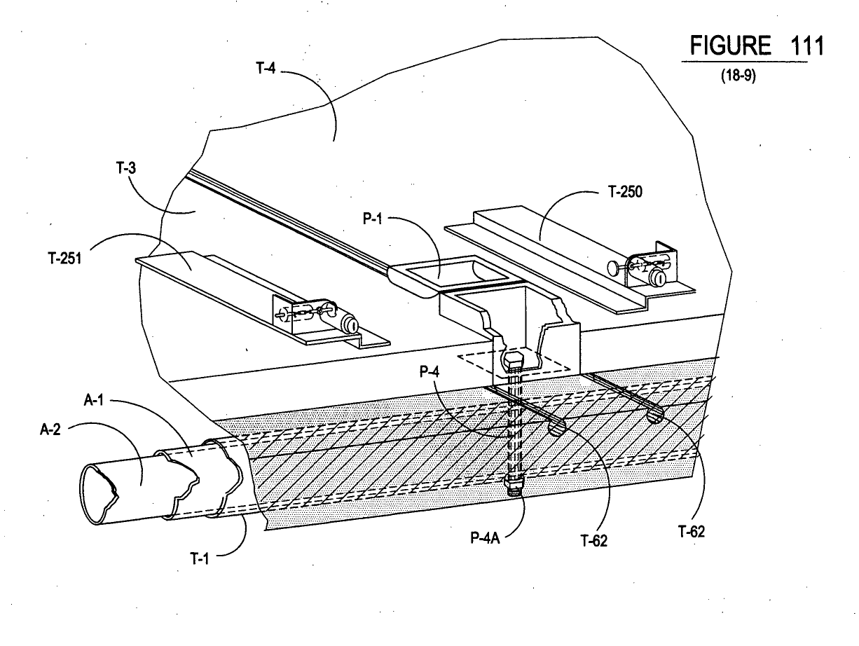

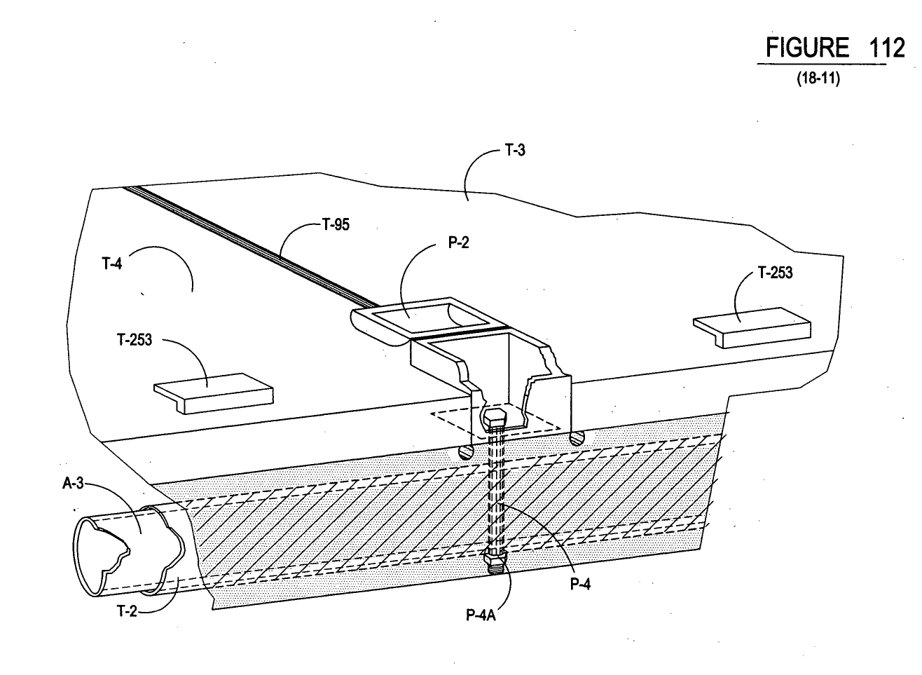

Once the front and rear double-ended telescopic arms illustrated in FIG. 76 are extended outwardly and their end-blocks are secured with bolts to end-joints E-2 and E-3 on end-joint assemblies E-1 on both sides of the apparatus, a drill bit P-3 can bore holes through main tubes A-1 and A-3 and inner tubes A-2 and A-4 respectively. A vertically oriented bolt P-4 placed from front box P-1 in the front of the trunk and an identical bolt placed from rear box P-2 in the rear of the trunk would then pass through said bored holes to secure each main tube to its respective inner tube. Bolts P-4 are retained in place with a nut P-4A at the lower end of said bolts. See FIGS. 111 AND 112.

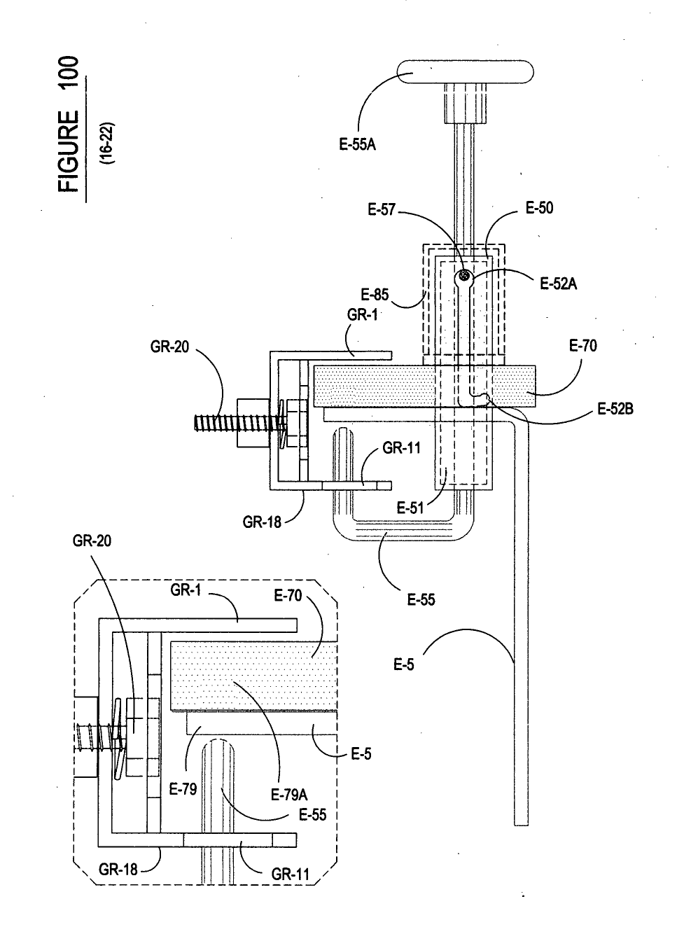

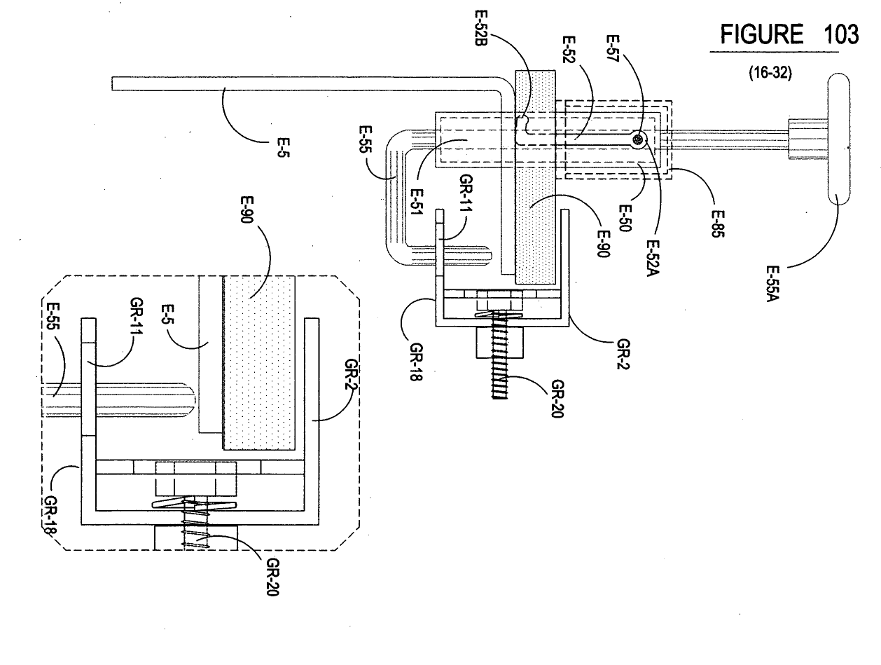

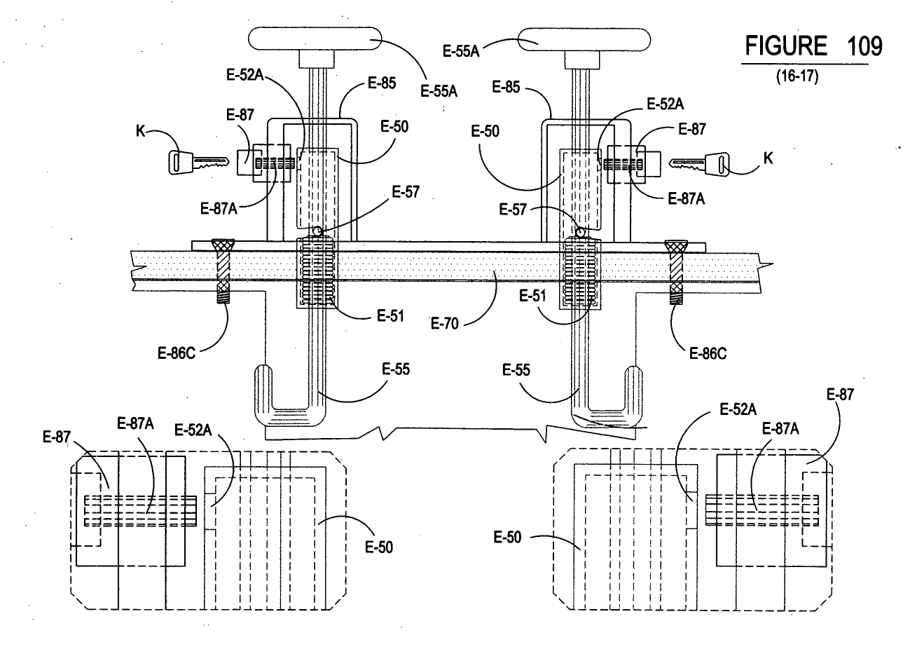

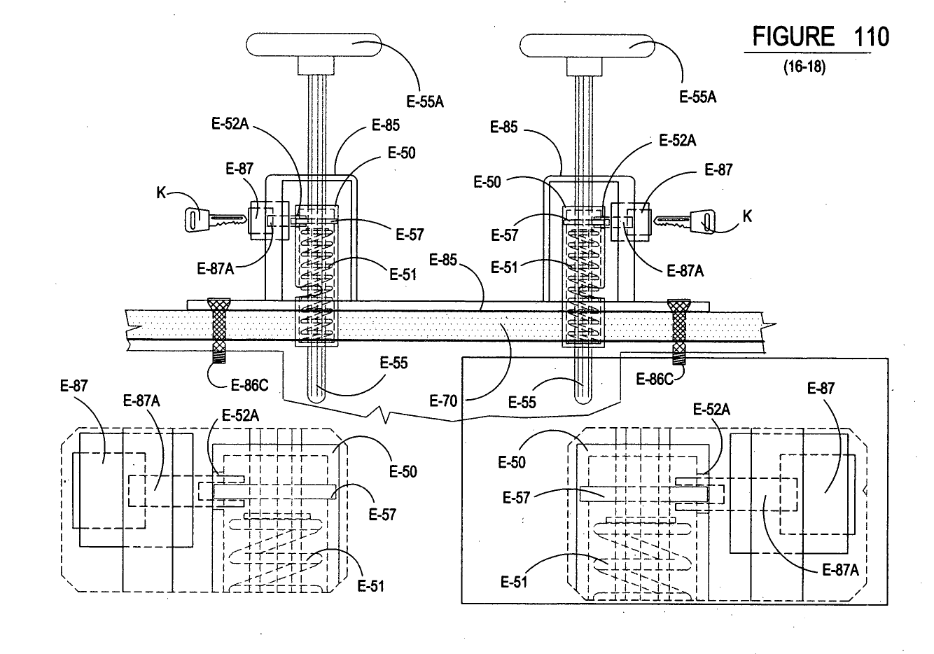

T-like metal pieces E-5 additionally hold two cylinders E-50 and two hook levers E-55 in their horizontal sections. See FIGS. 87, 109 and 110. As shown in FIGS. 98 thru 107, each hook lever E-55 passes through a cylinder E-50 holding a spring E-51, which when contracted presses hook lever E-55 upward. Thus, when springs E-51 are contracted and the apparatus is rolled back or forth on the truck bed, and the lower ends of hook levers E-55 are positioned underneath bottom walls GR-18 of guide rails GR-1 and GR-2, the lower ends of such hook levers E-55 will be locked into the first longitudinal stop holes GR-11 reached. When the apparatus is being rolled back or forth on the truck bed, and the lower ends of hook levers E-55 are positioned underneath bottom walls GR-18 of guide rails GR-1 and GR-2, the contracted springs E-51 inside cylinders E-50 press said lower ends upward, against said bottom walls, until said lower ends reach the first stop holes GR-11 and springs E-51 can extend freely. As springs E-51 then spring up the lower ends of hook levers E-55 raise through stop holes GR-11. See FIGS. 100 and 103. When this occurs, the apparatus stops rolling completely, secured to said stop holes.

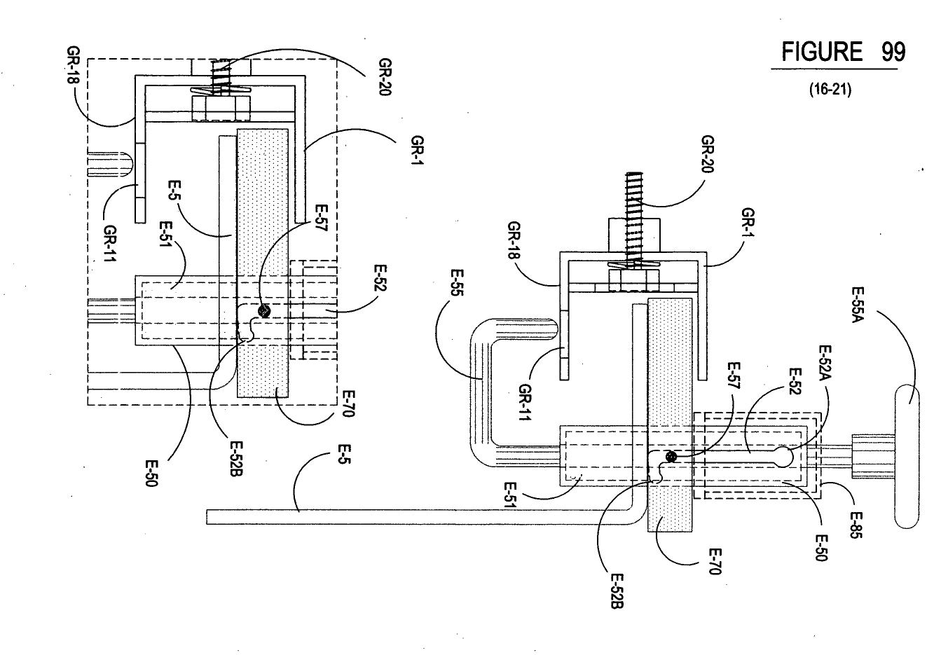

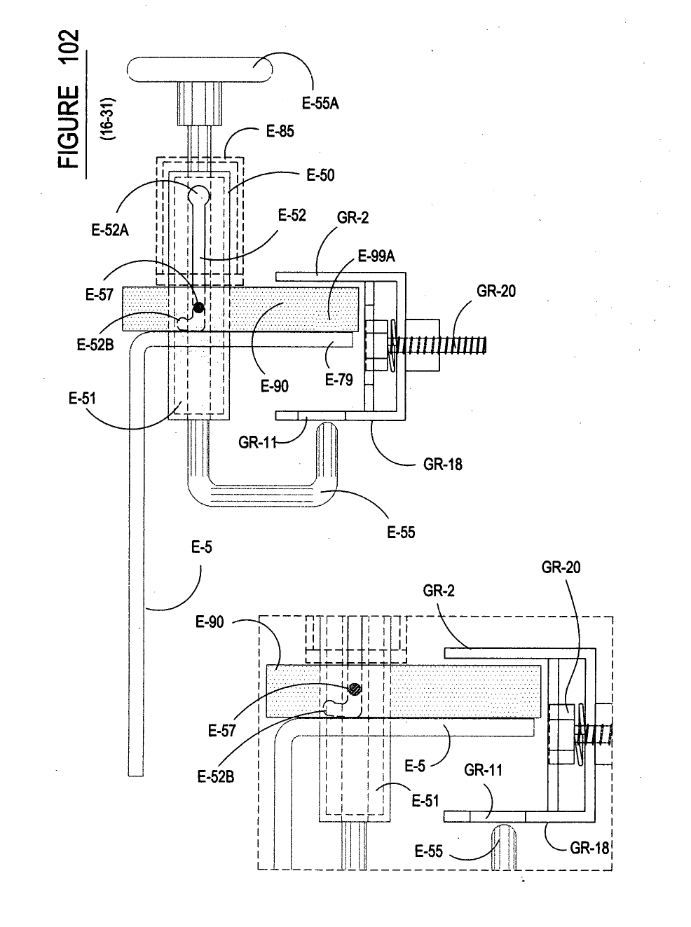

To roll the apparatus again, either forward or backward, handles E-55A on top of hook levers E-55 need to be pushed down, to again contract the extended springs E-51 and again lower hook levers E-55, to release them from stop holes GR-11 and slide them along underneath bottom walls GR-18 of guide rails GR-1 and GR-2. The apparatus would then roll on the truck bed until said lower ends reach other stop holes GR-11. See FIGS. 99, 100, 102 and 103.

As explained, side shoes E-70 and E-90 are slightly separated from vertical walls GR-9 of guide rails GR-1 and GR-2. See FIGS. 98 thru 103. This separation allows the apparatus a small margin of side to side movement as it is rolled back or forth on the truck bed. Therefore, stop holes GR-11 are of an elongated form and occupy a crosswise position along bottom walls GR-18, so that even as the apparatus can move slightly side to side, the round lower ends of hook levers E-55 will always coincide with said elongated stop holes. See FIGS. 84 thru 86.

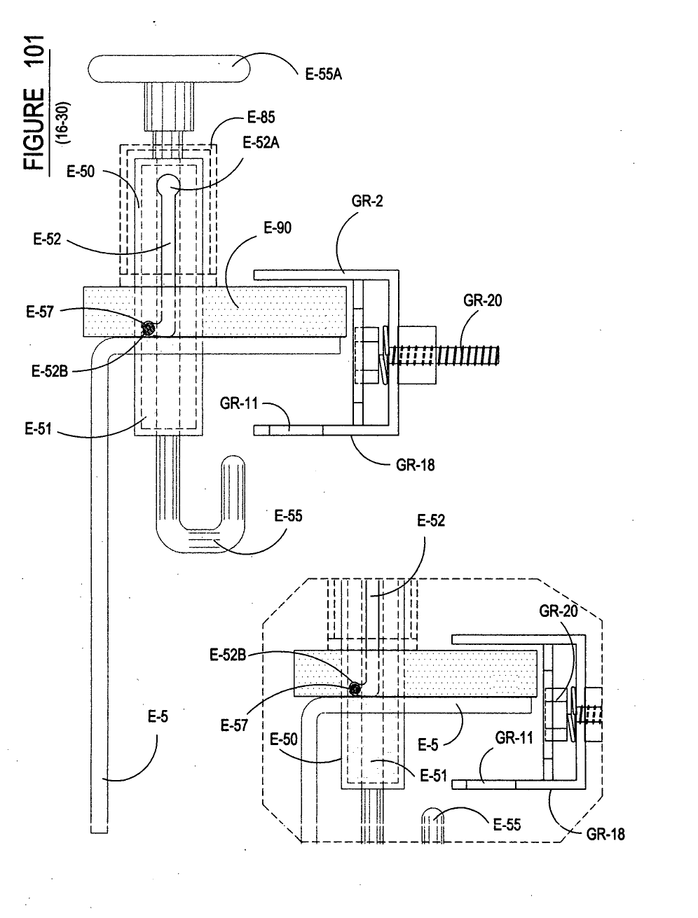

The apparatus can also be rolled freely in the truck bed without being stopped in stop holes GR-11. This can be accomplished by pushing down and then turning sideways handles E-55A. As shown in FIGS. 98 and 101, this operation unlocks the lower ends of hook levers E-55 from stop holes GR-11 and in addition swings them away from bottom walls GR-18 of guide rails GR-1 and GR-2, so that when the apparatus is rolled in the truck bed, either backward or forward, said lower ends do not reach other stop holes GR-11, allowing a free rolling movement.

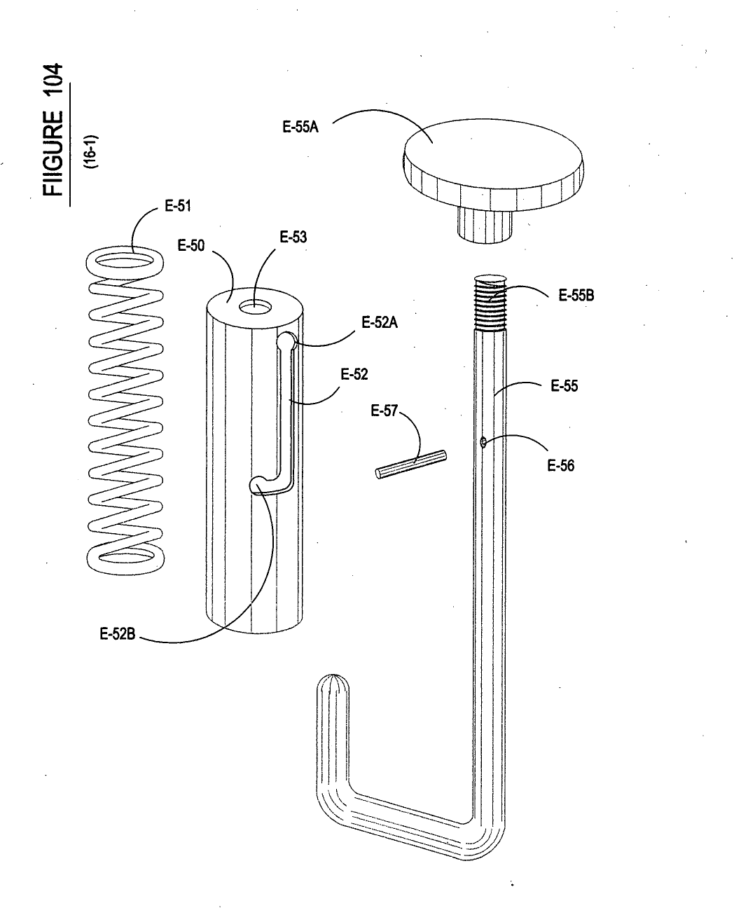

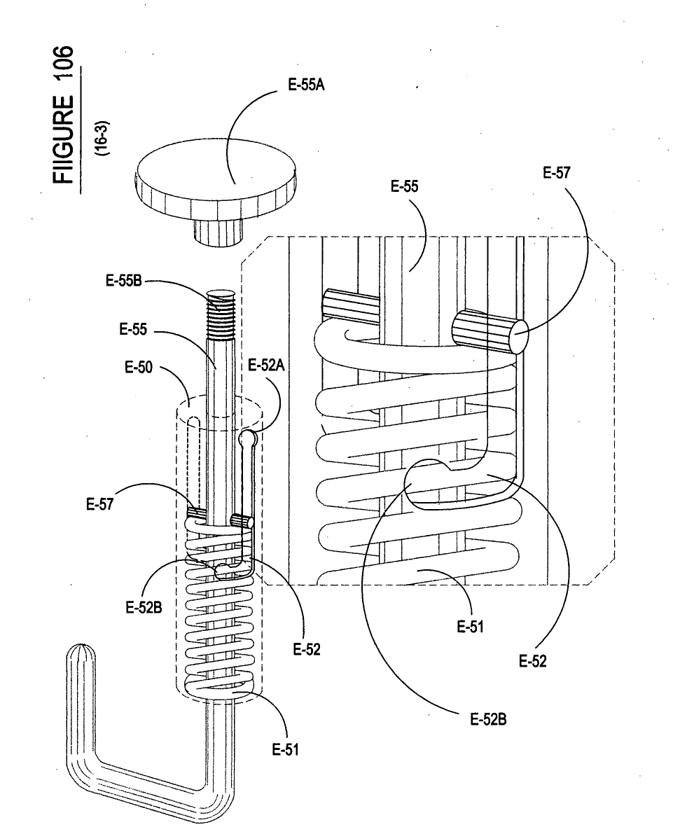

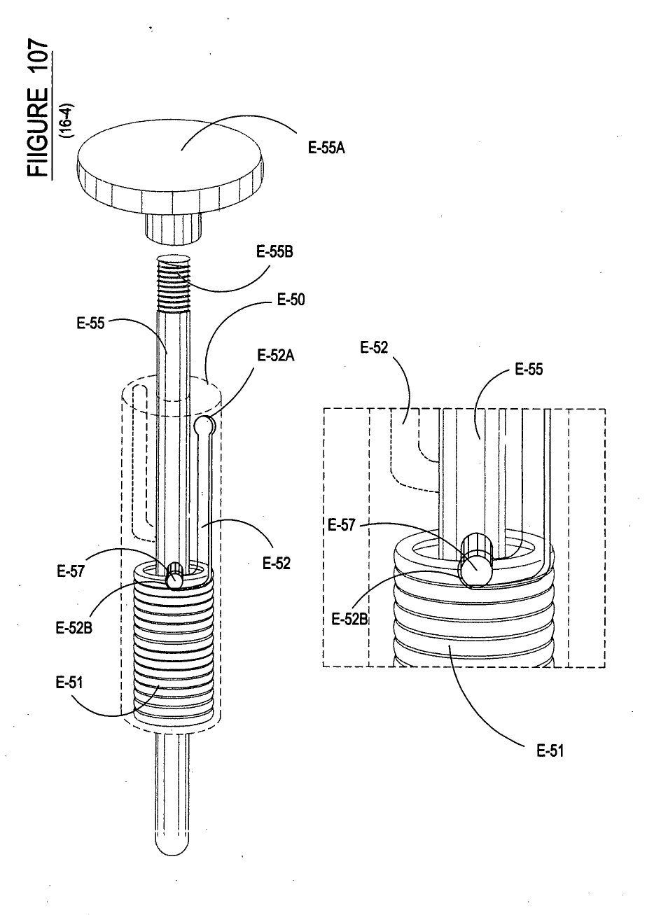

To keep the lower ends of hook levers E-55 away from bottom walls GR-18, hook levers E-55 have groove pins E-57 and cylinders E-50 have L-shaped parallel grooves E-52—See FIG. 104. L-shaped parallel grooves consist of vertical sections that end in top rests E-52A and horizontal sections which end in side rests E-52B. Groove pins E-57 pass through the circumference of cylinders E-50, traveling perpendicularly within L-shaped parallel grooves E-52 over springs E-51. Therefore, when handles E-55A are pushed down, simultaneously lowering hook levers E-55 and groove pins E-57, said groove pins force springs E-51 to contract within cylinders E-50. See FIG. 106. Concomitantly, when handles E-55A are turned sideways, the lower ends of hook levers E-55 swing away from bottom walls GR-18 of guide rails GR-1 and GR-2, making groove pins E-57 also turn sideways, until reaching side rests E-52B on the horizontal sections of L-shaped parallel grooves E-52, where said groove pins are retained. See FIG. 107.

To resecure the apparatus to a set of stop holes GR-11, handles E-55A should be turned back to their original position so that the lower ends of hook levers E-55 swing back to their previous position underneath bottom walls GR-18. As this is done, groove pins E-57 also return to the vertical section of L-shaped parallel grooves E-52 on cylinders E-50, where said groove pins can move up to allow springs E-51 under them to spring up as soon as the apparatus is rolled and the lower ends of hook levers E-55 reach the first set of stop holes GR-11. As this occurs the lower ends of hook levers E-55 are pushed upward, until springs E-51 are fully extended and said lower ends raise over such stop holes. See FIGS. 100 and 103.

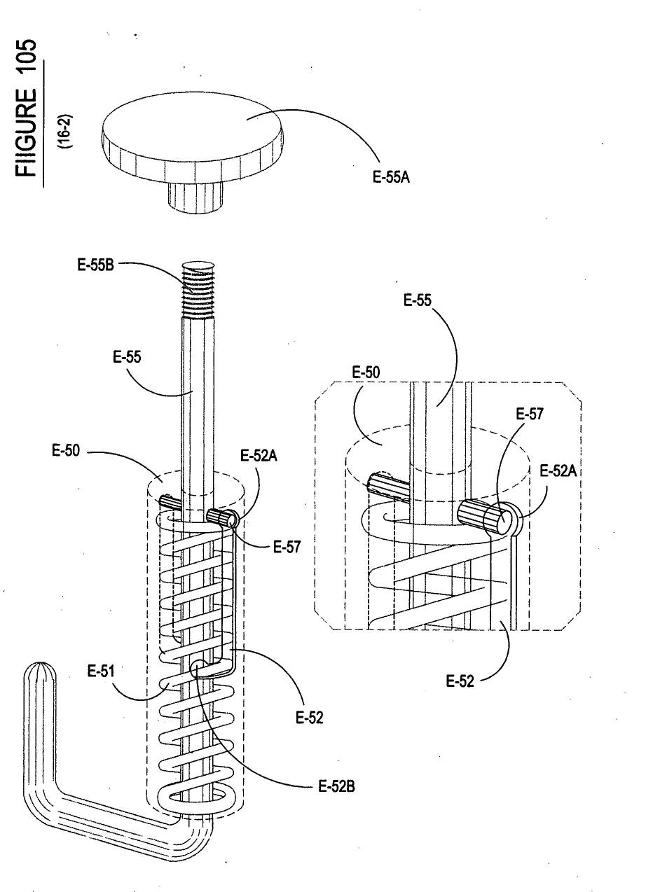

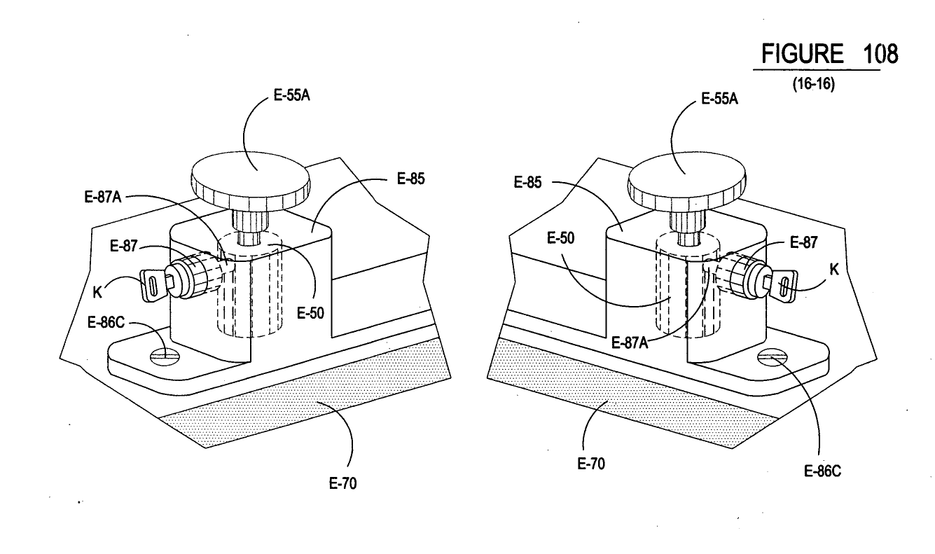

The apparatus can also be secured from theft in the truck bed by turning key K in lock units E-87. When key K is turned in lock units E-87 and the apparatus is locked into a set of stop holes GR-11, hollow pins E-87A move toward groove pins E-57 at top rests E-52A of the vertical section of L-shaped parallel grooves E-52 on cylinders E-50. As groove pins E-57 are then encompassed by hollow pins E-87A at top rests E-52A, groove pins E-57 are locked in place, and hook levers E-55 can not be pushed down to unlock the lower ends from bottom walls GR-18. See FIGS. 105, and 108 thru 110. Once this operation is repeated on both sides of the apparatus, the trunk and the seats are secured from theft on the truck bed until key K is reintroduced in lock units E-87 and hollow pins E-87A encompassing groove pins E-57 recede into said lock units.

The apparatus can be alternatively secured from theft in the open-topped truck bed with other lock units. Lock units GR-10 are located underneath bottom walls GR-18, a short distance from the end of guide rails GR-1 and GR-2 at the rear-end of the vehicle. See FIGS. 80 thru 83. When key K is turned in said lock units, lock pins GR-13 move up from under bottom walls GR-18 to thus block the passage of T-like metal pieces E-5 and side shoes E-70 and E-90. The apparatus can then be rolled back and forth on the truck bed, but it can not be disengaged from guide rails GR-1 and GR-2 or dismounted from the rear-end of the vehicle, until key K is reintroduced in lock units GR-10 and lock pins GR-13 recede into said lock units.

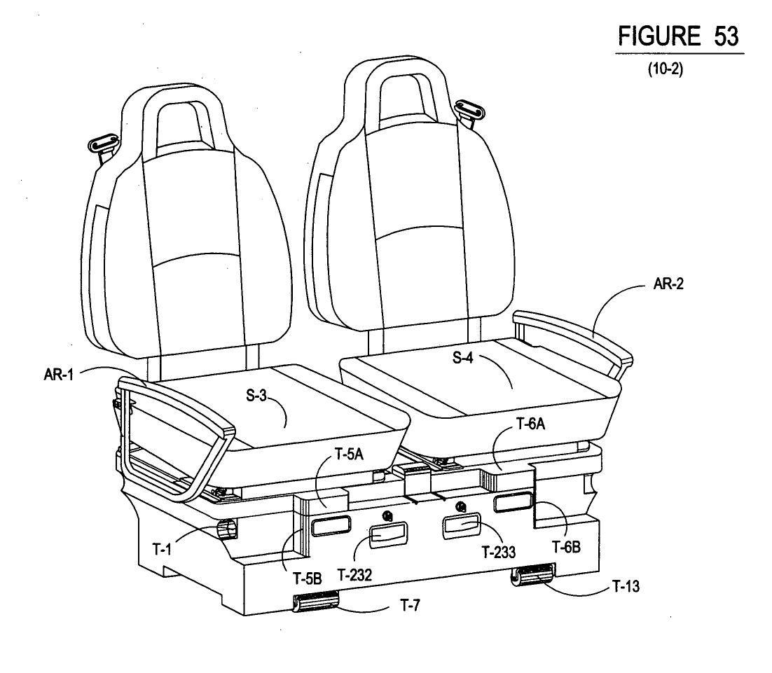

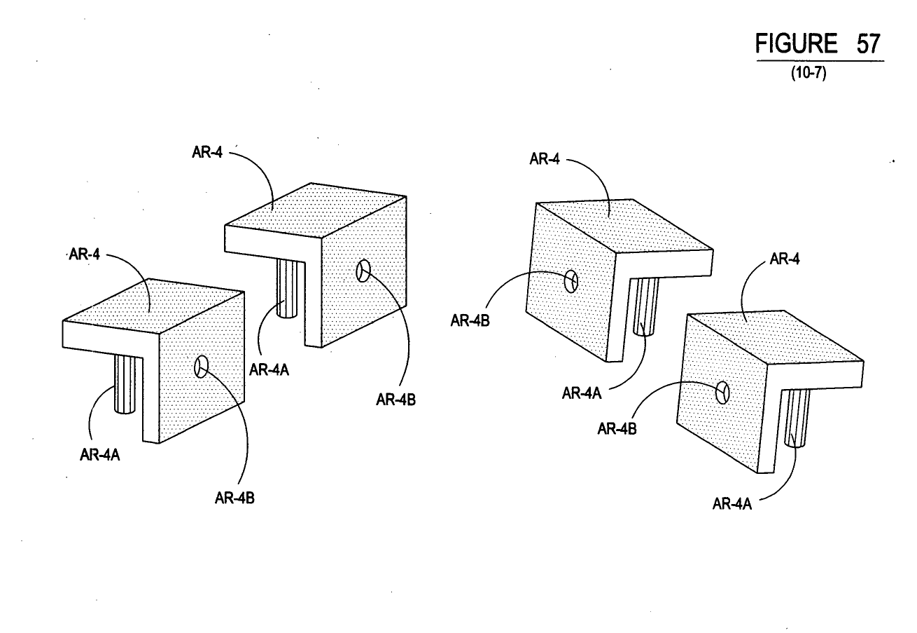

FIGS. 53 thru 57 further show how optional armrests AR-1 and AR-2 can be secured to side pockets AR-5 on side walls T-71 of the trunk. Each armrest has a pair of teeth AR-3 which fit snugly inside side pockets AR-5 and are secured thereto with bolts AR-6. To protect side pockets AR-5 from rain or dust when optional armrests AR-1 and AR-2 are not on the trunk, pocket fillers AR-4 can be used to fill the space. Pocket fillers AR-4 have the same pair of teeth as armrests AR-1 and AR-2 and are secured to side pockets AR-5 in the same way armrests AR-1 and AR-2 are secured. See FIG. 57.

I claim:

1. In combination with a truck with a cargo area having a bottom wall, front and back sides and opposite side walls extending up from said bottom wall, an apparatus comprising of at least one compartment underneath one or more removable seat bottoms having at least one reclinable backrest structure pivoted to swing back and down, relative to said seat bottoms, which can be reclined back and down when said seat bottoms are secured to said compartment and said compartment is secured within said cargo area; and means for guiding said compartment and said removable seat bottoms from one position to another within said cargo area.

2. In combination with a truck with a cargo area having a bottom wall, front and back sides and opposite side walls extending up from said bottom wall, an apparatus comprising of at least one compartment with one or more compartment lids underneath one or more removable seat bottoms having at least one reclinable backrest structure pivoted to swing back and down, relative to said seat bottoms, which can be reclined back and down when said seat bottoms are secured to said compartment lids and said compartment is secured within said cargo area; and means for guiding said compartment and said removable seat bottoms from one position to another within said cargo area; and one or more lock units over said compartment lids for securing said removable seat bottoms from theft.

3. In combination with a truck with a cargo area having a bottom wall, front and back sides and opposite side walls extending up from said bottom wall, an apparatus comprising of at least one compartment underneath one or more removable seat bottoms having at least one reclinable backrest structure pivoted to swing back and down, relative to said seat bottoms, which can be reclined back and down when said seat bottoms are secured to said compartment and said compartment is secured within said cargo area; and means for guiding said compartment and said removable seat bottoms from one position to another within said cargo area; and one or more lock units for securing from theft said removable seat bottoms, as well as for unlocking and removing them from said compartment while said compartment is in a closed position.

4. In combination with a truck with a cargo area having a bottom wall, front and back sides and opposite side walls extending up from said bottom wall, an apparatus comprising of at least one compartment underneath one or more removable seat bottoms having at least one reclinable backrest structure, pivoted to swing back and down, relative to said seat bottoms, which can be reclined back and down when said seat bottoms are secured to said compartment and said compartment is secured within said cargo area; and guide rails on said opposite side walls for guiding said compartment and said removable seat bottoms from one position to another within said cargo area; wherein said guide rails have one or more elongated holes for retaining in place said compartment and said removable seat bottoms.

5. In combination with a truck with a cargo area having a bottom wall, front and back sides and opposite side walls extending up from said bottom wall, an apparatus comprising of at least one compartment underneath one or more removable seat bottoms having at least one reclinable backrest structure pivoted to swing back and down, relative to said seat bottoms, which can be reclined back and down when said seat bottoms are secured to said compartment and said compartment is secured within said cargo area; and guide rails on said opposite side walls for guiding said compartment and said removable seat bottoms from one position to another within said cargo area; and means on said guide rails for securing said compartment from theft even as said compartment is free to move from one position to another within said cargo area.

6. In combination with a truck with a cargo area having a bottom wall, front and back sides and opposite side walls extending up from said bottom wall, an apparatus comprising of at least one compartment underneath one or more removable seat bottoms having at least one reclinable backrest structure pivoted to swing back and down, relative to said seat bottoms, which can be reclined back and down when said seat bottoms are secured to said compartment and said compartment is secured within said cargo area; and means for guiding said compartment and said removable seat bottoms from one position to another within said cargo area; wherein said backrest structure can be locked in place in a reclined position to protect from theft possessions kept underneath said backrest structure.

7. In combination with a truck with a cargo area having a bottom wall, front and back sides and opposite side walls extending up from said bottom wall, an apparatus comprising of at least one compartment underneath one or more removable seat bottoms having at least one reclinable backrest structure pivoted to swing back and down, relative to said seat bottoms, which can be reclined back and down when said seat bottoms are secured to said compartment and said compartment is secured within said cargo area; and means for guiding said compartment and said removable seat bottoms from one position to another within said cargo area and for securing them from theft in said positions.

8. In combination with a truck with a cargo area having a bottom wall, front and back sides and opposite side walls extending up from said bottom wall, an apparatus comprising of at least one compartment underneath one or more removable seat bottoms having at least one reclinable backrest structure pivoted to swing back and down, relative to said seat bottoms, which can be reclined back and down when said seat bottoms are secured to said compartment and said compartment is secured within said cargo area; and one or more lock units for securing from theft said removable seat bottoms, as well as for unlocking and removing them from said compartment while said compartment is in a closed position; and means for guiding said compartment and said removable seat bottoms from one position to another within said cargo area and for securing them from theft in said positions.

9. In combination with a truck with a cargo area having a bottom wall, front and back sides and opposite side walls extending up from said bottom wall, an apparatus comprising of at least one compartment; and guide rails on the interior section of said opposite side walls for guiding said compartment from one position to another within said cargo area and for securing it from theft in said positions, as well as for dismounting it from said cargo area when desired.
